(19) United States
(12) Patent Application Publication
(10) Pub. No.: US 2026/0164190 A1
(43) Pub. Date: Jun. 11, 2026

(54) HEARING AID COMPRISING AN INPUT UNIT ASSOCIATED WITH DIFFERENT SAMPLING RATES FOR ALIASING ARTEFACT SUPPRESSION IN COMMON FREQUENCY COMPONENTS

(71) Applicant: Oticon A/S, Smørum (DK)

(72) Inventors: Michael Syskind PEDERSEN, Smørum (DK); Nels Hede ROHDE, Smørum (DK); Aske Søderman HANSEN, Smørum (DK)

(21) Appl. No.: 19/406,988

(22) Filed: Dec. 3, 2025

(30) Foreign Application Priority Data
Dec. 10, 2024 (EP) 24218604.7
Dec. 10, 2024 (EP) 24218646.8

(51) Int. Cl. H04R 25/00; H04R 1/22

(52) U.S. Cl. CPC H04R 25/453; H04R 1/22

(57) ABSTRACT

Disclosed herein are embodiments of a hearing aid. The hearing aid can receive input signals and determine aliasing artefact frequency components within the signals. The hearing aid can further be configured to determine aliasing artefact reduced signals, which have reduced and/or eliminated aliasing artefact frequency components. The hearing aid can be configured to output audible sounds based on the aliasing artefact reduced signal.

### CROSS REFERENCE TO RELATED APPLICATIONS

Any and all application for which a foreign or domestic priority claim is identified in the Application Data Sheet as filed with the present application are hereby incorporated by reference under 37 CFR 1.57.

### TECHNICAL FIELD

The present application relates to the field of hearing aids. The present application relates to a hearing aid comprising an input unit associated with different sampling rates for aliasing artefact suppression.

### BACKGROUND

A hearing aid is configured to receive a number of analogue signals from a corresponding number of microphones, the number of analogue signals being digitally sampled at a certain sampling rate (e.g., either at the same sampling rate or at different sampling rates). The corresponding number of digital signals can be processed (e.g., in the frequency domain), with the processed signal being converted back from the digital domain to an analogue output signal, which can be presented to a user of the hearing aid.

When sampling an analogue signal that is captured by the microphone at a given sample rate, signal components located at frequency components above half of the sampling rate may still be present in the digitally sampled signal at frequencies below half of the sampling rate. Such an effect is known as aliasing. One option to prevent such signal components (e.g., aliasing artefacts) from appearing in the digitally sampled signal is to apply a Low-Pass Filter (LPF) or an anti-aliasing Filter (AAF) before sampling the analogue signal.

However, such signal components may still be present in the digitally sampled signal, such as below half of the sampling rate. In other words, aliasing may still occur even when an LPF or an anti-aliasing LPF is applied to the analogue signal. In other words, aliasing artefacts may still be audible in the digitally sampled signal.

### SUMMARY

There is a need for hearing aids and methods for reducing aliasing artefacts in at least two signals reaching a microphone or at least two corresponding microphones of the hearing aid, with the at least two signals being associated with different sampling rates.

### a Hearing Aid:

A hearing aid is disclosed herein. The hearing aid comprises an input unit.

The input unit is configured to determine a first frequency-domain signal based on a first input signal. The first frequency-domain signal comprises a plurality of first frequency components associated with a first frequency range. A first primary frequency range is a subset of the first frequency range. The first primary frequency range of the first frequency-domain signal comprises one or more first aliasing artefact frequency components. Each of the one or more first aliasing artefact frequency components is indicative of a frequency component of the plurality of first frequency components including a first aliasing artefact. In one or more example hearing aids, the input unit is configured to provide (e.g., determine) the first frequency domain signal based on a first digitized signal (e.g., a sampled signal). For example, the first digitized signal is associated with a first sampling rate.

The input unit is configured to determine a second frequency-domain signal based on a second input signal. The second frequency-domain signal comprises a plurality of second frequency components associated with the first primary frequency range. The second frequency-domain signal comprises one or more second aliasing artefact frequency components. Each of the one or more second aliasing artefact frequency components is indicative of a frequency component of the plurality of second frequency components including a second aliasing artefact. In one or more example hearing aids, the input unit is configured to provide (e.g., determine) the second frequency domain signal based on a second digitized signal (e.g., a sampled signal). For example, the second digitized signal is associated with a second sampling rate.

Each of the first input signal and second input signal is representative of a sound in an environment of the hearing aid, the environment of the hearing aid comprising an aliasing source.

The hearing aid comprises an aliasing artefact detection unit configured to determine the one or more first aliasing artefact frequency components and the one or more second aliasing artefact frequency components based on (e.g., by performing) a magnitude comparison between the first primary frequency range of the first frequency domain signal and the second frequency domain signal.

The hearing aid comprises a signal processing unit configured to determine an aliasing artefact reduced signal based on the first frequency domain signal, the second frequency domain signal, the one or more first aliasing artefact frequency components and the one or more second aliasing artefact frequency components.

The hearing aid comprises an output unit configured to output, based on the aliasing artefact reduced signal, an audible signal to the user wearing the hearing aid.

Thereby an improved hearing aid may be provided.

It is an advantage of the present disclosure that, by determining an aliasing artefact reduced signal based on the first frequency domain signal, the second frequency domain signal, the one or more first aliasing artefact frequency components and the one or more second aliasing artefact frequency components, an improved hearing experience is provided.

For example, embodiments of the present disclosure can ensure that the one or more first aliasing artefact frequency components are different from the one or more second aliasing artefact frequency components by having the first frequency domain signal and second frequency domain signals associated with different frequency ranges, e.g., by having such frequency domain signals resulting from input signals sampled with different sampling rates.

Embodiments of the present disclosure provide a hearing aid capable of determining (e.g., generating) an aliasing artefact reduced signal by properly combining the first frequency domain signal and the second signal frequency domain signal, with the one or more first aliasing artefact frequency components being different from the one or more second aliasing artefact frequency components. In particular, a first frequency component of the plurality of first frequency components and a corresponding second first frequency component of the plurality of second frequency components can form a pair of frequency components, with the first frequency component and the corresponding second frequency component sharing the same location in both the first and second frequency domain signals. A proper combination of the first and second frequency domain signals can, for example, be achieved by selecting one of the first and corresponding second frequency components that is less or not affected by an aliasing artefact. Such proper combination can, for example, be performed for a plurality of pairs, each pair comprising a first frequency component of the first primary frequency range of the first frequency domain signal and a corresponding second frequency component of the second frequency domain signal, in turn determining the aliasing artefact reduced signal based on the frequency components (e.g., either the first frequency component or the corresponding second frequency component) where the aliasing artefacts are absent. In other words, by having the one or more first aliasing artefact frequency components different from the one or more second aliasing artefact frequency components in conjunction with a proper combination of the first and second frequency domain signals (e.g., such combination being performed by the signal processing unit), suppression of aliasing artifacts in the first primary frequency range of each of the first and second frequency domain signals (e.g., in the range of the signals reaching the plurality of microphones) may be provided for a hearing aid with substantial aliasing artefact interference.

Furthermore, having the first frequency domain signal and the second frequency domain signal (e.g., a plurality of frequency domain signals) for determining the aliasing artefact reduced signal can increase the probability of having a given frequency component of one of such frequency domain signals that is less (e.g., or not) affected by an aliasing artefact compared to other of such frequency domain signals.

Embodiments of the present disclosure can advantageously enable provision of an output signal (e.g., the output of an audible signal) comprising no or a minor level of aliasing artefacts, such as a signal less impacted by aliasing artefact interference, in turn improving a user's hearing experience. Stated differently, embodiments of the present disclosure may provide for improved mitigation (e.g., reduction) of aliasing artefacts in hearing aids.

In one or more example hearing aids, a first aliasing artefact can be construed as an artefact (e.g., distortion) appearing in a frequency component of the plurality of first frequency components. For example, a frequency component of the plurality of first frequency components comprising a first aliasing artefact can be seen as a first aliasing artefact frequency component.

For example, a first aliasing artefact comprised by a first aliasing artefact frequency component of the one or more first aliasing artefact frequency components may be different from a first aliasing artefact comprised by another first aliasing artefact frequency component of the one or more first aliasing artefact frequency components in the sense that such first aliasing artefacts are comprised by different first aliasing artefact frequency components, but resulting (e.g., originating) from the same aliasing source. For example, a second aliasing artefact comprised by a second aliasing artefact frequency component of the one or more first aliasing artefact frequency components may be different from a second aliasing artefact comprised by another second aliasing artefact frequency component of the one or more first aliasing artefact frequency components in the sense that such second aliasing artefacts are comprised by different second aliasing artefact frequency components, but resulting (e.g., originating) from the same aliasing source. An aliasing source may be seen as a source in an environment of the hearing aid originating appearance of one or more first aliasing artefacts in the first frequency range of the first frequency domain signal as well as of one or more second aliasing artefacts in the second frequency domain signal (e.g., in the first primary frequency range of the second frequency domain signal).

For example, the first sampling rate is greater than the second sampling rate, thereby causing the first frequency-domain signal to be associated with the first frequency range and the second frequency-domain signal to be associated with the first primary frequency range (e.g., a porting of the first frequency range).

For example, frequency components up to half of the sampling rate (Nyquist frequency) can be correctly preserved (e.g., reconstructed). The first frequency range of the first frequency-domain signal may be construed as a frequency range having the maximum frequency component of such range given by half of the first sampling rate. The first primary frequency range of the second frequency-domain signal may be construed as a frequency range having the maximum frequency component of such range given by half of the second sampling rate.

For example, the first sampling rate is greater than the second sampling rate, thereby causing the first frequency-domain signal to be associated with the first frequency range and the second frequency-domain signal to be associated with the first primary frequency range (e.g., a porting of the first frequency range).

For example, frequency components up to half of the sampling rate (Nyquist frequency) can be correctly preserved (e.g., reconstructed). The first frequency range of the first frequency-domain signal may be construed as a frequency range having the maximum frequency component of such range given by half of the first sampling rate. The first primary frequency range of the second frequency-domain signal may be construed as a frequency range having the maximum frequency component of such range given by half of the second sampling rate. Put differently, a frequency range of a frequency domain signal can be seen as a range of frequency components having a maximum frequency component of such range given by half of a sampling rate used for sampling an input signal from which the frequency domain signal is derived.

In one or more example hearing aids, a frequency domain signal (e.g., the first frequency domain signal, the second frequency domain signal) comprising one or more aliasing artefacts (e.g., one or more first aliasing artefacts, one or more second aliasing artefacts) may derive from (e.g., may be determined based on) a digitally sampled time-domain signal in which the Nyquist frequency is lower than a frequency of the one or more aliasing artefacts (e.g., one or more first aliasing frequency components, one or more second aliasing frequency components).

For example, a frequency component of a frequency domain signal comprises a plurality of time instances. For example, a frequency component of a frequency domain signal can be seen as a portion (e.g., a part) of the frequency domain signal, such portion being associated with a plurality of time instances.

For example, the one or more first aliasing artefact frequency components are different from the one or more second aliasing artefact frequency components since the first and second frequency domain signals are associated with different sampling rates. For example, location of the one or more first aliasing artefact frequency components in the first frequency domain signal is different from location of the one or more second aliasing artefact frequency components in the second frequency domain signal. For example, the portion of the first frequency domain signal associated with each of the one or more first aliasing artefact frequency components is different from the portion of the second frequency domain signal associated with each of the one or more second aliasing artefact frequency components.

For example, the input unit configured to provide the first frequency-domain signal by determining the first frequency-domain signal based on a first input signal. For example, the first frequency-domain signal is a frequency domain representation of the first input signal. For example, the input unit configured to provide the second frequency-domain signal by determining the second frequency-domain signal based on a second input signal. For example, the second frequency-domain signal is a frequency domain representation of the second input signal.

For example, the aliasing source can be seen as a source in the (e.g., acoustic) environment of the hearing aid which may cause the appearance of aliasing artefacts in a frequency domain representation of an input signal (e.g., of the first and/or second input signal). Appearance of aliasing artefacts in a frequency domain representation of an input signal may occur when the input signal captured by the hearing aid (e.g., via a microphone) from such source contains frequency components exceeding the Nyquist frequency (e.g., half the sampling rate used to sample the input signal).

For example, the input unit configured to provide the first frequency-domain signal by determining the first frequency-domain signal based on a first input signal. For example, the first frequency-domain signal is a frequency domain representation of the first input signal. For example, the input unit configured to provide the second frequency-domain signal by determining the second frequency-domain signal based on a second input signal. For example, each of the first input signal and second input signal is representative of a sound in an environment of the hearing aid, the environment of the hearing aid comprising an aliasing source. For example, the second frequency-domain signal is a frequency domain representation of the second input signal.

For example, the aliasing source can be seen as a source in the (e.g., acoustic) environment of the hearing aid which may cause the appearance of aliasing artefacts in a frequency domain representation of an input signal (e.g., of the first and/or second input signal). Appearance of aliasing artefacts in a frequency domain representation of an input signal may occur when the input signal captured by the hearing aid (e.g., via a microphone) from such source contains frequency components exceeding the Nyquist frequency (e.g., half the sampling rate used to sample the input signal).

In one or more example hearing aids, the output unit is configured to provide a stimulus perceived by the user as an acoustic signal based on the aliasing artefact reduced signal. The output unit may comprise an output transducer. The output transducer may comprise a receiver (e.g., a loudspeaker) for providing the stimulus as an acoustic signal to the user (e.g., in an acoustic (air conduction based) hearing aid).

The output unit may (additionally or alternatively) comprise a (e.g., wireless) transmitter for transmitting sound picked up-by the hearing aid to another device, e.g. a far-end communication partner (e.g., via a network, e.g., in a telephone mode of operation). In one or more example hearing aids, the wireless transmitter is configured to transmit an electromagnetic signal in the radio frequency range (e.g., 3 kHz to 300 GHz). The wireless transmitter may be configured to transmit an electromagnetic signal in a frequency range of light (e.g., infrared light 300 GHz to 430 THz, or visible light, e.g., 430 THz to 770 THz).

In one or more example hearing aids, the hearing aid comprises a digital-to-analogue (DA) converter to convert a digital signal to an analogue output signal, e.g., for being presented to a user via the output unit (e.g., output transducer). In other words, the DA converter may be configured to convert the aliasing artefact reduced signal as a digital signal, e.g., provided in a digitized form by the signal processing unit, to an analogue output signal. The analogue output signal may be converted into an acoustic signal via the output transducer.

In one or more example hearing aids, the hearing aid comprises an aliasing artefact detection unit. For example, the aliasing artefact detection unit is configured to operate on the first primary frequency range of both the first frequency domain signal and the second frequency domain signal. The first primary frequency range (e.g., of the first frequency domain signal and of the second frequency domain signal) may be seen as a set of common frequency (CF) components. The set of CF components may be construed as a set of frequency components that are common to both the first frequency-domain signal and the second frequency-domain signal. In one or more example hearing aids, the signal processing unit can comprise the aliasing artefact detection unit.

In one or more example hearing aids, the aliasing artefact detection unit is configured to determine, based on the first primary frequency range of the first frequency domain signal and the second frequency domain signal, the one or more first aliasing artefact frequency components. For example, the aliasing artefact detection unit is configured to determine the location of the one or more first aliasing artefact frequency components in the first primary frequency range of the first frequency domain signal. The aliasing artefact detection unit may provide, to the signal processing unit, one or more first indexes (e.g., integer values), each first index being indicative of the location of a first aliasing artefact frequency component of the one or more first aliasing artefact frequency components in the first primary frequency range of the first frequency domain signal. Optionally, each first index may be indicative of a frequency value (e.g., in Hz), such as a frequency characterizing a first aliasing artefact frequency component of the one or more first aliasing artefact frequency components. In one or more example hearing aids, the aliasing artefact detection unit is configured to determine the occurrence of aliasing in the first and second frequency domain signals, such as to determine whether aliasing occurs (e.g., in order to enable an aliasing artefact reduction mode associated with the hearing aid).

In one or more example hearing aids, the aliasing artefact detection unit is configured to determine, based on the first primary frequency range of the first frequency domain signal and the second frequency domain signal, the one or more second aliasing artefact frequency components. For example, the aliasing artefact detection unit is configured to determine the location of the one or more second aliasing artefact frequency components in the second frequency domain signal. The aliasing artefact detection unit may provide, to the signal processing unit, one or more second indexes (e.g., integer values), each second index being indicative of the location of a second aliasing artefact frequency component of the one or more second aliasing artefact frequency components in the second frequency domain signal. Optionally, each second index may be indicative of a frequency value (e.g., in Hz), such as a frequency characterizing a second aliasing artefact frequency component of the one or more second aliasing artefact frequency components.

In one or more example hearing aids, each pair of a plurality of pairs of frequency components comprises a first frequency component of the plurality of first frequency components and a corresponding second frequency component of the plurality of second frequency components. In one or more example hearing aids, the first frequency component and the corresponding second frequency component are associated with the first primary frequency range. In one or more example hearing aids, the first frequency component and the corresponding second frequency component share the same location in the first frequency domain signal and the second frequency domain signal, respectively. For example, the location of the first frequency component in the first frequency domain signal is the same as the location of the corresponding second frequency component in the second frequency domain signal.

For example, the first frequency component and the corresponding second frequency component share the same index. For example, the location of the first frequency component is given by a first index. For example, the location of the corresponding second frequency component is given by a second index. The first index may be the same as the second index.

For example, the first frequency component and the corresponding second frequency component are characterized by the same frequency. For example, the first frequency component is characterized by a first frequency. For example, the corresponding second frequency component is characterized by a second frequency. The first frequency value may be the same as the second frequency.

In one or more example hearing aids, the aliasing artefact detection unit is configured to determine the one or more first aliasing artefact frequency components based on (e.g., by performing) a magnitude comparison between the first primary frequency range of the first frequency domain signal and the second frequency domain signal. In other words, the aliasing artefact detection unit may be configured to determine the one or more first aliasing artefact frequency components by performing a magnitude comparison between the plurality of first components (e.g., associated with the first primary frequency range) and the corresponding plurality of second components. In one or more example hearing aids, the aliasing artefact detection unit is configured to determine the one or more first aliasing artefact frequency components based on (e.g., by) determining whether the magnitude comparison meets a criterion.

In one or more example hearing aids, the aliasing artefact detection unit is configured to determine the one or more second aliasing artefact frequency components based on (e.g., by performing) a magnitude comparison between the first primary frequency range of the first frequency domain signal and the second frequency domain signal. In other words, the aliasing artefact detection unit may be configured to determine the one or more second aliasing artefact frequency components by performing a magnitude comparison between the plurality of first components (e.g., associated with the first primary frequency range) and the corresponding plurality of second components. In one or more example hearing aids, the aliasing artefact detection unit is configured to determine the one or more second aliasing artefact frequency components based on (e.g., by) determining whether the magnitude comparison meets the criterion. For example, the magnitude comparison is performed for each pair of the plurality of pairs of frequency components.

In one or more example hearing aids, each of the plurality of first frequency components (e.g., frequency bands) comprises a number of first time instances. In one or more example hearing aids, each of the plurality of second frequency components (e.g., frequency bands) comprises a number of second time instances. For example, a frequency component of a frequency domain signal can be seen as a portion (e.g., a part) of the frequency domain signal, such portion being associated with a plurality of time instances.

In one or more example hearing aids, the first frequency range is different from the first primary frequency range in such a way that only one of the plurality of frequency components having the same location in the first and second frequency domain signals include an aliasing artefact (only one frequency component of a pair comprises an aliasing artefact).

In one or more example hearing aids, the aliasing artefact detection unit is configured to (e.g., to determine the one or more first aliasing artefact frequency components and the one or more second aliasing artefact frequency components comprises to) determine a first magnitude of the first frequency component of each pair of the plurality of pairs of frequency components. In one or more example hearing aids, the aliasing artefact detection unit is configured to determine a plurality of first magnitude signals or a plurality of first magnitude-squared signals (e.g., one first magnitude signal or one first magnitude-squared signal for each pair of the plurality of pairs of frequency components).

In one or more example hearing aids, the aliasing artefact detection unit is configured to (e.g., to determine the one or more first aliasing artefact frequency components and the one or more second aliasing artefact frequency components comprises to) determine a second magnitude of the corresponding second frequency component of each pair of the plurality of pairs of frequency components. In one or more example hearing aids, the aliasing artefact detection unit is configured to determine a plurality of second magnitude signals or a plurality of second magnitude-squared signals (e.g., one second magnitude signal or one second magnitude-squared signal for each pair of the plurality of pairs of frequency components).

In one or more example hearing aids, the aliasing artefact detection unit is configured to (e.g., to determine the one or more first aliasing artefact frequency components and the one or more second aliasing artefact frequency components comprises to) compare the first magnitude with the second magnitude. In one or more example hearing aids, the aliasing artefact detection unit is configured to (e.g., to determine the one or more first aliasing artefact frequency components and the one or more second aliasing artefact frequency components comprises to) determine whether the magnitude comparison meets a criterion.

In one or more example hearing aids, a magnitude (e.g., the first magnitude and/or the second magnitude) can be construed as one or more of: a power, an energy and an amplitude. In one or more example hearing aids, a magnitude (e.g., the first magnitude and/or the second magnitude) of a frequency component of a frequency domain signal can be seen as a magnitude (e.g., spectral energy, power and/or amplitude) of a portion of a time domain signal from which the frequency domain signal (e.g., the first frequency domain signal and/or the second frequency domain signal) is derived from.

In one or more example hearing aids, to determine the first magnitude of the first frequency component of each pair of the plurality of pairs of frequency components comprises to apply an absolute operator (e.g., an ABS operator) to the first frequency component of each pair of the plurality of pairs of frequency components.

In one or more example hearing aids, to determine the second magnitude of the corresponding second frequency component of each pair of the plurality of pairs of frequency components comprises to apply an absolute operator (e.g., an ABS operator) to the corresponding second frequency component of each pair of the plurality of pairs of frequency components.

In one or more example hearing aids, each of the first and second magnitudes can be seen as absolute values and/or absolute-squared values. For example, determining the first magnitude can comprise determining an energy and/or power of the first frequency component, e.g., a magnitude-squared

$$( e . g . , {y}_{1 , n} = {\sum }_{1}^{N} {\vert {x}_{1 , n} \vert}^{2} ,$$

win n denoting the nth time frame of the first frequency component, n=1, . . . , N, e.g., a moving average magnitude estimate). For example, determining the second magnitude can comprise determining an energy and/or power of the corresponding second frequency component, e.g., a magnitude-squared

$$( e . g . , {y}_{2 , n} = {\sum }_{1}^{N} {\vert {x}_{2 , n} \vert}^{2} ,$$

with n denoting the nth time frame of the second frequency component, n=1, . . . , N, e.g., a moving average magnitude estimate).

In one or more example hearing aids, to determine whether the magnitude comparison meets the criterion comprises to determine that the magnitude comparison meets the criterion when the first magnitude is different from the second magnitude.

In one or more example hearing aids, to determine whether the magnitude comparison meets the criterion comprises to determine that the magnitude comparison does not meet the criterion when the first magnitude is (e.g., approximately) equal to the second magnitude. For example, the first magnitude is (e.g., approximately) equal to the second magnitude when the magnitude comparison is within one or a few dBs. For example, the first magnitude is (e.g., approximately) equal to the second magnitude when the magnitude comparison is equal to or less than 1 dB (e.g., and/or equal to or less than 1.5 dB).

For example, a hearing aid can comprise a microphone matching algorithm configured to (e.g., running while the hearing aid is in use) make the frequency response of the microphones providing a first and second input signals (e.g., from which the first and second frequency domain signals are based on) more similar. For example, microphone matching may compensate for consistent differences between the first and second input signals, e.g., when one microphone response is greater than the other. Microphone differences may occur in special cases: Near field sounds (e.g. own voice) may be louder at one microphone than the other. Handling noise or wind noise may also cause short-term microphone level differences greater than a few dBs. Such differences may be seen across a wider frequency range compared to differences caused by artifact (e.g., ultrasound) aliasing. It may be preferable to disable the microphone matching algorithm while ultrasound is present.

In one or more example hearing aids, the aliasing artefact detection unit configured to determine the one or more first aliasing artefact frequency components by, upon determining that the magnitude comparison meets the criterion, determining that the first magnitude is greater than or equal to the second magnitude by a magnitude threshold. In one or more example hearing aids, the aliasing artefact detection unit configured to determine the one or more first aliasing artefact frequency components by determining the first frequency component as a first aliasing artefact frequency component of the one or more first aliasing artefact frequency components.

In one or more example hearing aids, the aliasing artefact detection unit configured to determine the one or more first aliasing artefact frequency components when the first magnitude is greater than or equal to the second magnitude by the magnitude threshold. In other words, the one or more first aliasing artefact frequency components may be determined when the first magnitude differs from the second magnitude by the magnitude threshold.

In one or more example hearing aids, the aliasing artefact detection unit configured to determine the one or more second aliasing artefact frequency components by, upon determining that the magnitude comparison meets the criterion, determining that the second magnitude is greater than or equal to the first magnitude by the magnitude threshold. In one or more example hearing aids, the aliasing artefact detection unit configured to determine the one or more second aliasing artefact frequency components by determining the corresponding second frequency component as a second aliasing artefact frequency component of the one or more second aliasing artefact frequency components.

In one or more example hearing aids, the aliasing artefact detection unit configured to determine the one or more second aliasing artefact frequency components when the second magnitude is greater than or equal to the first magnitude by the magnitude threshold. In other words, the one or more second aliasing artefact frequency components may be determined when the second magnitude differs from the first magnitude by the magnitude threshold.

In one or more example hearing aids, the magnitude threshold can be given by approximately one or more of: 1 dB, 2 dB, 3 dB, 4 dB, and 5 dB. In one or more example hearing aids, the magnitude threshold can be seen as a range ranging from (e.g., approximately) 1 dB to (e.g., approximately) 5 dB. In one or more example hearing aids, the magnitude threshold can be frequency dependent. For example, at least two pairs of the plurality of frequency components can be associated with different magnitude thresholds. Optionally, the at least two pairs of the plurality of frequency components can be associated with the same magnitude threshold.

In one or more example hearing aids, the aliasing artefact detection unit is configured to, upon determining that the magnitude comparison does not meet the criterion, determine neither the first frequency component as first aliasing artefact frequency component nor the second frequency component as the second aliasing artefact frequency component.

In one or more example hearing aids, the first frequency component of the plurality of first frequency components and the corresponding second frequency component of the plurality of second frequency components are filtered frequency components.

In one or more example hearing aids, the hearing aid comprises a first filtering unit and a second filtering unit. For example, each of the first and second filtering units is a Low Pass Filter (LPF). For example, a filtered frequency component can be seen as a filtered version of a portion of a frequency domain signal. For example, a first filtered frequency component can be seen as a filtered version of a portion of the first frequency domain signal, such portion being associated with the first frequency component. For example, a second filtered frequency component can be seen as a filtered version of a portion of the second frequency domain signal, such portion being associated with the corresponding second frequency component.

In one or more example hearing aids, the first filtering unit is configured to determine a first filtered frequency domain signal based on the first frequency domain signal. For example, the first filtered frequency domain signal comprises a plurality of first filtered frequency components associated with the first frequency range. For example, the first primary frequency range of the first filtered frequency-domain signal comprises the one or more first aliasing artefact frequency components.

In one or more example hearing aids, the second filtering unit is configured to determine a second filtered frequency domain signal based on the second frequency domain signal. For example, the second filtered frequency domain signal comprises a plurality of second filtered frequency components associated with the first primary frequency range. For example, the second frequency-domain signal comprises one or more second aliasing artefact frequency components.

In one or more example hearing aids, a filtering unit (e.g., the first filtering unit, the second filtering unit) is configured to determine a filtered frequency domain signal (e.g., the first filtered frequency domain signal, the second filtered frequency domain signal) by applying an LPF to a frequency domain signal (e.g., the first filtered frequency domain signal, the second filtered frequency domain signal).

For example, a filtering unit (e.g., the first filtering unit and/or the second filtering unit) can be implemented using a first order infinite impulse response (IIR) LPF. For example, a first order IIR LPF can be given by yₙ=(1−λ)*yₙ₋₁+λ*|xₙ|², where |xₙ|² denotes a magnitude-squared (e.g., or a magnitude) estimate of the nth time frame (e.g., for a given frequency channel and/or frequency component), yₙ denotes a low-pass filtered magnitude estimate at the nth time frame, yₙ₋₁ denotes a low-pass filtered magnitude estimate at the (n−1)th time frame, and λ denotes a value controlling the amount of smoothing, e.g., taking values between 0 and 1 (e.g., with value 1 indicating no smoothing effect). For example, a recursive magnitude estimate (e.g., a magnitude of a filtered frequency domain signal) only requires a single memory element instead of a plurality of memory units (e.g., N memory elements) required by a moving average magnitude estimate.

In one or more example hearing aids, the aliasing artefact detection unit is configured to determine the one or more first aliasing artefact frequency components based on a magnitude comparison between the first primary frequency range of the first filtered frequency domain signal and the second filtered frequency domain signal.

In one or more example hearing aids, each of the first and second magnitudes being determined based on a first filtered frequency component of the first filtered frequency domain signal and a corresponding second filtered frequency component of the second filtered frequency domain signal respectively can be seen as filtered magnitudes. Stated differently, such filtered magnitudes may be determined as an average across a plurality of time frames, e.g., either as a moving average

$$( e . g . , {\sum }_{1}^{N} ( 1 / N ) {\vert {x}_{n} \vert}^{2} )$$

as a recursive average (e.g., implemented by an IIR filter, e.g., a recursive filter), where xₙ denotes the n-th frequency components of a frequency domain signal. For example, the first magnitude may be determined as an average across a plurality of first time frames for each of the plurality of first filtered frequency components, such as only the plurality of first filtered frequency components associated with the first primary frequency range. For example, the second magnitude may be determined as an average across a plurality of second time frames for each of the plurality of second filtered frequency components.

Embodiments of the present disclosure may allow that, by filtering the first frequency component of each pair of the plurality of pairs of frequency components and the corresponding second frequency component of each pair of the plurality of pairs of frequency components, the aliasing artefact reduced signal is determined in a controlled manner, e.g., while avoiding rapidly fluctuating decisions. Such a fluctuating decision may refer to decisions taken in the determination of the aliasing artefact reduced signal, e.g., for a given pair of frequency components, on which frequency component (e.g., of the first and second frequency domain signals) of such pair the aliasing artefact reduced signal can be based on for reducing aliasing artefact interference. In other words, it may be an advantage of the present disclosure that, by filtering the first frequency component of each pair of the plurality of pairs of frequency components and the corresponding second frequency component of each pair of the plurality of pairs of frequency components, a more stable aliasing artefact detection unit is achieved. For example, by averaging across several samples (e.g., by filtering), a smaller variance can be achieved, in turn leading to a less fluctuating decision (e.g., a more stable decision).

In one or more example hearing aids, the plurality of pairs of frequency components comprises a set of aliasing pairs and a remaining set of non-aliasing pairs.

In one or more example hearing aids, the set of aliasing pairs includes at least a first aliasing pair and a second aliasing pair. In one or more example hearing aids, the first aliasing pair includes a first aliasing artefact frequency component of the one or more first aliasing artefact frequency components. In one or more example hearing aids, the second aliasing pair includes a second aliasing artefact frequency component of the one or more second aliasing artefact frequency components. In one or more example hearing aids, the set of aliasing pairs can include a third aliasing pair and/or a fourth aliasing pair. The third aliasing pair and/or the fourth aliasing pair may include other first aliasing artefact frequency component of the one or more first aliasing artefact frequency components or other second aliasing artefact frequency component of the one or more second aliasing artefact frequency components.

In one or more example hearing aids, each of the remaining set of non-aliasing pairs includes neither the one or more first aliasing artefact frequency components nor the one or more second aliasing artefact frequency components. In other words, each of the remaining set of non-aliasing pairs may include neither the first aliasing artefact frequency component of the one or more first aliasing artefact frequency components and the second aliasing artefact frequency component of the one or more second aliasing artefact frequency components. For example, each of the remaining set of non-aliasing pairs can include neither the first aliasing artefact frequency component, the second aliasing artefact frequency component of the one or more second aliasing artefact frequency components, the other first aliasing artefact frequency component, and the other second aliasing artefact frequency component.

In one or more example hearing aids, the first aliasing artefact frequency component of the first aliasing pair is different from the second aliasing artefact frequency component of the second aliasing pair. For example, the one or more first aliasing artefact frequency components are different from the one or more second aliasing artefact frequency components.

In one or more example hearing aids, to determine the aliasing artefact reduced signal comprises to determine, for each of the remaining set of non-aliasing pairs, a combined version of the first frequency component and the corresponding second frequency component by applying a multi-channel processing technique to the first frequency component and the corresponding second frequency component. In one or more example hearing aids, the multi-channel processing technique comprises a beamforming technique.

In one or more example hearing aids, the signal processing unit can comprise a beamforming unit. For example, the signal processing unit (e.g., the beamforming unit) is configured to determine, for each of the remaining set of non-aliasing pairs, the combined version by performing a linear combination of the first frequency component and the corresponding second frequency component, thereby allowing for spatial filtering. For example, the signal processing unit (e.g., the beamforming unit) is configured to determine, for each of the remaining set of non-aliasing pairs, the combined version by multiplying each of the first frequency component and the corresponding second frequency component by a constant and adding such frequency components together. For example, spatial filtering is applied to frequency components that are common to the first and second frequency domain signals.

In one or more example hearing aids, a beamforming technique comprises one or more of: a linear constraint minimum variance (LCMV) beamforming technique, a minimum variance distortionless response (MVDR) beamforming technique, a generalized sidelobe cancellation (GSC) technique, and any other suitable beamforming technique.

For example, applying the multi-channel processing technique to the first frequency and the corresponding second frequency can provide for spatial filtering of sounds from an environment of the hearing aid, and thereby enhancing a target acoustic source among a multitude of acoustic sources in the environment of the user wearing the hearing aid.

For example, applying a multi-channel processing technique to the first frequency and the corresponding second frequency can comprise detecting (e.g., adaptively detecting) which direction a particular part of a microphone signal or a wireless signal originates from. The multi-channel processing technique may enable spatial attenuation of background noise sources. For example, the MVDR beamforming technique can enable maintaining sound signals from a target direction (e.g., a look direction) unchanged, while attenuating sound signals from other directions maximally. For example, a generalized sidelobe cancellation (GSC) technique can be seen as an equivalent representation of an MVDR beamformer offering computational and numerical advantages over a direct implementation in its original form.

In one or more example hearing aids, the first frequency domain signal is used as a reference for the determination (e.g., generation) of the aliasing artefact reduced signal. In one or more example hearing aids, the aliasing artefact reduced signal is associated with the first frequency range. In one or more example hearing aids, to determine the aliasing artefact reduced signal comprises to update, for each of the remaining set of non-aliasing pairs, the first frequency component with the corresponding combined version of the first frequency component and the corresponding second frequency component. In one or more example hearing aids, to update the first frequency component with the corresponding combined version of the first frequency component and the corresponding second frequency component comprises to replace the first frequency component with the corresponding combined version. In one or more example hearing aids, the corresponding combined version is determined based on the first frequency component and the corresponding second frequency component. For example, the first frequency component and the corresponding second frequency component share the same location in the first frequency domain signal and the second frequency domain signal, respectively. In other words, the corresponding combined version may result from a combination of two frequency components characterized by the same frequency, thereby allowing replacement of the first frequency component with the corresponding combined version.

For example, each of the remaining set of non-aliasing pairs may comprise no aliasing artefacts, which enables application of a beamforming technique to the first and corresponding second frequency components, in turn leading to improved directionality (e.g., allowing taking advantage of directional noise reduction). For example, the first frequency domain signal may be updated with portions of the second frequency domain signal and with combined portions of the first and second frequency domain signals, such as portions not containing aliasing artefacts.

Optionally, to determine the aliasing artefact reduced signal comprises to forego, for each of the remaining set of non-aliasing pairs, an update of the first frequency component with the corresponding combined version. For example, since the remaining set of non-aliasing pairs do not comprise aliasing artefacts, the first frequency component of each of the remaining set of non-aliasing pairs can be used for determining (e.g., generating) the aliasing artefact reduced signal (e.g., instead of the combined version). For example, the first frequency domain signal may be updated with portions of the second frequency domain signal (e.g., either when the first and second frequency domain signal are obtained from the same microphone or when the first and second frequency domain signal are obtained from different microphones).

In one or more example hearing aids, to determine the aliasing artefact reduced signal comprises to update, for the first aliasing pair, the first frequency component with the corresponding second frequency component. In one or more example hearing aids, to update the first frequency component with the corresponding second frequency component comprises to replace the first frequency component with the corresponding second frequency component. For example, the first aliasing pair comprises a first aliasing artefact frequency component of the one or more first aliasing artefact frequency components. In other words, the first component of the first aliasing pair may include a first aliasing artefact of the one or more first aliasing artefacts.

For example, updating the first frequency component of the first aliasing pair with the corresponding second frequency component of the first aliasing pair enables suppression of the first aliasing artefact in the first frequency domain signal, thus generating the aliasing artefact reduced signal using the first frequency domain signal as a reference.

For example, in such a scenario where the first frequency domain signal is used as reference for determining the aliasing artefact reduced signal, it is not required to perform any action (e.g., removal) on the second aliasing artefact of the second aliasing pair since the first frequency of the second aliasing pair does not include an aliasing artefact. The first frequency of the second aliasing pair may be used in the determination of the aliasing artefact reduced signal.

For example, by updating the first frequency component of the first aliasing pair with the corresponding second frequency component of the first aliasing pair as well as by updating, for each of the remaining set of non-aliasing pairs, the first frequency component of a respective non-aliasing pair with the combined version of the first frequency component and the corresponding second frequency component of the respective non-aliasing pair, a signal with no or minor aliasing artefacts as well as with improved directionality can be provided to the user of the hearing aid. The aliasing artefact reduced signal may be seen as a signal with no (e.g., or minor) aliasing artefacts and with improved directionality.

For example, by determining the aliasing artefact reduced signal using the first frequency domain signal as a reference, an audio signal (e.g., audible signal) with improved intelligibility and perception can be output to the user of the hearing aid. Embodiments of the present disclosure may allow an increase in sound quality achieved from broader bandwidth processing, such as by determining the aliasing artefact reduced signal using the first frequency domain signal as a reference.

In one or more example hearing aids, the second frequency domain signal is used as a reference for the determination (e.g., generation) of the aliasing artefact reduced signal. In one or more example hearing aids, the aliasing artefact reduced signal is associated with the first primary frequency range. In one or more example hearing aids, to determine the aliasing artefact reduced signal comprises to update, for each of the remaining set of non-aliasing pairs, the corresponding second frequency component with the corresponding combined version of the first frequency component and the corresponding second frequency component. In one or more example hearing aids, to update the corresponding second frequency component with the corresponding combined version of the first frequency component and the corresponding second frequency component comprises to replace the corresponding second frequency component with the corresponding combined version. In one or more example hearing aids, the corresponding combined version is determined based on the first frequency component and the corresponding second frequency component. For example, the first frequency component and the corresponding second frequency component share the same location in the first frequency domain signal and the second frequency domain signal, respectively. In other words, the corresponding combined version may result from a combination of two frequency components characterized by the same frequency, thereby allowing replacement of the corresponding second frequency component with the corresponding combined version.

For example, each of the remaining set of non-aliasing pairs may comprise no aliasing artefacts, which enables application of a beamforming technique to the first and corresponding second frequency components, in turn leading to improved directionality (e.g., allowing taking advantage of directional noise reduction). For example, the second frequency domain signal may be updated with portions of the first frequency domain signal and with combined portions of the first and second frequency domain signals, such as portions not containing aliasing artefacts.

Optionally, to determine the aliasing artefact reduced signal comprises to forego, for each of the remaining set of non-aliasing pairs, an update of the corresponding second frequency component with the corresponding combined version. For example, since the remaining set of non-aliasing pairs do not comprise aliasing artefacts, the corresponding frequency component of each of the remaining set of non-aliasing pairs can be used for determining (e.g., generating) the aliasing artefact reduced signal (e.g., instead of the combined version). For example, the second frequency domain signal may be updated with portions of the first frequency domain signal (e.g., either when the first and second frequency domain signal are obtained from the same microphone or when the first and second frequency domain signal are obtained from different microphones).

In one or more example hearing aids, to determine the aliasing artefact reduced signal comprises to update, for the second aliasing pair, the corresponding second frequency component with the first frequency component. In one or more example hearing aids, to update the corresponding second frequency component with the first frequency component comprises to replace the corresponding second frequency component with the first frequency component. For example, the second aliasing pair comprises a second aliasing artefact frequency component of the one or more second aliasing artefact frequency components. In other words, the corresponding second component of the second aliasing pair may include a second aliasing artefact of the one or more second aliasing artefacts.

For example, updating the corresponding second frequency component of the second aliasing pair with the first frequency component of the second aliasing pair enables suppression of the second aliasing artefact in the second frequency domain signal, thus generating the aliasing artefact reduced signal using the second frequency domain signal as a reference.

For example, in such a scenario where the second frequency domain signal is used as reference for determining the aliasing artefact reduced signal, it is not required to perform any action (e.g., removal) on the first aliasing artefact of the first aliasing pair since the corresponding second frequency of the first aliasing pair does not include an aliasing artefact. The corresponding second frequency of the first aliasing pair may be used in the determination of the aliasing artefact reduced signal.

For example, by updating the corresponding second frequency component of the second aliasing pair with the first frequency component of the second aliasing pair as well as by updating, for each of the remaining set of non-aliasing pairs, the corresponding second frequency component of a respective non-aliasing pair with the combined version of the first frequency component and the corresponding second frequency component of the respective non-aliasing pair, a signal with no or minor aliasing artefacts as well as with improved directionality can be provided to the user of the hearing aid. The aliasing artefact reduced signal may be seen as a signal with no (e.g., or minor) aliasing artefacts and with improved directionality.

Embodiments of the present disclosure can advantageously provide for a signal with no or minor aliasing artefacts (e.g., the aliasing artefact reduced signal) by properly combining the first and second frequency domain signals. Such proper combination can, for example, be performed for each pair of the plurality of pairs of frequency components, each pair comprising a first frequency component of the first primary frequency range of the first frequency domain signal and a corresponding second frequency component of the second frequency domain signal, in turn determining the aliasing artefact reduced signal based on the frequency components (e.g., either the first frequency component or the corresponding second frequency component) where the aliasing artefacts are absent (e.g., or minor).

In one or more example hearing aids, the first aliasing artefact comprises a first ultrasound artefact. In one or more example hearing aids, the second aliasing artefact comprises a second ultrasound artefact. In one or more example hearing aids, the first ultrasound artefact is different from the second ultrasound artefact.

For example, a first ultrasound artefact comprised by a first aliasing artefact frequency component of the one or more first aliasing artefact frequency components may be different from a first ultrasound artefact comprised by another first aliasing artefact frequency component of the one or more first aliasing artefact frequency components in the sense that such first ultrasound artefacts are comprised by different first aliasing artefact frequency components, but resulting (e.g., originating) from the same ultrasound source. For example, a second ultrasound artefact comprised by a second aliasing artefact frequency component of the one or more first aliasing artefact frequency components may be different from a second ultrasound artefact comprised by another second aliasing artefact frequency component of the one or more first aliasing artefact frequency components in the sense that such second ultrasound artefacts are comprised by different second aliasing artefact frequency components, but resulting (e.g., originating) from the same ultrasound source. An ultrasound source may be seen as a source in an environment of the hearing aid originating appearance of one or more first ultrasound artefacts in the first frequency range of the first frequency domain signal as well as of one or more second ultrasound artefacts in the second frequency domain signal (e.g., in the first primary frequency range of the second frequency domain signal).

For example, an aliasing source can comprise an ultrasound source. The one or more first aliasing artefact frequency components may be seen as one or more first ultrasound artefact frequency components. The one or more second aliasing artefact frequency components may be seen as one or more second ultrasound artefact frequency components.

For example, an ultrasound source can comprise one or more of: motion detectors (e.g., room occupancy sensors), automatic doors, mobile devices, medical devices, parking sensors, and any other suitable sources configured to perform ultrasound emissions. For example, an ultrasound is a sound with a frequency above the audible frequency range (e.g., above 20 kHz).

For example, embodiments of the present disclosure can ensure that the one or more first ultrasound artefact frequency components are different from the one or more second ultrasound artefact frequency components by having the first frequency domain signal and second frequency domain signals associated with different frequency ranges, e.g., by having such frequency domain signals resulting from input signals sampled with different sampling rates.

In other words, for a given ultrasound source, an ultrasound artefact may occur at a certain set of frequency components of a frequency domain signal. Such a set of frequency components comprising the ultrasound artefact may be dependent on dependent on the sampling rate used to sample an input signal from which the frequency domain signal is based on. For example, when a set of frequency domain signals are associated with different sampling rates, it may be more likely to have the set of frequency domain signals comprising one or more ultrasound artefact frequency components different from each other. Similarly, when the ultrasound source contains more than one frequency, such ultrasound artefact may also occur at a different set of frequency components. The origin of the ultrasound artefacts (e.g., occurring on the one or more ultrasound frequency components of each set of frequency domain signals) may be the same.

Embodiments of the present disclosure can advantageously enable provision of an output signal (e.g., the output of an audible signal) comprising no or a minor level of ultrasound artefacts, such as a signal less impacted by ultrasonic interference, in turn improving a user's hearing experience. Stated differently, embodiments of the present disclosure may provide for suppression of ultrasound artifacts in the range of each of the first and second frequency domain signals, which can be particularly useful in a challenging ultrasound environment (e.g., in an environment of the hearing aid with substantial ultrasound interference).

For example, ultrasound is more stable across time when compared to wind noise, in turn allowing determination of the aliasing artefact reduced signal in a controlled manner, e.g., while avoiding rapidly fluctuating decisions.

In one or more example hearing aids, in a rare case where an aliasing pair of the set of aliasing pairs comprises two aliasing artefact frequency components (e.g., the first frequency component and the second corresponding frequency component of such pair are determined as aliasing artefact frequency components by the aliasing artefact detection unit), the signal processing unit can be configured to determine the aliasing artefact reduced signal by applying a gain to attenuate the aliasing artefacts present on the first frequency component and the second corresponding frequency component of such pair. In other words, in a case where the same microphone frequency channel (e.g., component) is affected by an aliasing artefact, the particular frequency channel may be attenuated while aliasing artefacts are present. In one or more example hearing aids, the aliasing artefact detection unit can detect (e.g., determine) the two aliasing artefact frequency components based on a broadband detection. For example, when an aliasing artefact is detected in any frequency component, such frequency component band where the aliasing artefact co-occur can be attenuated (e.g., by the signal processing unit), e.g., independent on whether an aliasing artefact actually exist in such frequency band.

In cases where the aliasing artefact detection unit is not able to detect aliasing artefacts in the same frequency components (e.g., when the magnitude comparison meets the criterion or when the magnitude comparison does not meet the criterion), the signal processing unit may be configured to determine a combined version of the first frequency component and the corresponding second frequency component by applying the multi-channel processing technique to the first frequency component and the corresponding second frequency component.

For example, for given sampling rate fₛ (e.g., fₛ_{₁} of FIG. 1A or fₛ_{₂} of FIG. 1B), the aliasing artefact frequency components with a triangular pattern can be distributed around fₛ/2, 3fₛ/2, 5fₛ/2, etc. Whenever the triangular patterns associated with two digitized signals sampled at two different sampling rates overlap, the aliasing artefact frequency components of each of the two digitized signals may occur at the same frequency component.

For example, when the first sampling rate is 30 kHz and the second sampling rate is 20 kHz, the patterns of each of the two digitized signals may cross each other (e.g., intersect) at frequency components 25 kHz and 35 kHz, and between 50 kHz and 70 kHz all the aliasing artefacts may be mapped to similar (e.g., the same) frequency components.

For example, when the first sampling rate is 30 kHz, the second sampling rate is 20 kHz, and the third sampling rate is 25 kHz, it becomes less likely that all three triangular patterns overlap at the same frequency component, with the first overlap happening at frequency component 55 kHz, thereby avoiding that a specific frequency component has co-occurring aliasing artefacts for the first, second and third sampling rates. In other words, a hearing aid comprising an input unit configured to provide three frequency-domain signals, each of the associated with different sampling rates, can advantageously ensure that at least one of the three frequency domain signals does not contain any aliasing artefact at the same frequency component, thereby avoiding co-occurrence of aliasing artefacts.

For example, frequency components where aliasing artefacts are present need to be attenuated. For example, the aliasing artefact detection unit can be configured to detect aliasing artefact frequency components based on a broadband detection. In other words, the aliasing artefact detection unit may be configured to determine in which frequency component the first and second frequency domain signals may be likely to have a certain aliasing artefact in common (e.g., the first and second frequency domain signals comprise an aliasing artefact in the same frequency component). For example, the signal processing unit may be configured to attenuate the aliasing artefacts present on the first frequency component and the second corresponding frequency component of such pair. For example, it may be advantageous to enable an aliasing artefact reduction mode of the hearing aid when presence of an aliasing artefact is detected. Detection of an aliasing artefact at one frequency component may enable the aliasing artefact reduction (e.g., attenuation) mode across all frequency components.

In one or more example hearing aids, the input unit comprises a first analysis filter bank and a second analysis filter bank. Optionally, the input unit is in communication with the first analysis filter bank and the second analysis filter bank. In one or more example hearing aids, the first analysis filter bank is configured to provide (e.g., determine) the first frequency-domain signal based on a first digitized signal. For example, the first analysis filter bank is configured to provide a time-frequency (TF) representation of the first digitized signal. In other words, the first frequency-domain signal may be indicative of a TF representation (e.g., a frequency domain representation) of the first digitized signal. In one or more example hearing aids, the second analysis filter bank is configured to provide (e.g., determine) the second frequency-domain signal based on a second digitized signal. For example, the second analysis filter bank is configured to provide a TF representation of the second digitized signal. In other words, the second frequency-domain signal may be indicative of a TF representation (e.g., a frequency domain representation) of the second digitized signal.

In one or more example hearing aids, a TF representation of a signal (e.g., a digitized signal) may comprise an array or map of corresponding complex or real values of the signal in a given time and frequency range. An analysis filter bank may be configured to filter the signal (e.g., a time varying signal) and providing a number of output signals (e.g., time varying output signals), each of the output signals comprising a distinct frequency range of the signal. In other words, the analysis filter bank may be configured to provide a frequency domain representation of a signal (e.g., of a digitized signal).

For example, an analysis filter bank is configured to apply to the signal (e.g., a digitized signal) one or more of: a Discrete Fourier Transform (DFT) algorithm, a Short Time Fourier Transform (STFT) algorithm, a Fast Fourier Transform (FFT) algorithm and any other suitable algorithm. In other words, an analysis filter bank may be configured to convert a time variant signal to a (time variant) signal in the (time-)frequency domain.

For example, the frequency range ranging from a minimum frequency fₘᵢₙ to a maximum frequency fₘₐₓ may comprise a part of the typical human audible frequency range from 20 Hz to 20 kHz (e.g., a part of the range from 20 Hz to 12 kHz). For example, a sampling rate fₛ is larger than or equal to twice the maximum frequency fₘₐₓ, fₛ≥2fₘₐₓ. Each of the plurality of digitized signals (e.g., first digitized signal, second digitized signal, third digitized signal, fourth digitized signal) may be split into a number NI of frequency bands (e.g., of uniform width), where NI is e.g., larger than 5, such as larger than 10, such as larger than 50, such as larger than 100, such as larger than 500, at least some of which are processed individually. The hearing aid may be configured to process each of the plurality of digitized signals in a number NP of different frequency channels (NP≤NI). The frequency channels may be uniform or non-uniform in width (e.g., increasing in width with frequency), overlapping or non-overlapping.

In one or more example hearing aids, the input unit comprises a first analogue-to-digital (AD) conversion unit and a second AD conversion unit. In one or more example hearing aids, the first AD conversion unit is configured to digitize a first input signal using the first sampling rate for provision of the first digitized signal. In one or more example hearing aids, the second AD conversion unit is configured to digitize a second input signal using the second sampling rate for provision of the second digitized signal. In one or more example hearing aids, the first sampling rate is greater than the second sampling rate.

In one or more example hearing aids, a digitized signal can be construed as a signal sampled at a given sampling rate or sampling frequency (e.g., a digitally sampled signal). For example, a frequency domain signal can be seen as a frequency domain representation of a digitally sampled input signal. The first frequency domain signal may indicate a frequency domain representation of the first input signal sampled at (e.g., using) the first sampling rate. The second frequency domain signal may indicate a frequency domain representation of the second input signal sampled at (e.g., using) the second sampling rate.

For example, the input unit is configured to determine the first frequency-domain signal based on the first digitized signal. For example, the input unit is configured to determine the second frequency-domain signal based on the second digitized signal.

In one or more example hearing aids, each of the first and second input signals is provided in a digitized form. In one or more example hearing aids, the hearing aid comprises an analogue-to-digital (AD) converter configured to digitize an analogue input (e.g., from an input transducer, such as a microphone) with a predefined sampling rate (e.g., 20 kHz). In other words, the AD converter may be configured to provide each of first and second input signals in a digitized form. In other words, the AD converter may be configured to provide each of the first and second input signals as a digitally sampled signal (e.g., a digital audio signal).

For example, each of the first and second input signals (e.g., an analogue electrical signal) may be converted to a digital audio signal in an AD conversion process, where each of the first and second input signals is sampled with a predefined sampling frequency or rate fₛ (fₛ being e.g., in the range from 8 kHz to 48 kHz) to provide digital (e.g., audio) samples xₙ (with n=1, . . . , N) at discrete points in time tₙ (with n=1, . . . , N), each digital (e.g., audio) sample representing the value of a respective electrical input signal at ty by a predefined number N_{b} of bits (Np being e.g., in the range from 1 to 48 bits, e.g., 24 bits). The sampling frequency or rate fₛ may be adapted to the particular needs of the application. For example, each digital (e.g., audio) sample is quantized using N_{b} bits (e.g., resulting in 2^{N}^{_{b}} different possible values of the digital sample). For example, a digital sample xₙ has a length in time of 1/fₛ (e.g., 50 μs for fₛ=20 kHz). A number of digital (e.g., audio) samples may be arranged in a time frame. A time frame may comprise 64 or 128 audio data samples. Other frame lengths may be used depending on the practical application. For example, each of the first and second input signals comprises a number of digital samples arranged in a time frame. In other words, each of the first and second input signals comprises a plurality of time frames.

Optionally, each of the first and second input signals can be sampled with a sampling frequency or rate fₛ of e.g., 640 kHz, to provide a plurality of first digital samples. Performing the AD conversion process may comprise applying a digital LP filter to each of the plurality of first digital samples for provision of a plurality of filtered digital samples. Performing the AD conversion process may comprise downsampling each of the plurality of filtered digital samples by a given factor, e.g., by a factor of 32. In other words, an AD conversion process may include sampling an input signal at a higher frequency, followed by a digital LP filter and a downsampling process.

For example, the frequency range of the second frequency-domain signal is a subset of the frequency range of the first frequency-domain signal. In other words, the first sampling rate is greater than the second sampling rate.

For example, a signal component of an analogue signal, the signal component located at a frequency component above half of the sampling rate fₛ/2 can be mapped to a signal component of a digitized signal located at a frequency component up to half of the sampling rate fₛ/2 (e.g., to an aliasing artefact frequency component) during the AD conversion process, thereby causing appearance of an aliasing artefact on that frequency component up to half of the sampling rate fₛ/2 of the digitized signal. The one or more first aliasing artefact frequency components are different from the one or more first aliasing artefact frequency components as the first sampling rate different from the second sampling rate.

In one or more example hearing aids, the first sampling rate can be given by 30 kHz and the second sampling rate is given by 20 kHz. In one or more example hearing aids, the first sampling rate can be given by 32 kHz and the second sampling rate is given by 20 kHz. For example, the first analysis filter bank can be associated with an FFT size of 192 and the second analysis filter bank can be associated with an FFT size of 128 when the first sampling rate is given by 30 kHz and the second sampling rate is given by 20 kHz (e.g., hereby obtaining a bandwidth of 156.25 Hz). For example, the first analysis filter bank can be associated with an FFT size of 256 and the second analysis filter bank can be associated with an FFT size of 160 when the first sampling rate is given by 32 kHz and the second sampling rate is given by 20 kHz (e.g., hereby obtaining a bandwidth of 125 Hz).

For example, a ratio between the first and second sampling rate of 2:3 (e.g., 20 kHz divided by 30 kHz) can lead to more aliasing artefact frequency components in common (e.g., pairs comprising two aliasing artefacts) than when compared to ratios of 4:5 or 5:6. In other words, it may be more likely to experience co-occurrence of aliasing artefacts (e.g., aliasing artefacts in the same frequency component of the first and second frequency domain signal) when compared to ratios of 4:5 or 5:6.

In one or more example hearing aids, the input unit comprises a first microphone and a second microphone. In one or more example hearing aids, the first microphone is configured to provide the first input signal. In one or more example hearing aids, the second microphone is configured to provide the second input signal. In one or more example hearing aids, the first input signal and the second input signal are representative of a sound in an environment of the hearing aid.

In one or more example hearing aids, the input unit comprises a microphone configured to provide the first input signal and the second input. In one or more example hearing aids, the first input signal and the second input are representative of a sound in an environment of the hearing aid. For example, the first and second input signals are similar to each other, having e.g., a small phase difference as the first and second input signals (e.g., sampled at different sampling rates) may be filtered by two different anti-aliasing low-pass filters. For example, the hearing aid does not comprise a beamforming unit when the input unit comprises a single microphone configured to provide the first input signal and the second input.

For example, when a single microphone is configured to provide the first input signal and the second input signal, the magnitude associated with a given frequency component of the first frequency domain signal is approximately equal to the magnitude associated with the given frequency component of the second frequency domain signal (e.g., thereby not meeting the criterion). For example, when such magnitudes are approximately equal, any one of the portions of the first and second frequency domain signal associated with the given frequency component can be used to determine the aliasing artefact reduced signal.

For example, when the first input signal and the second input signal are provided by different microphones, the portions of the first and second frequency domain signal associated with the given frequency component can be combined into a beamformed signal.

For example, a microphone (e.g., an input transducers) is configured to convert an input sound in an environment of the hearing aid to an electric input signal.

In one or more example hearing aids, each of the first and second input signals is indicative of a sound generated by the user of the hearing aid, people, or other sound sources (e.g., ultrasound sources) in the environment of the hearing device.

For example, an input signal may be indicative of user speech comprising one or more aliasing artefacts (e.g., ultrasound artefacts). For example, an input signal may be indicative of a sound output by an electronic device (e.g., a mobile phone, a computer, a speaker) comprising one or more aliasing artefacts (e.g., ultrasound artefacts). For example, each of the first and second input signals may comprise an ultrasound component (e.g., an ultrasound signal pulse). For example, the aliasing artefact detection unit can be configured to detect an ultrasound component in each of the first and second input signals (e.g., by detecting a power level, such as by detecting a signal with a power level that is above a threshold for a considerable time duration, and/or by detecting a signal with a repetitive pattern). In one or more example hearing aids, a neural network can be trained to detect aliasing artefacts (e.g., ultrasound artefacts) based on training data comprising time-frequency patterns of signals sampled at two different sample rates. The training data may comprise one or more frequency domain signals comprising aliasing artefacts. The training data may comprise one or more frequency domain signals without aliasing artefacts. The training data may comprise frequency domain signals comprising aliasing artefacts and not comprising aliasing artefacts.

In one or more example hearing aids, the hearing aid (e.g., the output unit) comprises a synthesis filter configured to convert the aliasing artefact reduced signal (e.g., a frequency-domain signal) to a time-domain signal. In one or more example hearing aids, the synthesis filter is configured to operate at either the highest sampling rate or the lowest of the first and the second sampling rates (e.g., depending on the frequency range of the aliasing artefact reduced signal). The synthesis filter may be configured to operate at the first sampling rate when the aliasing artefact reduced signal is associated with the first frequency range. The synthesis filter may be configured to operate at the second sampling rate when the aliasing artefact reduced signal is associated with the first primary frequency range. The synthesis filter may be configured to provide the aliasing artefact reduced signal as a time-domain signal sampled at the first sampling rate or the second sampling rate.

In one or more example hearing aids, the hearing aid comprises a memory configured to store the first frequency-domain signal, the second frequency-domain signal, the one or more first aliasing artefact frequency components, the one or more second aliasing artefact frequency components, the aliasing artefact reduced signal in a part of the memory.

In one or more example hearing aids, the hearing aid comprises a ‘forward’ (or ‘signal’) path configured to process an audio signal between an input and an output of the hearing aid. In one or more example hearing aids, the hearing aid comprises a signal processing unit configured to apply one or more processing algorithms to the first and second input signals, e.g., input signals of a forward path from the input to the output of the hearing aid. The signal processing unit may be located in the forward path. The one or more processing algorithms may e.g. comprise a compression algorithm configured to amplify (or attenuate) a signal according to the needs of the user, e.g. to compensate for a hearing impairment of the user. Other processing algorithms may include frequency transposition, feedback control (e.g., cancellation), etc. For example, the signal processing unit is configured to provide a frequency dependent gain and/or a level dependent compression and/or a transposition (with or without frequency compression) of one or more frequency ranges to one or more other frequency ranges, e.g., to compensate for a hearing impairment of a user. The signal processing unit may be configured to enhance the first and second input signals and provide a processed output signal, such as the aliasing artefact reduced signal.

The hearing aid may comprise an ‘analysis’ path comprising functional components configured to analyze signals and/or controlling processing of the forward path. Some or all signal processing of the analysis path and/or the forward path may be conducted in the frequency domain, in which case the hearing aid comprises appropriate analysis and synthesis filter banks. Some or all signal processing of the analysis path and/or the forward path may be conducted in the time domain.

In one or more example hearing aids, the hearing aid comprises a directional microphone system configured to spatially filter sounds from the environment, and thereby enhance a target acoustic source among a multitude of acoustic sources in the local environment of the user wearing the hearing aid. The directional system may be adapted to detect (such as adaptively detect) from which direction a particular part of the microphone signal originates. In hearing aids, a microphone array beamformer is often used for spatially attenuating background noise sources. The beamformer may comprise a linear constraint minimum variance (LCMV) beamformer. Many beamformer variants can be found in literature. The minimum variance distortionless response (MVDR) beamformer is widely used in microphone array signal processing. Ideally the MVDR beamformer keeps the signals from the target direction (also referred to as the look direction) unchanged, while attenuating sound signals from other directions maximally. The generalized sidelobe canceller (GSC) structure is an equivalent representation of the MVDR beamformer offering computational and numerical advantages over a direct implementation in its original form.

Most sound signal sources (except the user's own voice) are located far away from the user compared to dimensions of the hearing aid, e.g. a distance d_{mic} between two microphones of a directional system. A typical microphone distance in a hearing aid is of the order 10 mm. A minimum distance of a sound source of interest to the user (e.g. sound from the user's mouth or sound from an audio delivery device) is of the order of 0.1 m (>10 d_{mic}). For such minimum distances, the hearing aid (e.g., microphones) would be in the acoustic near-field of the sound source and a difference in level of the sound signals impinging on respective microphones may be significant. A typical distance for a communication partner is more than 1 m (>100 d_{mic}). The hearing aid (e.g., microphones) would be in the acoustic far-field of the sound source and a difference in level of the sound signals impinging on respective microphones is insignificant. The difference in time of arrival of sound impinging in the direction of the microphone axis (e.g., the front or back of a normal hearing aid) is ΔT=d_{mic}/v_{sound}=0.01/343 [s]=29 μs, where v_{sound} is the speed of sound in air at 20° C. (343 m/s).

In one or more example hearing aids, the hearing aid comprises antenna and transceiver circuitry allowing a wireless link to an entertainment device (e.g. a TV-set), a communication device (e.g. a telephone), a wireless microphone, a separate (external) processing device, or another hearing aid, etc. The hearing aid may be configured to wirelessly receive a direct electric input signal from another device. Likewise, the hearing aid may be configured to wirelessly transmit a direct electric output signal to another device. The direct electric input or output signal may represent or comprise an audio signal and/or a control signal and/or an information signal.

A wireless link established by antenna and transceiver circuitry of the hearing aid may be of any type. The wireless link may be a link based on near-field communication, e.g. an inductive link based on an inductive coupling between antenna coils of transmitter and receiver parts. The wireless link may be based on far-field, electromagnetic radiation. Preferably, frequencies used to establish a communication link between the hearing aid and the other device is below 70 GHz, e.g. located in a range from 50 MHz to 70 GHz, e.g. above 300 MHz, e.g. in an ISM range above 300 MHz, e.g. in the 900 MHz range or in the 2.4 GHz range or in the 5.8 GHz range or in the 60 GHz range (ISM=Industrial, Scientific and Medical, such standardized ranges being e.g. defined by the International Telecommunication Union, ITU). The wireless link may be based on a standardized or proprietary technology. The wireless link may be based on Bluetooth technology (e.g. Bluetooth Low-Energy technology, e.g. LE audio), or Ultra-Wideband (UWB) technology.

In one or more example hearing aids, the hearing aid can be constituted by or form part of a portable (e.g., configured to be wearable) device, such as a device comprising a local energy source, e.g., a battery (e.g. a rechargeable battery). The hearing aid may be a low weight, easily wearable, device, e.g., having a total weight less than 100 g, such as less than 20 g, such as less than 5 g.

The hearing aid may be configured to operate in different modes, e.g., a normal mode and one or more specific modes, e.g., selectable by a user, or automatically selectable. A mode of operation may be optimized to a specific acoustic situation or environment, e.g., a communication mode, such as a telephone mode. A mode of operation may include a low-power mode, where functionality of the hearing aid is reduced (e.g., to save power), e.g. to disable wireless communication, and/or to disable specific features of the hearing aid.

The hearing aid may comprise a number of detectors configured to provide status signals relating to a current physical environment of the hearing aid (e.g., the current acoustic environment), and/or to a current state of the user wearing the hearing aid, and/or to a current state or mode of operation of the hearing aid. Alternatively or additionally, one or more detectors may form part of an external device in communication (e.g., wirelessly) with the hearing aid. An external device may e.g. comprise another hearing aid, a remote control, and audio delivery device, a telephone (e.g., a smartphone), an external sensor, etc.

One or more of the number of detectors may operate on the full band signal (time domain). One or more of the number of detectors may operate on band split signals ((time-) frequency domain), e.g., in a limited number of frequency bands.

The number of detectors may comprise a level detector for estimating a current level of a signal of the forward path. The detector may be configured to decide whether the current level of a signal of the forward path is above or below a given (L-)threshold value. The level detector operates on the full band signal (time domain). The level detector operates on band split signals ((time-) frequency domain).

The hearing aid may comprise a voice activity detector (VAD) for estimating whether or not (or with what probability) an input signal comprises a voice signal (at a given point in time). A voice signal may in the present context be taken to include a speech signal from a human being. It may also include other forms of utterances generated by the human speech system (e.g., singing). The voice activity detector unit may be adapted to classify a current acoustic environment of the user as a VOICE or NO-VOICE environment. This has the advantage that time segments of the electric microphone signal comprising human utterances (e.g., speech) in the user's environment can be identified, and thus separated from time segments only (or mainly) comprising other sound sources (e.g., artificially generated noise). The voice activity detector may be adapted to detect as a VOICE also the user's own voice. Alternatively, the voice activity detector may be adapted to exclude a user's own voice from the detection of a VOICE.

The hearing aid may comprise an own voice detector for estimating whether or not (or with what probability) a given input sound (e.g., a voice, e.g. speech) originates from the voice of the user of the system. A microphone system of the hearing aid may be adapted to be able to differentiate between a user's own voice and another person's voice and possibly from NON-voice sounds.

The number of detectors may comprise a movement detector, e.g., an acceleration sensor. The movement detector may be configured to detect movement of the user's facial muscles and/or bones, e.g., due to speech or chewing (e.g., jaw movement) and to provide a detector signal indicative thereof.

The hearing aid may comprise a classification unit configured to classify the current situation based on input signals from (at least some of) the detectors, and possibly other inputs as well. In the present context ‘a current situation’ may be taken to be defined by one or more of
a) the physical environment (e.g., including the current electromagnetic environment, e.g. the occurrence of electromagnetic signals (e.g., comprising audio and/or control signals) intended or not intended for reception by the hearing aid, or other properties of the current environment than acoustic);
b) the current acoustic situation (e.g., input level, feedback, etc.), and
c) the current mode or state of the user (e.g., movement, temperature, cognitive load, etc.);
d) the current mode or state of the hearing aid (e.g., program selected, time elapsed since last user interaction, etc.) and/or of another device in communication with the hearing aid.

The classification unit may be based on or comprise a neural network, e.g. a recurrent neural network, e.g., a trained neural network.

In one or more example hearing aids, the hearing aid comprises an acoustic (and/or mechanical) feedback control (e.g., suppression) or an echo-cancelling system. For example, adaptive feedback cancellation allows tracking feedback path changes over time. It may be based on a linear time invariant filter to estimate the feedback path, with its filter weights being updated over time. The filter update may be calculated using stochastic gradient algorithms, such as a Least Mean Square (LMS) algorithm or a Normalized LMS (NLMS) algorithm. For example, such algorithms may enable minimization of the error signal in the mean square sense with the NLMS additionally normalizing the filter update with respect to the squared Euclidean norm of some reference signal.

In one or more example hearing aids, the hearing aid can further comprise other relevant functionality for the application in question, e.g. compression, noise reduction, etc.

In one or more example hearing aids, the hearing aid comprises a hearing instrument, e.g., a hearing instrument adapted for being located at the ear or fully or partially in the ear canal of a user.

### Use:

In an aspect, use of a hearing aid as described above, in the ‘detailed description of embodiments’ and in the claims, is moreover provided. Use may be provided in a system comprising one or more hearing aids (e.g. hearing instruments).

### A Method:

A method of operating a hearing aid is disclosed.

The method comprises determining a first frequency-domain signal based on a first input signal. The first frequency-domain signal comprises a plurality of first frequency components associated with a first frequency range. A first primary frequency range being a subset of the first frequency range. The first primary frequency range of the first frequency-domain signal comprises one or more first aliasing artefact frequency components. Each of the one or more first aliasing artefact frequency components is indicative of a frequency component of the plurality of first frequency components including a first aliasing artefact.

The method comprises determining a second frequency-domain signal based on a second input signal. The second frequency-domain signal comprises a plurality of second frequency components associated with the first primary frequency range. The second frequency-domain signal comprises one or more second aliasing artefact frequency components. Each of the one or more second aliasing artefact frequency components is indicative of a frequency component of the plurality of second frequency components including a second aliasing artefact.

Each of the first input signal and second input signal is representative of a sound in an environment of the hearing aid, the environment of the hearing aid comprising an aliasing source.

The method comprises determining the one or more first aliasing artefact frequency components and the one or more second aliasing artefact frequency components based on a magnitude comparison between the first primary frequency range of the first frequency domain signal and the second frequency domain signal.

The method comprises determining, based on the first frequency domain signal, the second frequency domain signal, the one or more first aliasing artefact frequency components and the one or more second aliasing artefact frequency components, an aliasing artefact reduced signal.

The method comprises outputting, based on the aliasing artefact reduced signal, an audible signal to the user wearing the hearing aid.

It is intended that some or all of the structural features of the hearing aid described above, in the ‘detailed description of embodiments’ or in the claims can be combined with embodiments of the method of operating the hearing aid, when appropriately substituted by a corresponding process and vice versa. Embodiments of the method of operating the hearing aid have the same advantages as the corresponding hearing aid (e.g., and/or hearing system).

### A Computer Readable Medium or Data Carrier:

In an aspect, a tangible computer-readable medium (a data carrier) storing a computer program comprising program code means (instructions) for causing a data processing system (a computer) to perform (carry out) at least some (such as a majority or all) of the (steps of the) method described above, in the ‘detailed description of embodiments’ and in the claims, when said computer program is executed on the data processing system is furthermore provided by the present application.

By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Other storage media include storage in DNA (e.g. in synthesized DNA strands). Combinations of the above should also be included within the scope of computer-readable media. In addition to being stored on a tangible medium, the computer program can also be transmitted via a transmission medium such as a wired or wireless link or a network, e.g. the Internet, and loaded into a data processing system for being executed at a location different from that of the tangible medium.

### A Computer Program:

A computer program (product) comprising instructions which, when the program is executed by a computer, cause the computer to carry out (steps of) the method described above, in the ‘detailed description of embodiments’ and in the claims is furthermore provided by the present application.

### A Data Processing System:

In an aspect, a data processing system comprising a processor and program code means for causing the processor to perform at least some (such as a majority or all) of the steps of the method described above, in the ‘detailed description of embodiments’ and in the claims is furthermore provided by the present application.

### A Hearing System:

In a further aspect, a hearing system comprising a hearing aid as described above, in the ‘detailed description of embodiments’, and in the claims, and an auxiliary device is moreover provided.

The hearing system may be adapted to establish a communication link between the hearing aid and the auxiliary device to provide that information (e.g., control and status signals, possibly audio signals) can be exchanged or forwarded from one to the other. The hearing system may be configured to perform the processing, e.g. aliasing artefact (e.g., ultrasound) reduction, according to the present disclosure, fully or partially in a separate audio processing device.

The auxiliary device may be constituted by or comprise a remote control, a smartphone, or other portable or wearable electronic device, such as a smartwatch or the like.

The auxiliary device may be constituted by or comprise a remote control for controlling functionality and operation of the hearing aid(s). The function of a remote control may be implemented in a smartphone, the smartphone possibly running an APP allowing to control the functionality of the audio processing device via the smartphone (the hearing aid(s) comprising an appropriate wireless interface to the smartphone, e.g. based on Bluetooth or some other standardized or proprietary scheme).

The auxiliary device may be constituted by or comprise an audio gateway device adapted for receiving a multitude of audio signals (e.g., from an entertainment device, e.g. a TV or a music player, a telephone apparatus, e.g. a mobile telephone or a computer, e.g., a PC, a wireless microphone, etc.) and adapted for selecting and/or combining an appropriate one of the received audio signals (or combination of signals) for transmission to the hearing aid.

The auxiliary device may be constituted by or comprise another hearing aid. The hearing system may comprise two hearing aids adapted to implement a binaural hearing system, e.g. a binaural hearing aid system. For example, each of the two hearing aids is configured to determine the corresponding one or more first and second aliasing artefact frequency components, in turn determining a corresponding aliasing artefact reduced signal based thereon. For example, one of the two hearing aids is configured to determine the one or more first and second aliasing artefact frequency components associated with the first and second frequency domain signals being provided by the input unit, in turn determining an aliasing artefact reduced signal based thereon. The one of the two hearing aids determining the aliasing artefact reduced signal may transmit such aliasing artefact reduced signal to the other of the two hearing aids.

For example, the classification of the current situation (e.g., by the classification unit) can be a binaural decision. In other words, when there is an aliasing artefact in one of the two hearing aids (e.g., when the first and the second frequency domain signals associated with the one of the two hearing aids comprise aliasing artefacts), it may be likely that an aliasing artefact also exists in the other of the two hearing aids (e.g., the first and the second frequency domain signals associated with the other of the two hearing aids comprise aliasing artefacts). For example, each of the two hearing aids can be configured to perform a classification of the current situation when aliasing artefacts are determined in the two hearing aids. For example, one of the two hearing aids can be configured to perform a classification of the current situation when aliasing artefacts are determined in only the one of the two hearing aids.

### An App:

In a further aspect, a non-transitory application, termed an APP, is furthermore provided by the present disclosure. The APP comprises executable instructions configured to be executed on an auxiliary device to implement a user interface for a hearing aid or a hearing system described above in the ‘detailed description of embodiments’, and in the claims. The APP may be configured to run on cellular phone, e.g., a smartphone, or on another portable device allowing communication with said hearing aid or said hearing system.

### Definitions

In the present context, a hearing aid, e.g., a hearing instrument, refers to a device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears. Such audible signals may e.g., be provided in the form of acoustic signals radiated into the user's outer ears and/or acoustic signals transferred as mechanical vibrations to the user's inner ears through the bone structure of the user's head and/or through parts of the middle ear.

The hearing aid may be configured to be worn in any known way, e.g., as a unit arranged behind the ear with a tube leading radiated acoustic signals into the ear canal or with an output transducer, e.g. a loudspeaker, arranged close to or in the ear canal, as a unit entirely or partly arranged in the pinna and/or in the ear canal. The hearing aid may comprise a single unit or several units communicating (e.g., acoustically, electrically or optically) with each other. The loudspeaker may be arranged in a housing together with other components of the hearing aid, or may be an external unit in itself (possibly in combination with a flexible guiding element, e.g., a dome-like element).

A hearing aid may be adapted to a particular user's needs, e.g., a hearing impairment. A configurable signal processing circuit of the hearing aid may be adapted to apply a frequency and level dependent compressive amplification of an input signal. A customized frequency and level dependent gain (amplification or compression) may be determined in a fitting process by a fitting system based on a user's hearing data, e.g. an audiogram, using a fitting rationale (e.g., adapted to speech). The frequency and level dependent gain may e.g., be embodied in processing parameters, e.g. uploaded to the hearing aid via an interface to a programming device (fitting system), and used by a processing algorithm executed by the configurable signal processing circuit of the hearing aid.

A ‘hearing system’ refers to a system comprising one or two hearing aids, and a ‘binaural hearing system’ refers to a system comprising two hearing aids and being adapted to cooperatively provide audible signals to both of the user's ears. Hearing systems or binaural hearing systems may further comprise one or more ‘auxiliary devices’, which communicate with the hearing aid(s) and affect and/or benefit from the function of the hearing aid(s). Such auxiliary devices may include at least one of a remote control, a remote microphone, an audio gateway device, an entertainment device, e.g., a music player, a wireless communication device, e.g., a mobile phone (such as, a smartphone) or a tablet or another device, e.g., comprising a graphical interface. Hearing aids, hearing systems or binaural hearing systems may e.g., be used for compensating for a hearing-impaired person's loss of hearing capability, augmenting or protecting a normal-hearing person's hearing capability and/or conveying electronic audio signals to a person. Hearing aids or hearing systems may e.g., form part of or interact with public-address systems, active ear protection systems, handsfree telephone systems, car audio systems, entertainment (e.g., TV, music playing or karaoke) systems, teleconferencing systems, classroom amplification systems, etc.

The invention is set out in the appended set of claims.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIGS. 1A-1B illustrate example first and second aliasing artefacts according to present disclosure,

FIG. 2 schematically illustrates an example hearing aid according to the present disclosure,

FIG. 3 schematically illustrates an example aliasing artefact detection unit according to present disclosure,

FIGS. 4-6B schematically illustrate example signal processing units according to present disclosure,

FIGS. 7A-7D schematically illustrate an example hearing aid comprising three microphones according to the present disclosure,

FIGS. 8A-8C schematically illustrate an example hearing aid comprising a single microphone according to the present disclosure, and

FIG. 9 illustrates a flow-chart of an example method of operating a hearing aid according to the present disclosure.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

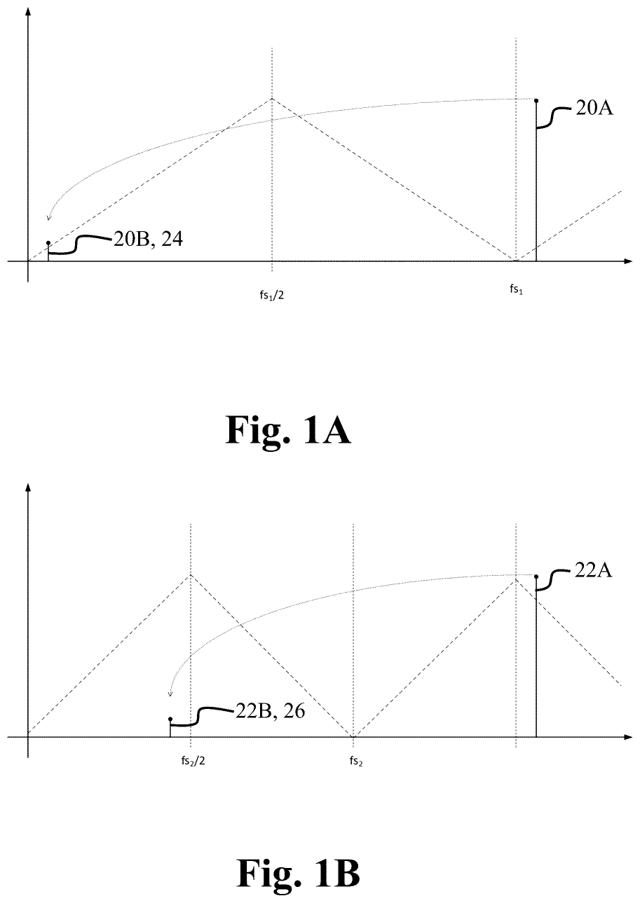

FIGS. 1A-1B illustrate example first and second aliasing artefacts 24, 26 according to present disclosure. FIG. 1A shows the magnitude of the first aliasing artefact 24 (e.g., appearing in a frequency component 20B of a first frequency domain signal). FIG. 1B shows the magnitude of the second aliasing artefact 26 (e.g., appearing in a frequency component 22B of a second frequency domain signal).

The horizontal axis illustrates the frequency range. The height of the aliasing artefact 24, 26 may be construed as a magnitude. For example, the height of an aliasing artefact is shown as being lower (e.g., in magnitude) than in the original sound (e.g., the height associated with a frequency component in the non-sampled signal, such as frequency component 20A, 20B) as application of an AAF can reduce the magnitude associated with the aliasing artefact. The vertical axis may illustrate both the magnitude of the aliasing artefact and the frequency component to which the aliasing artefact is mapped (e.g., dashed lines increasing/decreasing by 45 degrees, the top of the dashed line being at fₛ/2, 3fₛ/2, 5fₛ/2, etc.).

For example, a frequency domain signal comprising one or more aliasing artefacts may derive from (e.g., may be determined based on) a digitally sampled time-domain signal in which the Nyquist frequency is lower than a frequency of the one or more aliasing artefacts.

In other words, signal components located at frequency components above half of the sampling rate fₛ/2 (e.g., signal component located at frequency component 20A in FIG. 1A, signal component located at frequency component 22A in FIG. 1B) may still be present in the digitally sampled signal at frequency components below half of the sampling rate fₛ/2 (e.g., at frequency component 20B of FIG. 1A, at frequency component 22B of FIG. 1B), thereby originating an aliasing artefact (e.g., aliasing artefact 24, aliasing artefact 26). For example, mapping the signal component 20 to a frequency component below half of the sampling rate fₛ/2 can lead to presence of an aliasing artefact on such frequency component.

FIG. 1A shows a signal component located at frequency component 20A being mapped to frequency component 20B (e.g., one of a plurality of first frequency components) of a first frequency domain signal during a sampling process (e.g., using a first sampling rate fₛ₁), thereby leading to appearance of the first aliasing artefact 24 (e.g., a distortion). Optionally, the first frequency domain signal can comprise more than one first aliasing artefact. For example, the signal component located at frequency component 20A is a signal component of a first signal provided by a microphone or a transmitter. The frequency component 20B may be a first aliasing artefact frequency component.

FIG. 1B shows a signal component located at frequency component 22A being mapped to frequency component 22B (e.g., one of a plurality of second frequency components) of a second frequency domain signal during a sampling process (e.g., using a second sampling rate fₛ₂), thereby leading to appearance of the second aliasing artefact 26 (e.g., a distortion). Optionally, the second frequency domain signal can comprise more than one second aliasing artefact. For example, the signal component located at frequency component 22A is a signal component of a second signal provided by the same microphone or (e.g., wireless) transmitter, or by a different microphone or (e.g., wireless) transmitter. The frequency component 22B may be a second aliasing artefact frequency component.

For example, an aliasing artifact can, depending on the sampling rate used to sample an analogue signal, occur at a given frequency. In other words, one or more frequency domain signals may comprise different aliasing artefact frequency components as a result of using different sampling rates for sampling the corresponding analogue signals based on which the one or more frequency domain signals are determined.

For example, an aliasing artefact originating from the same ultrasound source (e.g., with the same ultrasound frequency, such as ultrasound frequency 20A, 22A) may likely appear at two different frequency components, depending on whether the analogue signal has been digitally sampled at a first sample rate fₛ₁ or at a second sample rate fₛ₂.

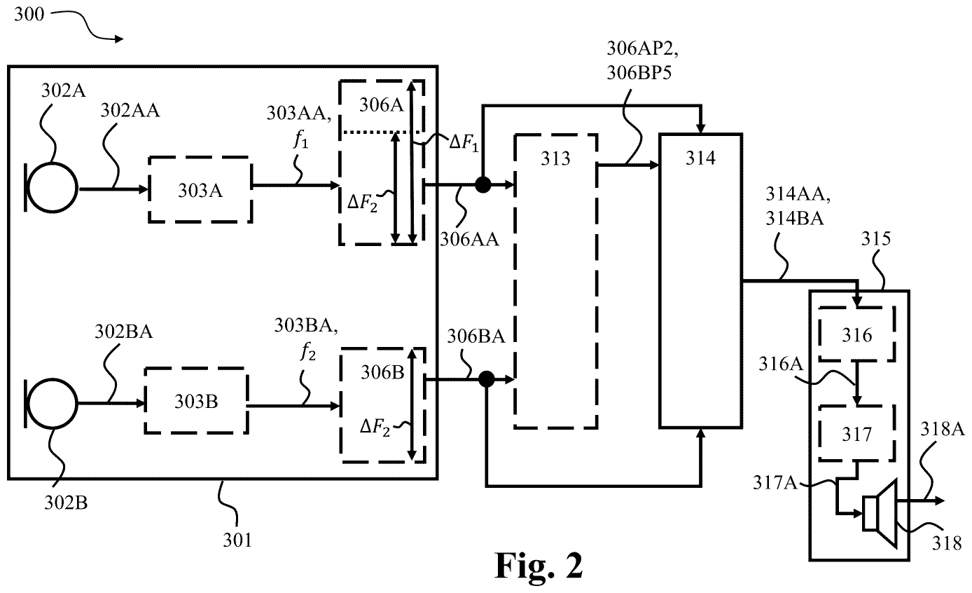

FIG. 2 schematically illustrates an example hearing aid 300 according to the present disclosure. The hearing aid 300 comprises an input unit 301, a signal processing unit 314, and an output unit 315. The input unit 301 comprises a plurality of microphones 302A, 302B. In one or more example hearing aids, the output unit 315 comprises an output transducer 318.

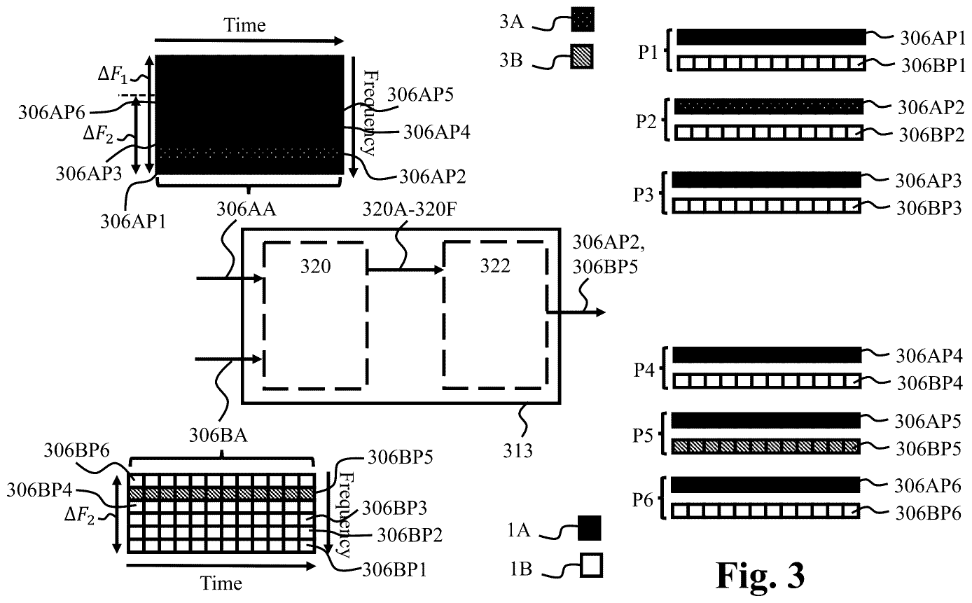

The input unit 301 is configured to provide a first frequency-domain signal 306AA comprising a plurality of first frequency components associated with a first frequency range ΔF₁. A first primary frequency range ΔF₂ being a subset of the first frequency range ΔF₁. The first primary frequency range ΔF₂ of the first frequency-domain signal 306AA comprises one or more first aliasing artefact frequency components 306AP2 (e.g., first aliasing artefact frequency component 306AP2 of FIG. 3). Each of the one or more first aliasing artefact frequency components being indicative of a frequency component of the plurality of first frequency components including a first aliasing artefact.

The input unit 301 is configured to provide a second frequency-domain signal 306BA comprising a plurality of second frequency components associated with the first primary frequency range ΔF₂. The second frequency-domain signal 306BA comprises one or more second aliasing artefact frequency components 306BP5 (e.g., second aliasing artefact frequency component 306BP5 of FIG. 3). Each of the one or more second aliasing artefact frequency components being indicative of a frequency component of the plurality of second frequency components including a second aliasing artefact.

The one or more first aliasing artefact frequency components are different from the one or more second aliasing artefact frequency components.

In one or more example hearing aids, the input unit 301 comprises a first microphone 302A and a second microphone 302B. In one or more example hearing aids, the first microphone 302A is configured to provide a first input signal 302AA. In one or more example hearing aids, the second microphone 302B is configured to provide a second input signal 302BA. For example, the first input signal 302AA and the second input signal 302BA are representative of a sound in an environment of the hearing aid 300.

In one or more example hearing aids, the input unit 301 comprises a first AD conversion unit 303A and a second AD conversion unit 303B.

In one or more example hearing aids, the first AD conversion unit 303A is configured to digitize the first input signal 302AA using the first sampling rate f₁ for provision of the first digitized signal 303AA. Put differently, the first AD conversion unit 303A may be configured to provide the first digitized signal 303AA by sampling the first input signal 302AB at the first sampling rate f₁.

In one or more example hearing aids, the second AD conversion unit 303B is configured to digitize the second input signal 302BA using the second sampling rate f₂ for provision of the second digitized signal 303BA. Put differently, the second AD conversion unit 303B may be configured to provide the second digitized signal 303BA by sampling the second input signal 302BA at the second sampling rate f₂. In one or more example hearing aids, the first sampling rate f₁ is greater than the second sampling rate f₂.

Optionally, the hearing aid 300 can comprise a single AD conversion unit (not shown in FIG. 2) configured to digitize the first input signal 302AA and the second input signal 302BA using a third sampling rate for provision of a first primary digitized signal and a second primary digitized signal. In other words, the single AD conversion unit may be configured to sample the first input signal 302AA and the second input signal 302BA at the third sampling rate. For example, the third sampling rate is different from the first sampling rate f₁ and the second sampling rate f₂. For example, the input unit 301 is configured to apply a downsampling technique to the first primary digitized signal and the second primary digitized signal when the third sampling rate is greater than the first sampling rate f₁ and the second sampling rate f₂ for provision of the first digitized signal 303AA and the second digitized signal 303BA. For example, the input unit 301 is configured to apply an upsampling technique to the first primary digitized signal and the second primary digitized signal when the third sampling rate is less than the first sampling rate f₁ and the second sampling rate f₂ for provision of the first digitized signal 303AA and the second digitized signal 303BA.

Optionally, the first AD conversion unit 303A and the second AD conversion unit 303B are included in an auxiliary device (e.g. a phone, a computer, etc.). The hearing aid 300 may be configured to receive, from the auxiliary device, the first digitized signal 303AA sampled at the first sampling rate f₁ and the second digitized signal 303BA sampled at the second sampling rate f₂. For example, the single AD conversion unit can be included in an auxiliary device.

In one or more example hearing aids, the input unit 301 comprises a plurality of analysis filter banks comprising a first analysis filter bank 306A and a second analysis filter bank 306B.

For example, the first analysis filter bank 306A is configured to provide the first frequency-domain signal 306AA based on the first digitized signal 303AA. In one or more example hearing aids, the second analysis filter bank 306B is configured to provide a second frequency-domain signal 306BA based on the second digitized signal 303BA. The frequency range of the second frequency-domain signal 306BA is a subset of the frequency range of the first frequency-domain signal 306AA. In other words, the first sampling rate f₁ may be greater than the second sampling rate f₂.

In one or more example hearing aids, the hearing aid 300 comprises an aliasing artefact detection unit 313. In one or more example hearing aids, the aliasing artefact detection unit 313 is configured to determine, based on the first primary frequency range ΔF₂ of the first frequency domain signal 306AA and the second frequency domain signal 306BA, the one or more first aliasing artefact frequency components 306AP2 (e.g., first aliasing artefact frequency component 306AP2 of FIG. 3) and the one or more second aliasing artefact frequency components 306BP5 (e.g., second aliasing artefact frequency component 306BP5 of FIG. 3).

The signal processing unit 314 is configured to determine an aliasing artefact reduced signal 314AA, 314BA based on the first frequency domain signal 306AA, the second frequency domain signal 306BA, the one or more first aliasing artefact frequency components 313A and the one or more second aliasing artefact frequency components 313B. For example, the signal processing unit 314 is configured to determine one of the aliasing artefact reduced signals 314AA, 314BA (e.g., depending on the frequency range of the aliasing artefact reduced signal).

In one or more example hearing aids, the output unit 315 comprises a synthesis filter bank 316. In one or more example hearing aids, the synthesis filter bank 316 is configured to convert one of the aliasing artefact reduced signals 314AA, 314BA in the frequency domain into a synthesized signal 316A.

In one or more example hearing aids, the output unit 315 comprises a DA conversion unit 317 configured to convert the synthesized signal 316A (e.g., a digital signal) to an analogue output signal 317A, such as for being presented to the user wearing the hearing aid 300 via the output unit 315 (e.g., output transducer 318, such as a loudspeaker).

The output unit 315 is configured to output, based on one of the aliasing artefact reduced signals 314AA, 314BA, an audible signal 318A to the user wearing the hearing aid 300. In the embodiment of FIG. 2, the output unit 315 is configured to output the audible signal 318A based on the analogue output signal 317A. The analogue output signal 317A may be converted into an acoustic signal via the output transducer 318.

FIG. 3 schematically illustrates an example aliasing artefact detection unit 313 of the hearing aid 300 according to present disclosure. The aliasing artefact detection unit 313 may comprise a magnitude and comparison determination unit 320.

FIG. 3 shows the first frequency domain signal 306AA and the second frequency domain signal 306BA in a TF representation. For example, a TF representation comprises a plurality of TF bins (e.g., a plurality of frequency components and a plurality of time instances). For example, each TF bin is associated with a frequency components (e.g., frequency band) and a time instance. For example, a TF bin can be seen as a portion (e.g., a part) of a frequency domain signal, such portion being associated with a given frequency component and a given time instance. For example, a frequency component of a frequency domain signal comprises a plurality of time instances. For example, a frequency component of a frequency domain signal can be seen as a portion (e.g., a part) of the frequency domain signal, such portion being associated with a plurality of time instances.

In the embodiment of FIG. 3, the first frequency domain signal 306AA comprises a plurality of first frequency components (e.g., 9 frequency components). In the embodiment of FIG. 3, the second frequency domain signal 306BA comprises a plurality of second frequency components (e.g., 6 frequency components). In the embodiment of FIG. 3, each of the plurality of first and second frequency components comprises a plurality of time instances (e.g., 12 time instances).

In one or more example hearing aids, each pair of a plurality of pairs of frequency components comprises a first frequency component of the plurality of first frequency components and a corresponding second frequency component of the plurality of second frequency components. In one or more example hearing aids, the first frequency component and the corresponding second frequency component are associated with the first primary frequency range. For example, the first frequency component and the corresponding second frequency component share the same location in the first and second frequency domain signals.

In the embodiment of FIG. 3, the plurality of pairs of frequency components comprises 6 pairs of frequency components. The numbers of pairs of frequency components may be given by the number of frequency components common the both the first and second frequency domain signals (e.g., frequency components encompassed in the first primary frequency range).

For example, a first pair P1 of the plurality of pairs of frequency components comprises a first frequency component 306AP1 and a corresponding second frequency component 306BP1. For example, a second pair P2 of the plurality of pairs of frequency components comprises a first frequency component 306AP2 and a corresponding second frequency component 306BP2. For example, a third pair P3 of the plurality of pairs of frequency components comprises a first frequency component 306AP3 and a corresponding second frequency component 306BP3. For example, a fourth pair P4 of the plurality of pairs of frequency components comprises a first frequency component 306AP4 and a corresponding second frequency component 306BP4. For example, a fifth pair P5 of the plurality of pairs of frequency components comprises a first frequency component 306AP5 and a corresponding second frequency component 306BP5. For example, a sixth pair P6 of the plurality of pairs of frequency components comprises a first frequency component 306AP6 and a corresponding second frequency component 306BP6.

In one or more example hearing aids, the magnitude and comparison determination unit 320 is configured to determine a first magnitude of the first frequency component 306AP1, 306AP2, 306AP3, 306AP4, 306AP5, 306AP6 of each pair P1, P2, P3, P4, P5, P6 of the plurality of pairs of frequency components.

In one or more example hearing aids, the magnitude and comparison determination unit 320 is configured to determine a second magnitude of the corresponding second frequency component 306BP1, 306BP2, 306BP5 of each pair P1, P2, P3, P4, P5, P6 of the plurality of pairs of frequency components.

In one or more example hearing aids, the magnitude and comparison determination unit 320 is configured to compare, for each pair P1, P2, P3, P4, P5, P6 of the plurality of pairs of frequency components, the first magnitude with the second magnitude. For example, the magnitude and comparison determination unit 320 is configured to provide a magnitude comparison 320A, 320B, 320C, 320D, 320E, 320F for each pair P1, P2, P3, P4, P5, P6 of the plurality of pairs of frequency components. The arrow labelled with 320A-320F of FIG. 3 is to be interpreted as 320A, 320B, 320C, 320D, 320E, 320F.

In one or more example hearing aids, the criterion determination unit 322 is configured to determine, each pair P1, P2, P3, P4, P5, P6 of the plurality of pairs of frequency components, whether the magnitude comparison 320A, 320B, 320C, 320D, 320E, 320F meets a criterion.

In one or more example hearing aids, the criterion determination unit 322 is configured to determine, each pair P1, P2, P3, P4, P5, P6 of the plurality of pairs of frequency components, whether the magnitude comparison 320A, 320B, 320C, 320D, 320E, 320F meets the criterion by determining that the magnitude comparison 320A, 320B, 320C, 320D, 320E, 320F meets the criterion when the first magnitude is different from the second magnitude.

In the embodiment of FIG. 3, the criterion determination unit 322 is configured to determine that the magnitude comparison 320B, 320E meets the criterion for the pair P2, P5 of the plurality of pairs of frequency components. For example, the criterion determination unit 322 is configured to determine, for each pair P2, P5 of the plurality of pairs of frequency components, that the first magnitude of a respective pair is different from the second magnitude of the respective pair.

In one or more example hearing aids, the criterion determination unit 322 is configured to determine, each pair P1, P2, P3, P4, P5, P6 of the plurality of pairs of frequency components, whether the magnitude comparison 320A, 320B, 320C, 320D, 320E, 320F meets the criterion by determining that the magnitude comparison 320A, 320B, 320C, 320D, 320E, 320F does not meet the criterion when the first magnitude is (e.g., approximately) equal to the second magnitude. In the embodiment of FIG. 3, the criterion determination unit 322 is configured to determine that the magnitude comparison 320A, 320C, 320D, 320F does not meet the criterion for the remaining pairs of the plurality of pairs of frequency components, such as for pairs of frequency components P1, P3, P4, P6. For example, the criterion determination unit 322 is configured to determine, for each pair of frequency components P1, P3, P4, P6, that the first magnitude of a respective pair is (e.g., approximately) equal to the second magnitude of the respective pair.

In one or more example hearing aids, the aliasing artefact detection unit 313 (e.g., and/or the criterion determination unit 320) is configured to determine the one or more first aliasing artefact frequency components by upon determining that the magnitude comparison 320B, 320E meets the criterion, determining that the first magnitude 306AP2 is greater than or equal to the second magnitude 306BP2 by a magnitude threshold. For example, the aliasing artefact detection unit 313 (e.g., and/or the criterion determination unit 320) is configured to determine, for the pair P2 of the plurality of pairs of frequency components, that the first magnitude is greater than or equal to the second magnitude by the magnitude threshold.

In one or more example hearing aids, the aliasing artefact detection unit 313 (e.g., and/or the criterion determination unit 320) is configured to determine the first frequency component 306AP2 of the pair P2 as a first aliasing artefact frequency component of the one or more first aliasing artefact frequency components. In the embodiment of FIG. 3, the first frequency domain signal 306AA comprises one first aliasing artefact frequency component 306AP2 (e.g., given by the first frequency component 306AP2 of pair of frequency components P2).

For example, the first aliasing artefact frequency component 306AP2 (e.g., comprising a plurality of time instances) is illustrated with pattern 3A.

In one or more example hearing aids, the aliasing artefact detection unit 313 (e.g., and/or the criterion determination unit 320) is configured to determine the one or more second aliasing artefact frequency components by upon determining that the magnitude comparison 320B, 320E meets the criterion, determining that the second magnitude 306BP5 is greater than or equal to the first magnitude 306AP5 by the magnitude threshold. For example, the aliasing artefact detection unit 313 (e.g., and/or the criterion determination unit 320) is configured to determine, for the pair P5 of the plurality of pairs of frequency components, that the second magnitude is greater than or equal to the first magnitude by the magnitude threshold.

In one or more example hearing aids, the aliasing artefact detection unit 313 (e.g., and/or the criterion determination unit 320) is configured to determine the corresponding second frequency component 306BP5 of the pair P5 as a second aliasing artefact frequency component of the one or more second aliasing artefact frequency components. In the embodiment of FIG. 3, the second frequency domain signal 306BA comprises one second aliasing artefact frequency component 306BP5 (e.g., given by the corresponding frequency component 306AP5 of the pair of frequency components P5).

For example, the second aliasing artefact frequency component 306BP5 (e.g., comprising a plurality of time instances) is illustrated with pattern 3B.

In one or more example hearing aids, the aliasing artefact detection unit 313 (e.g., and/or the criterion determination unit 320) is configured to provide, to a signal processing unit (e.g., signal processing unit 314 of FIG. 2), location (e.g., an index) of the first aliasing artefact frequency component 306AP2 in the first frequency domain signal 306AA and location (e.g., an index) of the second aliasing artefact frequency component 306BP5 in the second frequency domain signal 306BA. Optionally, the aliasing artefact detection unit 313 (e.g., and/or the criterion determination unit 320) is configured to provide, to a signal processing unit (e.g., signal processing unit 314 of FIG. 2), a frequency (e.g., in Hz) characterizing the first aliasing artefact frequency component 306AP5 and a frequency (e.g., in Hz) characterizing the second aliasing artefact frequency component 306BP5.

For example, the plurality of first frequency components of the first frequency domain signal 306AA are in black (e.g., color 1A). For example, the plurality of second frequency components of the second frequency domain signal 306BA are in white (e.g., color 1B).

In one or more example hearing aids, the plurality of pairs of frequency components comprises a set of aliasing pairs and a remaining set of non-aliasing pairs. For example, the plurality of pairs of frequency components comprises the first pair P1, the second pair P2, the third pair P3, the fourth pair P4, the fifth pair P5, and the sixth pair P6.

In one or more example hearing aids, the set of aliasing pairs includes at least a first aliasing pair and a second aliasing pair. In one or more example hearing aids, the first aliasing pair includes a first aliasing artefact frequency component of the one or more first aliasing artefact frequency components. In one or more example hearing aids, the second aliasing pair includes a second aliasing artefact frequency component of the one or more second aliasing artefact frequency components. In one or more example hearing aids, each of the remaining set of non-aliasing pairs includes neither the one or more first aliasing artefact frequency components nor the one or more second aliasing artefact frequency components.

In the embodiment of FIG. 3, the first aliasing pair is the pair P2 of the plurality of pairs of frequency components as the pair P2 of the plurality of pairs of frequency components comprises the first aliasing artefact frequency component 306AP2. In the embodiment of FIG. 3, the second aliasing pair is the pair P5 of the plurality of pairs of frequency components as the pair P5 of the plurality of pairs of frequency components comprises the second aliasing artefact frequency component 306BP5. The set of aliasing pairs may include the pair P2 and the pair P5.

In the embodiment of FIG. 3, the remaining set of non-aliasing pairs comprises the pair P1, pair P3, pair P4, and pair P6 of the plurality of pairs of frequency components, such as pairs comprising neither the first aliasing artefact frequency component 306AP2 nor the second aliasing artefact frequency component 306AP5.

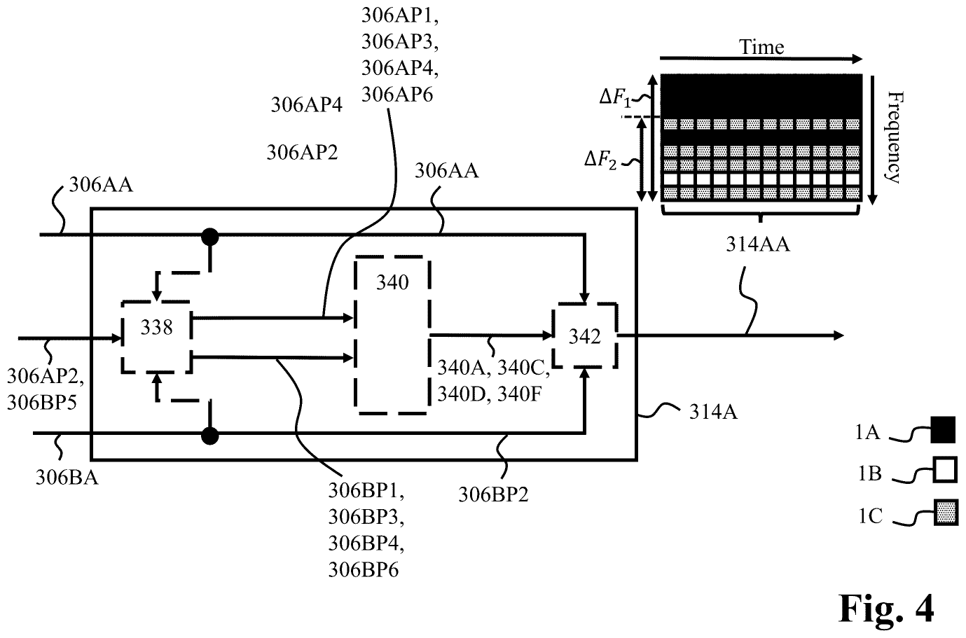

FIGS. 4-6B schematically illustrate example signal processing units 314A-314C of the hearing aid 300 according to present disclosure. For example, the signal processing unit 314 of FIG. 2 can be seen as one of the signal processing units 314A-314C (e.g., depending on a frequency range of an aliasing artefact reduced signal to be output by the signal processing units 314A-314C). The signal processing units 314A-314C may be configured to determine the signal processing unit 314A based on the first aliasing artefact frequency component 306AP2 of FIG. 3, the second aliasing artefact frequency component 306AP5 of FIG. 3, the first frequency domain signal 306AA of FIG. 3, and the second frequency domain signal 306BA of FIG. 3. Optionally, the signal processing units 314A-314C may be configured to determine the signal processing unit 314A based on one or more first aliasing artefact frequency component, one or more second aliasing artefact frequency component, a first frequency domain signal, and a second frequency domain signal (e.g., when the first frequency domain signal comprises more than one first aliasing artefact frequency component and when the second frequency domain signal comprises more than one second aliasing artefact frequency component).

In one or more example hearing aids, the signal processing unit 314A-314C is configured to determine the remaining set of non-aliasing pairs based on the set of aliasing pairs, such as based on the first aliasing artefact frequency component 306AP2 and the second aliasing artefact frequency component 306BP5 provided by the aliasing artefact detection unit 313 to the signal processing unit 314A-314C. In the embodiment of FIGS. 4-6B, the signal processing unit 314A-314C comprises a pair determination unit 338 configured to determine the remaining set of non-aliasing pairs (e.g., pairs P1, P3, P4, P6 of FIG. 3) based on the set of aliasing pairs comprising the first aliasing artefact frequency component 306AP2 and the second aliasing artefact frequency component 306BP5 (e.g., pairs P1 and P5 of FIG. 3).

FIG. 4 schematically illustrates the signal processing unit 314A of the hearing aid 300. For example, the aliasing artefact reduced signal determined by the signal processing unit 314A is associated with a first frequency range ΔF₁. In one or more example hearing aids, the signal processing unit 314A comprises the pair determination unit 338, a beamforming unit 340, and a replacement unit 342.

In one or more example hearing aids, the beamforming unit 340 (e.g., the signal processing unit 314A) is configured to determine, for each of the remaining set of non-aliasing pairs P1, P3, P4, and P6 of FIG. 3, a combined version 340A, 340C, 340D, 340F of the first frequency component 306AP1, 306AP3, 306AP4, 306AP6 and the corresponding second frequency component 306BP1, 306BP3, 306BP4, 306BP6 by applying a multi-channel processing technique to the first frequency component 306AP1, 306AP3, 306AP4, 306AP6 and the corresponding second frequency component 306BP1, 306BP3, 306BP4, 306BP6. For example, the remaining set of non-aliasing pairs (e.g., comprises the pair P1, pair P3, pair P4, and pair P6) can be combined for spatial filtering (beamforming).

For example, the beamforming unit 340 (e.g., signal processing unit 314A) is configured to, for the pair P1, apply the multi-channel processing technique to the first frequency component 306AP1 and the corresponding second frequency component 306BP1 for provision of the combined version 340A. For example, the beamforming unit 340 (e.g., signal processing unit 314A) is configured to, for the pair P3, apply the multi-channel processing technique to the first frequency component 306AP3 and the corresponding second frequency component 306BP3 for provision of the combined version 340C. For example, the beamforming unit 340 (e.g., signal processing unit 314A) is configured to, for the pair P4, apply the multi-channel processing technique to the first frequency component 306AP4 and the corresponding second frequency component 306BP4 for provision of the combined version 340D. For example, the beamforming unit 340 (e.g., signal processing unit 314A) is configured to, for the pair P6, apply the multi-channel processing technique to the first frequency component 306AP6 and the corresponding second frequency component 306BP6 for provision of the combined version 340F.

In one or more example hearing aids, the first frequency domain signal 306AA is used as a reference for the determination of the aliasing artefact reduced signal 314AA. In other words, frequency components of the first frequency domain signal 306AA may be replaced by other frequency components (e.g., frequency components resulting from a combination or from the second frequency domain signal 306BA).

In one or more example hearing aids, the replacement unit 342 (e.g., the signal processing unit 314A) is configured to determine the aliasing artefact reduced signal 314AA by updating, for each of the remaining set of non-aliasing pairs P1, P3, P4, and P6 of FIG. 3, the first frequency component 306AP1, 306AP3, 306AP4, 306AP6 with the corresponding combined version 340A, 340C, 340D, 340F of the first frequency component 306AP1, 306AP3, 306AP4, 306AP6 and the corresponding second frequency component 306BP1, 306BP3, 306BP4, 306BP6.

For example, the replacement unit 342 (e.g., the signal processing unit 314A) is configured to update (e.g., replace), for the pair P1, the first frequency component 306AP1 with the combined version 340A. For example, the replacement unit 342 (e.g., the signal processing unit 314A) is configured to update (e.g., replace), for the pair P3, the first frequency component 306AP3 with the combined version 340C. For example, the replacement unit 342 (e.g., the signal processing unit 314A) is configured to update (e.g., replace), for the pair P4, the first frequency component 306AP4 with the combined version 340D. For example, the replacement unit 342 (e.g., the signal processing unit 314A) is configured to update (e.g., replace), for the pair P6, the first frequency component 306AP6 with the combined version 340F.

Optionally, the replacement unit 342 is configured to update (e.g., replace), for each of the pairs P1, P3, P4, and P6 of FIG. 3, the first frequency component 306AP1, 306AP3, 306AP4, 306AP6 with the corresponding second frequency component 306BP1, 306BP3, 306BP4, 306BP6 (e.g., as the corresponding second frequency component 306BP1, 306BP3, 306BP4, 306BP6 does not contain any aliasing artefact).

Optionally, the replacement unit 342 is configured to forego, for each of the pairs P1, P3, P4, and P6 of FIG. 3, the updated of the first frequency component 306AP1, 306AP3, 306AP4, 306AP6 with either the corresponding second frequency component 306BP1, 306BP3, 306BP4, 306BP6 or the corresponding combined version 340A, 340C, 340D, 340F (e.g., as the first frequency component 306AP1, 306AP3, 306AP4, 306AP6 does not contain any aliasing artefact).

In one or more example hearing aids, the replacement unit 342 (e.g., the signal processing unit 314A) is configured to determine the aliasing artefact reduced signal 314AA by updating, for the first aliasing pair P2, the first frequency component 306AP2 of the first frequency domain signal 306AA with the corresponding second frequency component 306BP2 of the second frequency domain signal 306BA.

For example, the aliasing artefact reduced signal 314AA is provided in a TF representation, such as comprising a plurality of frequency components, each of the plurality of frequency components comprising a plurality of time instances. For example, frequency components of such plurality of frequency components in black (e.g., color 1A) illustrate portions of the first frequency domain signal 306AA (e.g., portions free of aliasing artefacts). For example, frequency components of such plurality of frequency components in white (e.g., color 1B) illustrate portions of the second frequency domain signal 306BA (e.g., portions free of aliasing artefacts). For example, frequency components of such plurality of frequency components having a pattern 1C illustrate combined versions of corresponding portions of the first frequency domain signal 306AA and second frequency domain signal 306BA (e.g., portions free of aliasing artefacts), such as combined versions free of aliasing artefacts.

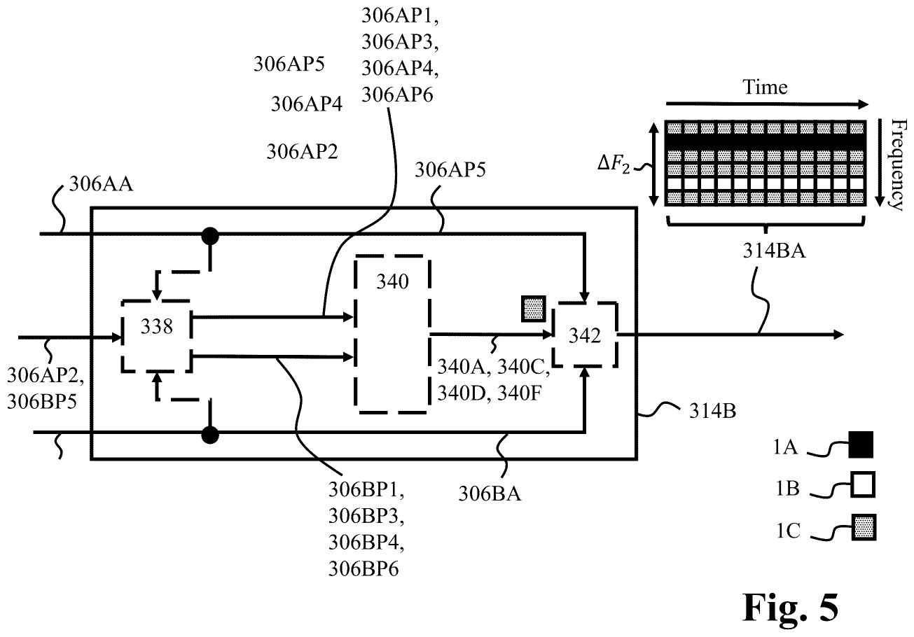

FIG. 5 schematically illustrates an example signal processing unit 314B of the hearing aid 300. The aliasing artefact reduced signal determined by the signal processing unit 314B is associated with a first primary frequency range ΔF₂. In one or more example hearing aids, the signal processing unit 314B comprises the pair determination unit 338, the beamforming unit 340, and the replacement unit 342.

In one or more example hearing aids, the beamforming unit 340 (e.g., the signal processing unit 314B) is configured to determine, for each of the remaining set of non-aliasing pairs P1, P3, P4, and P6 of FIG. 3, a combined version 340A, 340C, 340D, 340F of the first frequency component 306AP1, 306AP3, 306AP4, 306AP6 and the corresponding second frequency component 306BP1, 306BP3, 306BP4, 306BP6 by applying a multi-channel processing technique to the first frequency component 306AP1, 306AP3, 306AP4, 306AP6 and the corresponding second frequency component 306BP1, 306BP3, 306BP4, 306BP6.

For example, the beamforming unit 340 (e.g., signal processing unit 314B) is configured to, for the pair P1, apply the multi-channel processing technique to the first frequency component 306AP1 and the corresponding second frequency component 306BP1 for provision of the combined version 340A. For example, the beamforming unit 340 (e.g., signal processing unit 314A) is configured to, for the pair P3, apply the multi-channel processing technique to the first frequency component 306AP3 and the corresponding second frequency component 306BP3 for provision of the combined version 340C. For example, the beamforming unit 340 (e.g., signal processing unit 314A) is configured to, for the pair P4, apply the multi-channel processing technique to the first frequency component 306AP4 and the corresponding second frequency component 306BP4 for provision of the combined version 340D. For example, the beamforming unit 340 (e.g., signal processing unit 314A) is configured to, for the pair P6, apply the multi-channel processing technique to the first frequency component 306AP6 and the corresponding second frequency component 306BP6 for provision of the combined version 340F.

In one or more example hearing aids, the second frequency domain signal 306BA is used as a reference for the determination of the aliasing artefact reduced signal 314BA. In other words, frequency components of the second frequency domain signal 306BA may be replaced by other frequency components (e.g., frequency components resulting from a combination or from the first frequency domain signal 306AA).

In one or more example hearing aids, the replacement unit 342 (e.g., the signal processing unit 314B) is configured to determine the aliasing artefact reduced signal 314BA by updating, for each of the remaining set of non-aliasing pairs P1, P3, P4, and P6 of FIG. 3, the first frequency component 306AP1, 306AP3, 306AP4, 306AP6 with the corresponding combined version 340A, 340C, 340D, 340F of the first frequency component 306AP1, 306AP3, 306AP4, 306AP6 and the corresponding second frequency component 306BP1, 306BP3, 306BP4, 306BP6.

For example, the replacement unit 342 (e.g., the signal processing unit 314B) is configured to update (e.g., replace), for the pair P1, the corresponding second frequency component 306BP1 with the combined version 340A. For example, the replacement unit 342 (e.g., the signal processing unit 314A) is configured to update (e.g., replace), for the pair P3, the corresponding second frequency component 306BP3 with the combined version 340C. For example, the replacement unit 342 (e.g., the signal processing unit 314A) is configured to update (e.g., replace), for the pair P4, the corresponding second frequency component 306BP4 with the combined version 340D. For example, the replacement unit 342 (e.g., the signal processing unit 314A) is configured to update (e.g., replace), for the pair P6, the corresponding frequency component 306BP6 with the combined version 340F.

Optionally, the replacement unit 342 is configured to update (e.g., replace), for each of the pairs P1, P3, P4, and P6 of FIG. 3, the corresponding second frequency component 306BP1, 306BP3, 306BP4, 306BP6 with the first frequency component 306AP1, 306AP3, 306AP4, 306AP6 (e.g., as the first frequency component 306BP1, 306BP3, 306BP4, 306BP6 does not contain any aliasing artefact).

Optionally, the replacement unit 342 is configured to forego, for each of the pairs P1, P3, P4, and P6 of FIG. 3, the updated of the corresponding second frequency component 306BP1, 306BP3, 306BP4, 306BP6 with either first frequency component 306AP1, 306AP3, 306AP4, 306AP6 or the corresponding combined version 340A, 340C, 340D, 340F (e.g., as the corresponding second frequency component 306AP1, 306AP3, 306AP4, 306AP6 does not contain any aliasing artefact).

In one or more example hearing aids, the replacement unit 342 (e.g., the signal processing unit 314B) is configured to determine the aliasing artefact reduced signal 314BA by updating, for the second aliasing pair P5, the corresponding second frequency component 306BP5 of the second frequency domain signal 306BA with the first frequency component 306AP5 of the first frequency domain signal 306AA.

For example, the aliasing artefact reduced signal 314BA is provided in a TF representation, such as comprising a plurality of frequency components, each of the plurality of frequency components comprising a plurality of time instances. For example, frequency components of such plurality of frequency components in black (e.g., color 1A) illustrate portions of the first frequency domain signal 306AA (e.g., portions free of aliasing artefacts). For example, frequency components of such plurality of frequency components in white (e.g., color 1B) illustrate portions of the second frequency domain signal 306BA (e.g., portions free of aliasing artefacts). For example, frequency components of such plurality of frequency components having a pattern 1C illustrate combined versions of corresponding portions of the first frequency domain signal 306AA and second frequency domain signal 306BA (e.g., portions free of aliasing artefacts), such as combined versions free of aliasing artefacts.

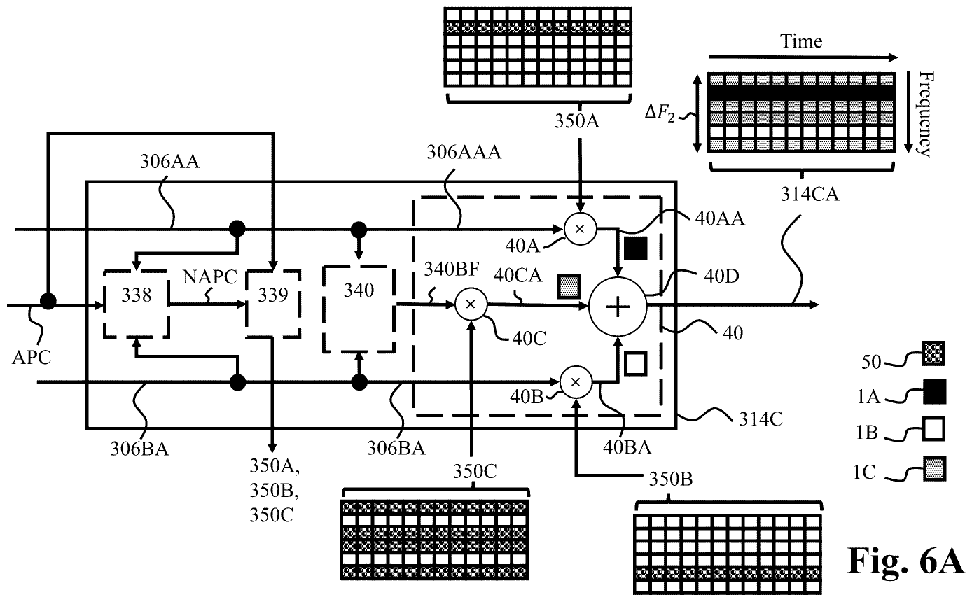

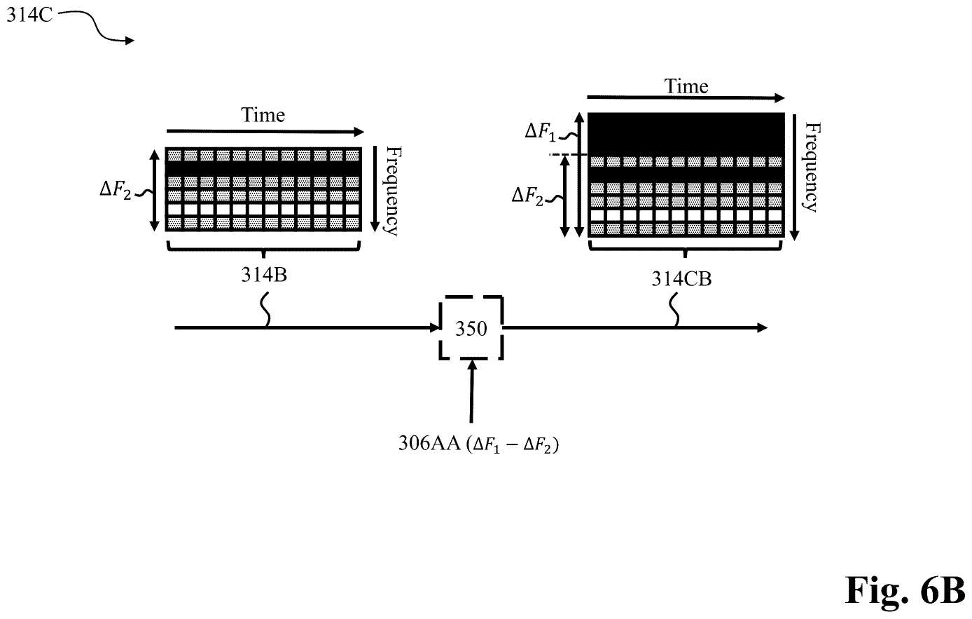

FIG. 6A-6B schematically illustrates an example signal processing unit 314C of the hearing aid 300. The aliasing artefact reduced signal determined by the signal processing unit 314C is associated with a first primary frequency range ΔF₂. FIG. 6B schematically illustrates determination of an aliasing artefact reduced signal associated with a first frequency range ΔF₁.

FIGS. 6A-6B may illustrate a different manner of combining the first and second frequency domain signals in comparison with FIGS. 4-5. For example, FIGS. 6A-6B illustrates determination of the aliasing artefact reduced signal using binary masks (e.g., matrices) instead of using the first and second frequency domain signals as a reference as illustrated by FIGS. 4-5. In one or more example hearing aids, the signal processing unit 314D comprises the pair determination unit 338, a binary mask determination unit 339, a beamforming unit 340, and a mixing unit 40.

The arrow APC should be interpreted as the first and second aliasing artefact frequency components 306AP2, 306BP5 of FIGS. 3-5. The arrow NAPC should be interpreted as the remaining set of non-aliasing pairs P1, P3, P4, P6 of FIGS. 3-5.

In one or more example hearing aids, the binary mask determination unit 339 is configured to determine, based on the first aliasing pair (e.g., pair P2), the second aliasing pair (e.g., pair P5) and the remaining set of non-aliasing pairs (e.g., pairs P1, P3, P4, P6), a first binary mask 350A, a second binary mask 350B, and a beamforming binary mask 350C.

For example, a binary mask (e.g., the first binary mask 350A, the second binary mask 350B, the beamforming binary mask 350C) can be seen as a matrix comprising a plurality of rows (e.g., 6 rows) illustrating a corresponding plurality of frequency components. The rows having the pattern 50 may be illustrated as “1” and the rows in white may be illustrated as “0”. In other words, only the frequency components having the pattern 50 may be used for the determination of the aliasing artefact reduced signal 314CA. For example, the aliasing artefact reduced signal 314CA comprises the frequency components having the pattern 50.

In one or more example hearing aids, the beamforming unit 340 (e.g., the signal processing unit 314C) is configured to determine, for each of the set of aliasing pairs (e.g., P2, P5 of FIGS. 3-5) and each of the remaining set of non-aliasing pairs NAPC (e.g., P1, P3, P4, and P6 of FIGS. 3-5), a combined version 340A, 340b, 340C, 340D, 340E, 340F of the first frequency component 306AP1, 306AP2, 306AP3, 306AP4, 306AP5, 306AP6 and the corresponding second frequency component 306BP1, 306BP2, 306BP3, 306BP4, 306BP5, 306BP6 by applying a multi-channel processing technique to the first frequency component 306AP1, 306AP2, 306AP3, 306AP4, 306AP5, 306AP6 and the corresponding second frequency component 306BP1, 306BP2, 306BP3, 306BP4, 306BP5, 306BP6 (e.g., as partially illustrated by FIGS. 4-5).

For example, the beamforming unit 340 (e.g., signal processing unit 314C) is configured to, for the pair P1, apply the multi-channel processing technique to the first frequency component 306AP1 and the corresponding second frequency component 306BP1 for provision of the combined version 340A. For example, the beamforming unit 340 (e.g., signal processing unit 314C) is configured to, for the pair P2, apply the multi-channel processing technique to the first frequency component 306AP2 and the corresponding second frequency component 306BP2 for provision of the combined version 340B. For example, the beamforming unit 340 (e.g., signal processing unit 314C) is configured to, for the pair P3, apply the multi-channel processing technique to the first frequency component 306AP3 and the corresponding second frequency component 306BP3 for provision of the combined version 340C. For example, the beamforming unit 340 (e.g., signal processing unit 314C) is configured to, for the pair P4, apply the multi-channel processing technique to the first frequency component 306AP4 and the corresponding second frequency component 306BP4 for provision of the combined version 340D. For example, the beamforming unit 340 (e.g., signal processing unit 314C) is configured to, for the pair P5, apply the multi-channel processing technique to the first frequency component 306AP5 and the corresponding second frequency component 306BP5 for provision of the combined version 340E. For example, the beamforming unit 340 (e.g., signal processing unit 314C) is configured to, for the pair P6, apply the multi-channel processing technique to the first frequency component 306AP6 and the corresponding second frequency component 306BP6 for provision of the combined version 340F.

In other words, the beamforming unit 340 (e.g., signal processing unit 314C) may be configured to determine a beamformed frequency domain signal 340BF based on the combined version 340A, 340B, 340C, 340D, 340E, 340F.

For example, the beamformed signal can comprise a plurality of frequency components, such as α frequency components, with each plurality of frequency components comprising a plurality of time instances, such as 12 time instances. In other words, the structure of the beamformed frequency domain signal 340BF may be similar to the structure of the first and second frequency domain signals 306AA, 306BA in the sense of such signals may comprise the same number of frequency components and of time instances. For example, beamformed frequency domain signal 340BF is associated with the first primary frequency range ΔF₂.

For example, the beamformed frequency domain signal 340BF comprise a first frequency component of the 6 frequency components determined as the combined version 340A. For example, the beamformed frequency domain signal 340BF comprise a second frequency component of the 6 frequency components determined as the combined version 340B. For example, the beamformed frequency domain signal 340BF comprise a third frequency component of the 6 frequency components determined as the combined version 340C. For example, the beamformed frequency domain signal 340BF comprise a fourth frequency component of the 6 frequency components determined as the combined version 340D. For example, the beamformed frequency domain signal 340BF comprise a fifth frequency component of the 6 frequency components determined as the combined version 340E. For example, the beamformed frequency domain signal 340BF comprise a sixth frequency component of the 6 frequency components determined as the combined version 340F.

In one or more example hearing aids, the mixing unit 40 (e.g., signal processing unit 314C) is configured to determine the aliasing artefact reduced signal 314CA based on the first primary frequency range of the first frequency domain signal 306AAA, a first binary mask 350A, the second frequency domain signal 306BA, a second binary mask 350B, the beamformed frequency domain signal 340BF, and a beamforming binary mask 350C.

For example, the mixing unit 40 comprises a first multiplication unit 40A configured to determine a first auxiliary frequency domain signal 40AA based on the first primary frequency range of the first frequency domain signal 306AAA and the first binary mask 350A. In other words, the first multiplication unit 40A may be configured to multiplicate the first primary frequency range of the first frequency domain signal 306AAA (e.g., represented by a matrix) by the first binary mask 350A (e.g., represented by a matrix). For example, having the fifth frequency component of the first binary mask 350A illustrated as “1” (e.g., by pattern 50) enables to determine the second frequency component of the aliasing artefact reduced signal 314CA as the first frequency component 306AP5 of the pair P5.

For example, the mixing unit 40 comprises a second multiplication unit 40B configured to determine a second auxiliary frequency domain signal 40BA based on the second frequency domain signal 360BA and the second binary mask 350B. In other words, the second multiplication unit 40B may be configured to multiplicate the second frequency domain signal 306BA (e.g., represented by a matrix) by the second binary mask 350B (e.g., represented by a matrix). For example, having the second frequency component of the second binary mask 350B illustrated as “1” (e.g., by pattern 50) enables to determine the second frequency component of the aliasing artefact reduced signal 314CA as the first frequency component 306AP2 of the pair P2.

For example, the mixing unit 40 comprises a third multiplication unit 40C configured to determine a third auxiliary frequency domain signal 40CA based on the beamformed frequency domain signal 340BF and the third binary mask 350C. In other words, the third multiplication unit 40C may be configured to multiplicate the beamformed frequency domain signal 340BF (e.g., represented by a matrix) by the first binary mask 350A (e.g., represented by a matrix). For example, having the first, third, fourth, and sixth frequency components of the beamforming binary mask 350C illustrated as “1” (e.g., by pattern 50) enables to determine the corresponding frequency components of the aliasing artefact reduced signal 314CA as the combined versions 340A, 340C, 340D, 340F.

For example, the mixing unit 40 comprises an addition unit 40D configured to determine the aliasing artefact reduced signal 314CA based on the first auxiliary frequency domain signal 40AA, the second auxiliary frequency domain signal 40BA, and the third auxiliary frequency domain signal 40CA. In other words, the addition unit 40D may be configured to add the first auxiliary frequency domain signal 40AA, the second auxiliary frequency domain signal 40BA, and the third auxiliary frequency domain signal 40CA.

For example, the mixing unit 40 is configured to linearly combine the first frequency domain signal, the second frequency domain signal, and the beamformed frequency domain signal, such as by using the first, second and third binary masks. In other words, the aliasing artefact reduced signal 314CA may be given by,

$$314 C A = 350 A * 306 A A A + 350 B * 306 B A + 350 C * 340 B F .$$

For example, the aliasing artefact reduced signal 314CA is provided in a TF representation, such as comprising a plurality of frequency components, each of the plurality of frequency components comprising a plurality of time instances. For example, frequency components of such plurality of frequency components illustrated in black (e.g., color 1A) illustrate portions of the first frequency domain signal 306AA (e.g., portions free of aliasing artefacts). For example, frequency components of such plurality of frequency components illustrated in which (e.g., color 1B) illustrate portions of the second frequency domain signal 306BA (e.g., portions free of aliasing artefacts). For example, frequency components of such plurality of frequency components having a pattern 1C illustrate combined versions of corresponding portions of the first frequency domain signal 306AA and second frequency domain signal 306BA (e.g., portions free of aliasing artefacts), such as combined versions free of aliasing artefacts.

FIG. 6B schematically illustrates determination of an aliasing artefact reduced signal 314CB associated with the first frequency range ΔF₁.

In one or more example hearing aids, the signal processing unit 314C can comprise an aggregating unit 350. In one or more example hearing aids, the aggregating unit 350 (e.g., the signal processing unit 314C) is configured to determine the aliasing artefact reduced signal 314CB based on the previously determined aliasing artefact reduced signal 314CA.

In other words, the aggregating unit 350 (e.g., the signal processing unit 314C) is configured to determine the aliasing artefact reduced signal 314CB by aggregating (e.g., concatenating) the pairs of frequency components belonging to a second primary frequency range (e.g., ΔF₁-ΔF₂) of the first frequency domain signal 306AA. For example, the second primary frequency range of the first frequency domain signal 306AA can comprise a set of frequency components not common to the second frequency domain signal 306BA. In the embodiment of FIG. 6B, the aggregating unit 350 is configured to add 3 frequency components at the end of the previously determined aliasing artefact reduced signal 314CA, such as adding such frequency components in such a way that locations of such frequency components in the first frequency domain signal 306AA match locations of such frequency components in aliasing artefact reduced signal 314CB.

In the embodiments of FIGS. 3-6B, the number of frequency components (e.g., bands) for schematic illustration of the first frequency domain signals 306AA (e.g., showing frequency and time along the vertical and horizontal axes, respectively) and signals deriving from the first frequency domain signals 306AA is 9. In the embodiments of FIGS. 3-6B, the number of frequency components (e.g., bands) for schematic illustration of the second frequency domain signals 306BA (e.g., showing frequency and time along the vertical and horizontal axes, respectively) and signals deriving from the second frequency domain signals 306BA is 6. Any other number of frequency bands may be used for each of the first and second frequency domain signals (e.g., 4 or 8 or 16 or 64, etc.), with the number of frequency components of the second frequency domain signal being smaller than the number of frequency components of the first frequency domain signal.

For example, the signal processing unit 314 may be configured to determine the aliasing artefact reduced signal 314AA when operating according to signal processing unit 314A of FIG. 4. For example, the signal processing unit 314 may be configured to determine the aliasing artefact reduced signal 314BA when operating according to signal processing unit 314B of FIG. 5. For example, the signal processing unit 314 may be configured to determine the aliasing artefact reduced signal 314CA, 314CB when operating according to signal processing unit 314BC of FIGS. 6A-6B.

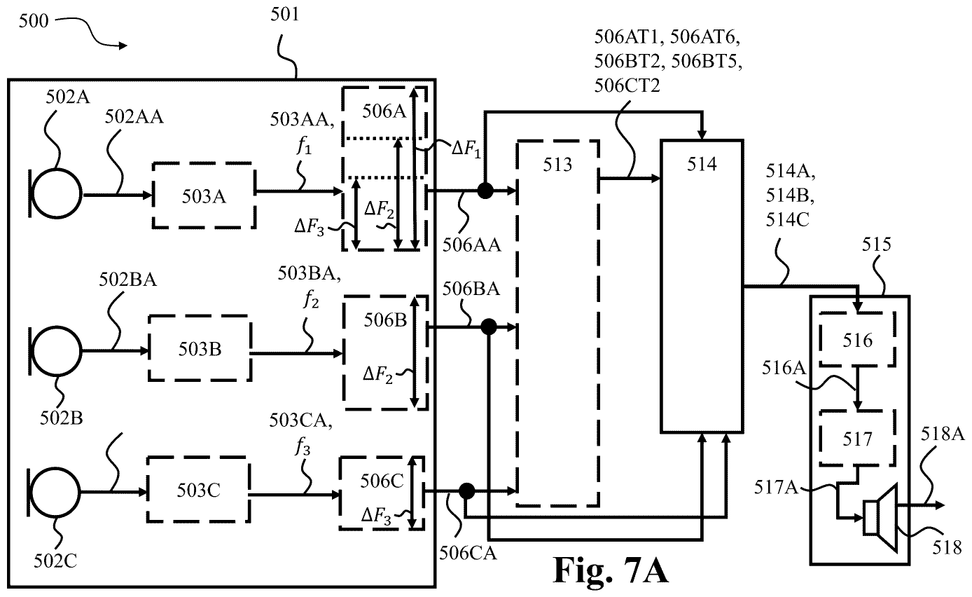

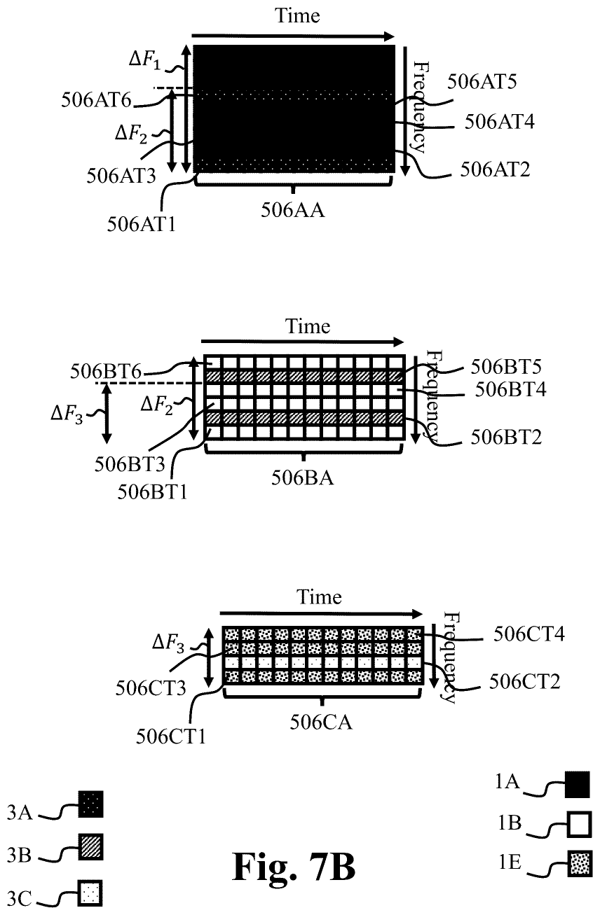

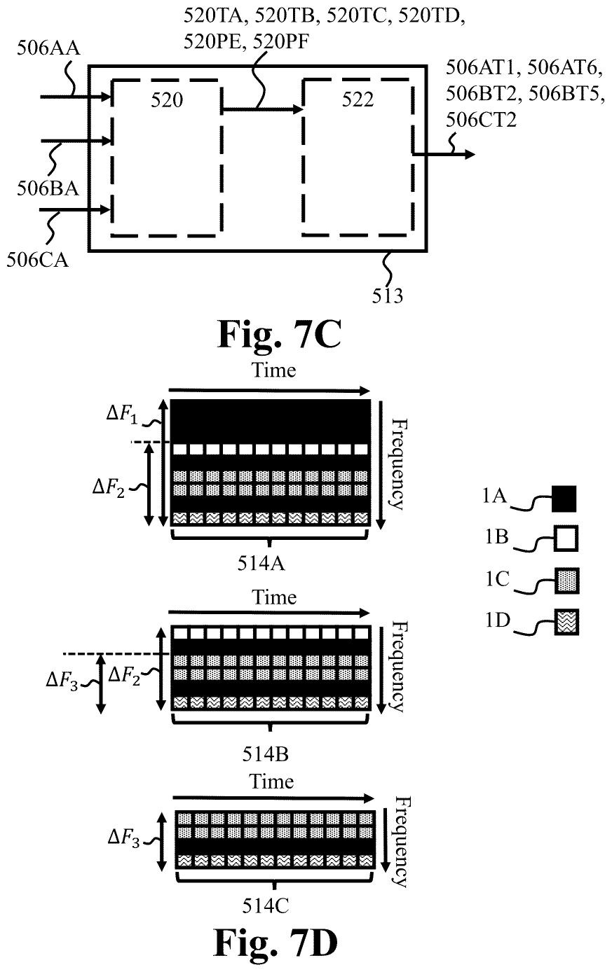

FIG. 7A-7D schematically illustrate an example hearing aid 500, the example hearing aid 500 comprising three microphones according to the present disclosure. FIG. 7A shows the structure of the hearing aid 500. For example, the hearing aid 500 can comprise a plurality of microphones, such as at least two microphones. FIG. 7B shows schematic illustrations of a first frequency domain signals 506AA, a second frequency domain signals 506BA, and a third frequency domain signals 506CA (e.g., showing frequency and time along the vertical and horizontal axes, respectively). FIG. 7C schematically illustrates an example aliasing detection unit 513 of the hearing aid 500. FIG. 7D shows schematic illustrations of an aliasing artefact reduced signal 514A, 514B, 514C (e.g., showing frequency and time along the vertical and horizontal axes, respectively).

In one or more example hearing aids, the hearing aid 500 comprises an input unit 501, a signal processing unit 514, and an output unit 515. In one or more example hearing aids, the input unit 501 comprises a plurality of microphones 502A, 502B, 502C. In one or more example hearing aids, the output unit 515 comprises an output transducer 518.

In one or more example hearing aids, the input unit 501 is configured to provide a first frequency-domain signal 506AA comprising a plurality of first frequency components associated with a first frequency range ΔF₁. For example, a first primary frequency range ΔF₂ being a subset of the first frequency range ΔF₁. For example, the first primary frequency range ΔF₂ of the first frequency-domain signal 506AA comprises one or more first aliasing artefact frequency components. For example, each of the one or more first aliasing artefact frequency components being indicative of a frequency component of the plurality of first frequency components including a first aliasing artefact.

In one or more example hearing aids, the input unit 501 is configured to provide a second frequency-domain signal 506BA comprising a plurality of second frequency components associated with the first primary frequency range ΔF₂. For example, the second frequency-domain signal 506BA comprises one or more second aliasing artefact frequency components. For example, each of the one or more second aliasing artefact frequency components being indicative of a frequency component of the plurality of second frequency components including a second aliasing artefact.

In one or more example hearing aids, the input unit 501 is configured to provide a third frequency-domain signal 506CA comprising a plurality of third frequency components associated with the first secondary frequency range ΔF₃. For example, the first secondary frequency range ΔF₃ is a subset of the first primary frequency range ΔF₂. For example, the third frequency-domain signal 506CA comprises one or more third aliasing artefact frequency components. For example, each of the one or more third aliasing artefact frequency components being indicative of a frequency component of the plurality of third frequency components including a third aliasing artefact.

For example, an input unit can be configured to provide L frequency domain signals, L denoting at least two frequency domain signals, wherein the L frequency domain signals comprise a plurality of frequency components, wherein a set of frequency components of a plurality of sets of frequency components comprises L frequency components, the L frequency components having the same location in the L frequency domain signals.

For example, the first frequency range ΔF₁, the first primary frequency range ΔF₂, and the first secondary frequency range ΔF₃ may be different from each other such that up to two of the plurality of frequency components having the same location in the first, second, and third frequency domain signals include an aliasing artefact. Such up to two of the plurality of frequency components having the same location in the first, second, and third frequency domain signals and including an aliasing artefact may be seen as aliasing artefact frequency components (e.g., first, second or third aliasing artefact frequency components, depending on the frequency domain signal including the aliasing artefact). For example, a hearing aid with an input unit configured to provide L frequency domain signals, the frequency ranges of such L frequency domain signals may be different from each other such that up to L−1 of the plurality of frequency components having the same location in the L frequency domain signals include an aliasing artefact. For example, the frequency range of the L frequency domain signals are different from one another in that at least two of the plurality of sets of frequency components comprise up to L−1 frequency components including an aliasing artefact.

For example, the first, the second and the third sampling rates can be 20 kHz, 25 kHz, and 30 kHz, respectively. For example, the first, the second and the third sampling rates can be 16 kHz, 24 kHz, 32 kHz, respectively (e.g., the first, second and third frequency domain signals having aliasing artefacts in common for frequency components characterized by frequency values above approximately 90 kHz (such as frequency components originating above approximately 90 kHz)). For example, the frequency domain signals comprise more aliasing artefact frequency components in common when the ratio between the sampling rates is of 2:3 than when compared to ratios of 4:5 or 5:6. In other words, it may be more likely to experience co-occurrence of aliasing artefacts (e.g., aliasing artefacts in the same frequency component of the first, second, and third frequency domain signals) when compared to ratios of 4:5 or 5:6.

In one or more example hearing aids, the input unit 501 comprises a first microphone 502A, a second microphone 302B, and a third microphone 502C. In one or more example hearing aids, the first microphone 502A is configured to provide a first input signal 502AA. In one or more example hearing aids, the second microphone 502B is configured to provide a second input signal 502BA. In one or more example hearing aids, the third microphone 502C is configured to provide a third input signal 502CA.

For example, the first input signal 502AA, the second input signal 502BA, and the third input signal 502BA are representative of a sound in an environment of the hearing aid 500.

In one or more example hearing aids, the input unit 501 comprises a first AD conversion unit 503A, a second AD conversion unit 503B, and a third AD conversion unit 503C.

In one or more example hearing aids, the first AD conversion unit 503A is configured to digitize the first input signal 502AA using the first sampling rate f₁ for provision of the first digitized signal 503AA. Put differently, the first AD conversion unit 503A may be configured to provide the first digitized signal 503AA by sampling the first input signal 502AB at the first sampling rate f₁.

In one or more example hearing aids, the second AD conversion unit 503B is configured to digitize the second input signal 502BA using the second sampling rate f₂ for provision of the second digitized signal 503BA. Put differently, the second AD conversion unit 503B may be configured to provide the second digitized signal 503BA by sampling the second input signal 502BA at the second sampling rate f₂. In one or more example hearing aids, the first sampling rate f₁ is greater than the second sampling rate f₂.

In one or more example hearing aids, the third AD conversion unit 503C is configured to digitize the third input signal 502CA using the third sampling rate f₃ for provision of the third digitized signal 503CA. Put differently, the third AD conversion unit 503C may be configured to provide the third digitized signal 503CA by sampling the third input signal 502CA at the third sampling rate f₃. In one or more example hearing aids, the first sampling rate f₁ is greater than the second sampling rate f₂ and the third sampling rate f₃. In one or more example hearing aids, the second sampling rate f₂ is greater than the third sampling rate f₃.

Optionally, the hearing aid 500 can comprise a single AD conversion unit (not shown in FIG. 7A) configured to digitize the first input signal 502AA, the second input signal 302BA, and the third input signal 502CA using a single sampling rate for provision of a first primary digitized signal, a second primary digitized signal, and a third primary signal. In other words, the single AD conversion unit may be configured to sample the first input signal 502AA, the second input signal 502BA, and the third input signal 502BA at the single sampling rate. For example, the single sampling rate is different from the first sampling rate f₁, the second sampling rate f₂, and the third sampling rate f₃. For example, the input unit 501 is configured to apply a downsampling technique to the first primary digitized signal, the second primary digitized signal, and the third primary digitized signal when the single sampling rate is greater than the first sampling rate f₁, the second sampling rate f₂, and the third sampling rate f₃ for provision of the first digitized signal 503AA, the second digitized signal 503BA, and the third digitized signal 503CA. For example, the input unit 501 is configured to apply an upsampling technique to the first primary digitized signal, the second primary digitized signal, and the third primary digitized signal when the single sampling rate is less than the first sampling rate f₁, the second sampling rate f₂, and the third sampling rate f₃ for provision of the first digitized signal 503AA, the second digitized signal 503BA, and the third digitized signal 503CA.

Optionally, the first AD conversion unit 503A, the second AD conversion unit 503B, and the third AD conversion unit 503C are included in an auxiliary device (e.g. a phone, a computer, etc.). The hearing aid 500 may be configured to receive, from the auxiliary device, the first digitized signal 503AA sampled at the first sampling rate f₁, the second digitized signal 503BA sampled at the second sampling rate f₂, and the third digitized signal 503CA sampled at the third sampling rate f₃. For example, the single AD conversion unit can be included in an auxiliary device.

In one or more example hearing aids, the input unit 501 comprises a plurality of analysis filter banks comprising a first analysis filter bank 506A, a second analysis filter bank 506B, and a third analysis filter bank 506C.

For example, the first analysis filter bank 506A is configured to provide the first frequency-domain signal 506AA based on the first digitized signal 503AA. In one or more example hearing aids, the second analysis filter bank 506B is configured to provide the second frequency-domain signal 506BA based on the second digitized signal 503BA. In one or more example hearing aids, the third analysis filter bank 506C is configured to provide the third frequency-domain signal 506CA based on the third digitized signal 503CA.

For example, the frequency range of the second frequency-domain signal 506BA is a subset of the frequency range of the first frequency-domain signal 506AA. In other words, the first sampling rate f₁ may be greater than the second sampling rate f₂. The frequency range of the third frequency-domain signal 506CA may be a subset of the frequency range of the second frequency-domain signal 506BA. In other words, the second sampling rate f₂ may be greater than the third sampling rate f₃.

In one or more example hearing aids, the hearing aid 500 comprises an aliasing artefact detection unit 513. For example, a signal processing unit (e.g., signal processing unit 514 of FIG. 7A) can comprise the aliasing artefact detection unit 513. In one or more example hearing aids, the aliasing artefact detection unit 513 is configured to determine, based on the first primary frequency range ΔF₂ of the first frequency domain signal 506AA, the second frequency domain signal 506BA, the third domain signal 506CA, the one or more first aliasing artefact frequency components 506AT1, 506AT6, the one or more second aliasing artefact frequency components 506BT2, 506BT5, and the one or more third aliasing artefact frequency components 506CT2.

For example, a frequency component of a frequency domain signal comprises a plurality of time instances. For example, a frequency component of a frequency domain signal can be seen as a portion (e.g., a part) of the frequency domain signal, such portion being associated with a plurality of time instances.

FIG. 7B shows schematic illustrations of the first frequency domain signals 506AA, the second frequency domain signals 506BA, and the third frequency domain signals 506CA (e.g., showing frequency and time along the vertical and horizontal axes, respectively). For example, the first frequency domain signal 506AA comprises a plurality of first frequency components (e.g., 9 frequency components). For example, the second frequency domain signal 506BA comprises a plurality of second frequency components (e.g., 6 frequency components). For example, the third frequency domain signal 506CA comprises a plurality of third frequency components (e.g., 4 frequency components). For example, each of the plurality of first, second, and third frequency components comprises a plurality of time instances (e.g., 12 time instances).

For example, the plurality of first frequency components of the first frequency domain signal 306AA are in black (e.g., color 1A). For example, the plurality of second frequency components of the second frequency domain signal 306BA are in white (e.g., color 1B). For example, the plurality of third frequency components of third frequency domain signal 306CA are illustrated with pattern 1E.

For example, the one or more first aliasing artefact frequency components 506AT1, 506AT6 (e.g., comprising a plurality of time instances) are illustrated with pattern 3A. For example, the one or more second aliasing artefact frequency components 506BT2, 506A′BT5 (e.g., comprising a plurality of time instances) are illustrated with pattern 3B. For example, the third aliasing artefact frequency components 506CT2 (e.g., comprising a plurality of time instances) are illustrated with pattern 3C.

In one or more example hearing aids, each trio of a plurality of trios of frequency components comprises a first frequency component of the plurality of first frequency components, a corresponding second frequency component of the plurality of second frequency components, and a corresponding third frequency component of the plurality of third frequency components. In one or more example hearing aids, the first frequency component, the corresponding second frequency component, and the corresponding third frequency component are associated with the first secondary frequency range ΔF₃. For example, the first frequency component, the corresponding second frequency component, and the corresponding third frequency component share the same location in the first, second, and third frequency domain signals, respectively.

In the embodiment of FIGS. 7A-7C, the plurality of trios of frequency components comprises 4 trios of frequency components. The numbers of trios of frequency components may be given by the number of frequency components common to the first, second, and third frequency domain signals (e.g., frequency components encompassed in the first secondary frequency range of each of the first, second, and third frequency domain signals).

For example, a first trio T1 of the plurality of trios of frequency components comprises the first frequency component 506AT1, and the corresponding second and third frequency components 506BT1, 506CT1. For example, a second trio T2 of the plurality of trios of frequency components comprises the first frequency component 506AT2, and the corresponding second and third frequency components 506BT2, 506CT2. For example, the third trio T3 of the plurality of trios of frequency components comprises the first frequency component 506AT3, and the corresponding second and third frequency components 506BT3, 506CT3. For example, the fourth trio T4 of the plurality of trios of frequency components comprise the first frequency component 506AT4, and the corresponding second and third frequency components 506BT4, 506CT4.

For example, each pair of a plurality of pairs of frequency components comprises a first frequency component of the plurality of first frequency components and a corresponding second frequency component of the plurality of second frequency components. In one or more example hearing aids, the first frequency component and the corresponding second frequency component of a pair are associated with a remaining frequency range resulting from a subtraction of the first secondary frequency range ΔF₃ from the first primary frequency range ΔF₂, such as ΔF₂-ΔF₃. For example, the first frequency component and the corresponding second frequency component share the same location in the first, second, and third frequency domain signals, respectively.

In the embodiment of FIGS. 7A-7C, the plurality of pairs of frequency components comprises 2 pairs of frequency components. The numbers of pairs of frequency components may be given by the number of frequency components common to the first and second frequency domain signals, but not common to the third frequency domain signal.

For example, a first pair P1 of the plurality of pairs of frequency components comprises the first frequency component 506AT5 and the corresponding second frequency component 506BT5. For example, a second pair P2 of the plurality of pairs of frequency components comprises the first frequency component 506AT6 and the corresponding second frequency components 506BT6.

For example, the aliasing artefact detection 513 unit is configured to operate on the first secondary frequency range of both the first frequency domain signal 506AA, the second frequency domain signal 506BA, and the third frequency domain signal 506CA as well as on the first primary frequency range of both the first frequency domain signal 506BA and the second frequency domain signal 506CA. In other words, the aliasing artefact detection unit 513 may be configured to operate on the first primary frequency range (e.g., including frequency ranges within the first primary frequency range).

In one or more example hearing aids, the magnitude and comparison determination unit 520 is configured to perform a magnitude comparison in a two-step comparison process (e.g., a first magnitude comparison between a first, second and third frequency of a trio and a second magnitude comparison between a first and second frequency of a pair). Optionally, the magnitude and comparison determination unit 520 can be configured to apply a MIN operator (e.g., function) to the first, second and third frequencies of a trio. For example, the magnitude and comparison determination unit 520 can be configured to apply a MIN operator (e.g., function) to the first and second frequencies of a pair. For example, the magnitude and comparison determination unit 520 can be configured to apply a MIN operator (e.g., function) to frequency components having the same location in the first, second and third frequency domain signals for provision of a magnitude comparison.

In one or more example hearing aids, the magnitude and comparison determination unit 520 is configured to determine a first magnitude of the first frequency components 506AT1, 506AT2, 506AT3, 506AT4, 506AT5, 506AT6 (e.g., first frequency components belonging to the first primary frequency range of the first frequency domain signal).

In one or more example hearing aids, the magnitude and comparison determination unit 520 is configured to determine a second magnitude of each of the plurality of second frequency components 506BT1, 506BT2, 506BT3, 506BT4, 506BT5, 506BT6.

In one or more example hearing aids, the magnitude and comparison determination unit 520 is configured to determine a third magnitude of each of the plurality of second frequency components 506CT1, 506CT2, 506CT3, 506CT4.

In one or more example hearing aids, the magnitude and comparison determination unit 520 is configured to compare, for each trio T1, T2, T3, T4 of the plurality of trios of frequency components, the first magnitude, the second magnitude, and the third magnitude with one another.

For example, the magnitude and comparison determination unit 520 is configured to provide, for each trio T1, T2, T3, T4 of the plurality of trios of frequency components, the frequency component comprising the lowest magnitude among the first, second and third frequency components. Put differently, the magnitude and comparison determination unit 520 is configured to provide, for each trio T1, T2, T3, T4 of the plurality of trios of frequency components, a relationship between the first, second and third magnitude 520TA, 520TB, 520TC, 520TD, e.g., be configured to provide the frequency component comprising the lowest magnitude.

For example, the relationship between the first, second and third magnitudes for each of the plurality of trios T1, T2, T3, T4 are labelled as 520TA, 520TB, 520TC, 520TD. A relationship between the first, second and third magnitudes for a trio may indicate either the frequency component of the first, second, and third frequency components comprising the lowest magnitude or that the first, second, and third magnitudes are the same.

For example, the magnitude and comparison determination unit 520 can be configured to provide the frequency component comprising the highest magnitude among the first, second and third frequency components when there is only one aliasing artefact on such trio. For example, the magnitude and comparison determination unit 520 can configured to provide the frequency component comprising the lowest magnitude among the first, second and third frequency components when there are more than one aliasing artefact on such trio.

In one or more example hearing aids, the magnitude and comparison determination unit 520 may preferably determine the lowest magnitude among the first, second, and third magnitudes. The lowest magnitude may comprise more than one lowest magnitudes when such lowest magnitudes are approximately the same. A lowest magnitude (e.g., or each of at least two lowest magnitudes) may be indicative of a magnitude of a frequency component not comprising an aliasing artefact frequency component, thereby rendering the frequency components associated with the remaining magnitudes as frequency components comprising aliasing artifacts.

In the embodiment of FIGS. 7A-7C, the magnitude and comparison determination unit 520 is configured to select and provide, for the trio T1, the corresponding second and third frequency component 506BT1, 506CT1 as the frequency components comprising the lowest magnitudes (e.g., the second magnitude of the trio T1 is approximately the same as the third magnitude of the trio T1). For example, the magnitude and comparison determination unit 520 may be configured to determine that, for the trio T1, the second magnitude is approximately equal to the third frequency, with both the second and third magnitude being lower than the first magnitude. For example, the magnitude and comparison determination unit 520 is configured to provide the relationship 520TA indicating that the second and third magnitudes are both the lowest magnitudes among the first, second, and third magnitudes of the trio T1.

In the embodiment of FIGS. 7A-7C, the magnitude and comparison determination unit 520 is configured to select and provide, for the trio T2, the first frequency component 506AT2 as the frequency component comprising the lowest magnitude. For example, the magnitude and comparison determination unit 520 is configured to determine, for the trio T2, that the first magnitude is lower than each of the second and third magnitudes (e.g., the second magnitude of the trio T2 may be different from the third magnitude of the trio T1). For example, the magnitude and comparison determination unit 520 is configured to provide the relationship 520TB indicating that the first magnitude is the lowest magnitude among the first, second, and third magnitudes of the trio T2.

In the embodiment of FIGS. 7A-7C, the magnitude and comparison determination unit 520 is configured to determine that, for each of the trios T3, T4, that the first magnitude, the second magnitude and the third magnitude are approximately equal to one another. In other words, the magnitude and comparison determination unit 520 is configured to determine that the first frequency component, the corresponding second frequency component, and the corresponding third frequency component do not comprise a first aliasing artefact of the one or more second aliasing artefacts, a second aliasing artefact of the one or more second aliasing artefacts, and a third aliasing artefact of the one or more third aliasing artefacts, respectively. For example, the magnitude and comparison determination unit 520 is configured to provide the relationship 520TC indicating that the first, second and third magnitudes are the approximately the same for the trio T3. In other words, the relationship 520TC may indicate that the trio T3 does not comprise any aliasing artefact frequency components. For example, the magnitude and comparison determination unit 520 is configured to provide the relationship 520TD indicating that the first, second and third magnitudes are the approximately the same for the trio T4. In other words, the relationship 520TD may indicate that the trio T4 does not comprise any aliasing artefact frequency components.

In one or more example hearing aids, the aliasing artefact detection unit 520 (e.g., and/or the criterion determination unit 522) is configured to determine the one or more aliasing artefact frequency components upon determining the relationship between the first, second, and third magnitude of each trio T1, T2, T3, T4.

For example, the relationship 520TA indicates that the second and third magnitudes are both the lowest magnitude among the first, second, and third magnitudes of the trio T1. In other words, the relationship 520TA may indicate that the first frequency components can (e.g., likely) be an aliasing artefact frequency component. In the embodiment of FIGS. 7A-7C, the aliasing artefact detection unit 513 (e.g., and/or the criterion determination unit 522) is configured to determine the first frequency component 506AT1 of the trio T1 as a first aliasing artefact frequency component of the one or more first aliasing artefact frequency components by determining that the first magnitude is greater than or equal to one or more of the second and third magnitudes by a magnitude threshold (e.g., a range of magnitude thresholds, e.g., 1-3 dB). For example, the magnitude threshold may be a range.

For example, the relationship 520TB indicates that the first magnitude is the lowest magnitude among the first, second, and third magnitudes of the trio T2. In other words, the relationship 520TB may indicate that the corresponding second and third frequency components can (e.g., likely) be aliasing artefact frequency components. In the embodiment of FIGS. 7A-7C, the aliasing artefact detection unit 513 (e.g., and/or the criterion determination unit 522) is configured to determine the corresponding second component 306BT2 of the trio T2 as a second aliasing artefact frequency component of the one or more second aliasing artefact frequency components by determining that the second magnitude is greater than or equal to the first magnitude by the magnitude threshold (e.g., a range of magnitude thresholds, e.g., 1-3 dB). In the embodiment of FIGS. 7A-7C, the aliasing artefact detection unit 513 (e.g., and/or the criterion determination unit 522) is configured to determine the corresponding third component 506CT2 as a third aliasing artefact frequency component of the one or more third aliasing artefact frequency components by determining that the third magnitude is greater than or equal to the first magnitude by the magnitude threshold (e.g., a magnitude threshold range, e.g., 1-3 dB).

In one or more example hearing aids, the magnitude and comparison determination unit 520 is configured to compare, for each pair P5, P6 of the plurality of pairs of frequency components, the first magnitude with the second magnitude. For example, the magnitude and comparison determination unit 520 is configured to determine, for each pair P5, P6 of the plurality of pairs of frequency components, whether the first magnitude is different from the second magnitude. In other words, the magnitude and comparison determination unit 520 may be configured to provide a magnitude comparison 520PE, 520PF, with the criterion determination unit 522 being configured to determine whether the magnitude comparison meets the criterion 520PE, 520PF.

Optionally, the magnitude and comparison determination unit 520 is configured to determine, for each pair P5, P6 of the plurality of pairs of frequency components, the lowest magnitude among the first magnitude and the second magnitude (e.g., implying that the first and second magnitude are different from each other). For example, the magnitude and comparison determination unit 520 can be configured to provide a relationship between the first and the second magnitudes. For example, the aliasing artefact detection unit 520 (e.g., and/or the criterion determination unit 522) can be configured to determine the one or more aliasing artefact frequency components upon determining the relationship between the first and second, and magnitudes of each pair P5, P6.

In the embodiment of FIGS. 7A-7B, the criterion determination unit 522 is configured to determine, for each pair P5, P6, that the first magnitude is different from the second magnitude (e.g., the magnitude comparison 520PE, 520PF meeting the criterion).

In one or more example hearing aids, the aliasing artefact detection unit 513 (e.g., and/or the criterion determination unit 522) is configured to determine, for the pair P6, that the first magnitude is greater than or equal to the second magnitude by the magnitude threshold. For example, the aliasing artefact detection unit 513 (e.g., and/or the criterion determination unit 522) is configured to determine the first frequency component 506AT6 of the pair P6 as other first aliasing artefact frequency component of the one or more first aliasing artefact frequency components. In the embodiment of FIGS. 7A-7C, the first frequency domain signal 506AA comprises two first aliasing artefact frequency components, such as first aliasing artefact frequency component 506AT1, 506AT6.

In one or more example hearing aids, the aliasing artefact detection unit 513 (e.g., and/or the criterion determination unit 520) is configured to determine, for the pair P5, that the second magnitude is greater than or equal to the first magnitude by the magnitude threshold. In one or more example hearing aids, the aliasing artefact detection unit 513 (e.g., and/or the criterion determination unit 520) is configured to determine the corresponding second frequency component 506BT5 of the pair P5 as other second aliasing artefact frequency component of the one or more second aliasing artefact frequency components. In the embodiment of FIGS. 7A-7C, the second frequency domain signal 506BA comprises two first aliasing artefact frequency components, such as first aliasing artefact frequency component 506BT2, 506BT5.

In one or more example hearing aids, the signal processing unit 514 is configured to determine an aliasing artefact reduced signal 514A based on the first frequency domain signal 506AA, the second frequency domain signal 506BA, the third frequency domain signal 506BA, the one or more first aliasing artefact frequency components 506AT1, 506AT6, the one or more second aliasing artefact frequency components 506BT2, 506BT5, and the third aliasing artefact frequency components 506CT2.

In one or more example hearing aids, the signal processing unit 514 can operate under the same manner as the signal processing units 314A-314C of FIGS. 4-6B. Such signal processing units 314A-314C of FIGS. 4-6B can be configured to (e.g., easily adapted for) receive more than two signals as input.

For example, the plurality of trios of frequency components comprises a set of aliasing trios and a remaining set of non-aliasing trios. For example, the set of aliasing trios includes a first aliasing trio T1 and a second aliasing trio T2. For example, the first aliasing trio T1 comprises the first aliasing artefact frequency component 506AT1 of the one or more first aliasing artefact frequency components. For example, the second aliasing trio T2 comprises the second aliasing artefact frequency components 506BT2 of the one or more second aliasing artefact frequency components and the third artefact frequency components 506CT2. For example, the remaining set of non-aliasing trios T3, T4 comprises neither the one or more first aliasing artefact frequency components nor the one or more second aliasing artefact frequency components nor the third aliasing artefact frequency component.

For example, the plurality of pairs of frequency components comprises a set of aliasing pairs and a remaining set of non-aliasing pairs. In the embodiment of FIGS. 7A-7C, the plurality of pairs of frequency components only comprises a set of aliasing pairs. For example, the set of aliasing pairs includes a first aliasing pair (e.g., the pair P6) and a second aliasing pair (e.g., the pair P5). For example, the first aliasing pair P6 comprises the first aliasing artefact frequency component 506AT6 of the one or more first aliasing artefact frequency components. For example, the second aliasing pair P5 comprises the second aliasing artefact frequency components 506BT5 of the one or more second aliasing artefact frequency components.

In one or more example hearing aids, the signal processing unit 514 (e.g., operating in the same manner as the signal processing 514A-514B of FIGS. 3-4) comprises a beamforming unit (e.g., beamforming unit 340) configured to determine, for each of the remaining set of non-aliasing trios T3, T4, a combined version of the first frequency component 506AT3, 506AT4, the corresponding second frequency component 506BT3, 506BT4, and the corresponding third frequency component 506CT3, 506CT4, by applying a multi-channel processing technique to the first frequency component 506AT3, 506AT4, the corresponding second frequency component 506BT3, 506BT4, and the corresponding third frequency component 506CT3, 506CT4. For example, the beamforming unit is configured to, for the trio T3, apply the multi-channel processing technique to the first frequency component 506AT3, the corresponding second frequency component 306BT3, and the third frequency component 506CT3. For example, the beamforming unit is configured to, for the trio T4, apply the multi-channel processing technique to the first frequency component 506AT4 and the corresponding second frequency component 306BT4, and the third frequency component 506CT4.

For example, the first frequency domain signal 506AA is used as a reference for the determination of the aliasing artefact reduced signal 514A (e.g., of FIG. 7D).

In one or more example hearing aids, the replacement unit (e.g., the replacement unit 342) is configured to determine the aliasing artefact reduced signal 514A by updating, for each of the remaining set of non-aliasing trios T3, T4, the first frequency component 306AT3, 306AT4 with the corresponding combined versions.

In one or more example hearing aids, the replacement unit is configured to determine the aliasing artefact reduced signal 514A by updating, for the first aliasing pair P6, the first frequency component 506AT6 of the first frequency domain signal 506AA with the corresponding second frequency component 506BT6 of the second frequency domain signal 506BA.

In one or more example hearing aids, the replacement unit is configured to determine the aliasing artefact reduced signal 514A by updating, for the first aliasing trio T1, the first frequency component 506AT1 of the first frequency domain signal 506AA with a combined version of the corresponding second frequency component 506BT1 of the second frequency domain signal 506BA and the corresponding third frequency component 506CT1 of the third frequency domain signal 506CA. The combined version of the corresponding second frequency component 506BT1 of the second frequency domain signal 506BA and the corresponding third frequency component 506CT1 of the third frequency domain signal 506CA may be determined by the beamforming unit. Optionally, the replacement unit is configured to determine the aliasing artefact reduced signal 514A by updating, for the first aliasing trio T1, the first frequency component 506AT1 of the first frequency domain signal 506AA with the corresponding second frequency component 506BT1 of the second frequency domain signal 506BA (e.g., as the corresponding second frequency component 506BT1 does not contain any aliasing artefact).

For example, the second frequency domain signal 506BA is used as a reference for the determination of the aliasing artefact reduced signal 514B (e.g., of FIG. 7D).

In one or more example hearing aids, the replacement unit (e.g., the replacement unit 342) is configured to determine the aliasing artefact reduced signal 514B by updating, for each of the remaining set of non-aliasing trios T3, T4, the second frequency component 306BT3, 306BT4 with the corresponding combined versions.

In one or more example hearing aids, the replacement unit is configured to determine the aliasing artefact reduced signal 514B by updating, for the second aliasing pair P5, the corresponding second frequency component 506BT6 of the second frequency domain signal 506BA with the first frequency component 506AT6 of the first frequency domain signal 506AA.

In one or more example hearing aids, the replacement unit is configured to determine the aliasing artefact reduced signal 514B by updating, for the first aliasing trio T1, the corresponding second frequency component 506BT1 of the second frequency domain signal 506BA with a combined version of the corresponding second frequency component 506BT1 of the second frequency domain signal 506BA and the corresponding third frequency component 506CT1 of the third frequency domain signal 506CA. The combined version of the corresponding second frequency component 506BT1 of the second frequency domain signal 506BA and the corresponding third frequency component 506CT1 of the third frequency domain signal 506CA may be determined by the beamforming unit. Optionally, the replacement unit is configured to determine the aliasing artefact reduced signal 514B by foregoing, for the first aliasing trio T1, the update of the corresponding second frequency component 506BT1 of the second frequency domain signal 506BA with such combined version (e.g., as the corresponding second frequency component 506BT1 does not contain any aliasing artefact).

For example, the third frequency domain signal 506CA is used as a reference for the determination of the aliasing artefact reduced signal 514C (e.g., of FIG. 7D).

In one or more example hearing aids, the replacement unit (e.g., the replacement unit 342) is configured to determine the aliasing artefact reduced signal 514C by updating, for each of the remaining set of non-aliasing trios T3, T4, the second frequency component 306BT3, 306BT4 with the corresponding combined versions.

In one or more example hearing aids, the replacement unit is configured to determine the aliasing artefact reduced signal 514B by updating, for the first aliasing trio T1, the corresponding third frequency component 506CT1 of the third frequency domain signal 506CA with a combined version of the corresponding second frequency component 506BT1 of the second frequency domain signal 506BA and the corresponding third frequency component 506CT1 of the third frequency domain signal 506CA. The combined version of the corresponding second frequency component 506BT1 of the second frequency domain signal 506BA and the corresponding third frequency component 506CT1 of the third frequency domain signal 506CA may be determined by the beamforming unit. Optionally, the replacement unit is configured to determine the aliasing artefact reduced signal 514B by foregoing, for the first aliasing trio T1, the update of the corresponding third frequency component 506CT1 of the third frequency domain signal 506CA with such combined version (e.g., as the corresponding third frequency component 506CT1 does not contain any aliasing artefact). Optionally, the replacement unit is configured to determine the aliasing artefact reduced signal 514B by updating, for the first aliasing trio T1, the corresponding third frequency component 506CT1 of the third frequency domain signal 506CA with the corresponding second frequency component 506BT1 of the second frequency domain signal 506BA (e.g., as the corresponding second frequency component 506BT1 does not contain any aliasing artefact).

For example, the aliasing artefact reduced signal 314A, 314B, 314C is provided in a TF representation, such as comprising a plurality of frequency components, each of the plurality of frequency components comprising a plurality of time instances. For example, frequency components of such plurality of frequency components in black (e.g., color 1A) illustrate portions of the first frequency domain signal 306AA (e.g., portions free of aliasing artefacts). For example, frequency components of such plurality of frequency components in white (e.g., color 1B) illustrate portions of the second frequency domain signal 306BA (e.g., portions free of aliasing artefacts). For example, frequency components of such plurality of frequency components having a pattern 1C illustrate combined versions of corresponding portions of the first frequency domain signal 306AA, the second frequency domain signal 306BA, and the third frequency domain signal 306CA (e.g., portions free of aliasing artefacts), such as combined versions free of aliasing artefacts. For example, frequency components of such plurality of frequency components having a pattern 1D illustrate combined versions of corresponding portions of the second frequency domain signal 306BA, and the third frequency domain signal 306CA (e.g., portions free of aliasing artefacts), such as combined versions free of aliasing artefacts.

The signal processing unit 314C of FIGS. 6A-6B can be configured to determine (e.g., easily adapted for determining) the aliasing artefact reduced signal 314A, 314B, 314C using appropriate binary masks, such as following the same structure of FIGS. 6A-6B (e.g., such as using similar operations described with reference to FIGS. 6A-6B).

In one or more example hearing aids, the output unit 515 comprises a synthesis filter bank 516. In one or more example hearing aids, the synthesis filter bank 516 is configured to convert one of the aliasing artefact reduced signals 514A, 514B, 514C in the frequency domain into a second aliasing artefact reduced signal 316A (e.g., in the time domain).

In one or more example hearing aids, the output unit 515 comprises a DA conversion unit 517 configured to convert the second aliasing artefact reduced signal 316A (e.g., a digital signal) to an analogue output signal 517A, such as for being presented to the user wearing the hearing aid 500 via the output unit 515 (e.g., output transducer 518, such as a loudspeaker).

The output unit 515 is configured to output, based on one of the aliasing artefact reduced signals 514A, 514B, 514C, an audible signal 518A to the user wearing the hearing aid 500. In the embodiment of FIGS. 7A-7D, the output unit 515 is configured to output the audible signal 518A based on the analogue output signal 517A. The analogue output signal 517A may be converted into an acoustic signal via the output transducer 518.

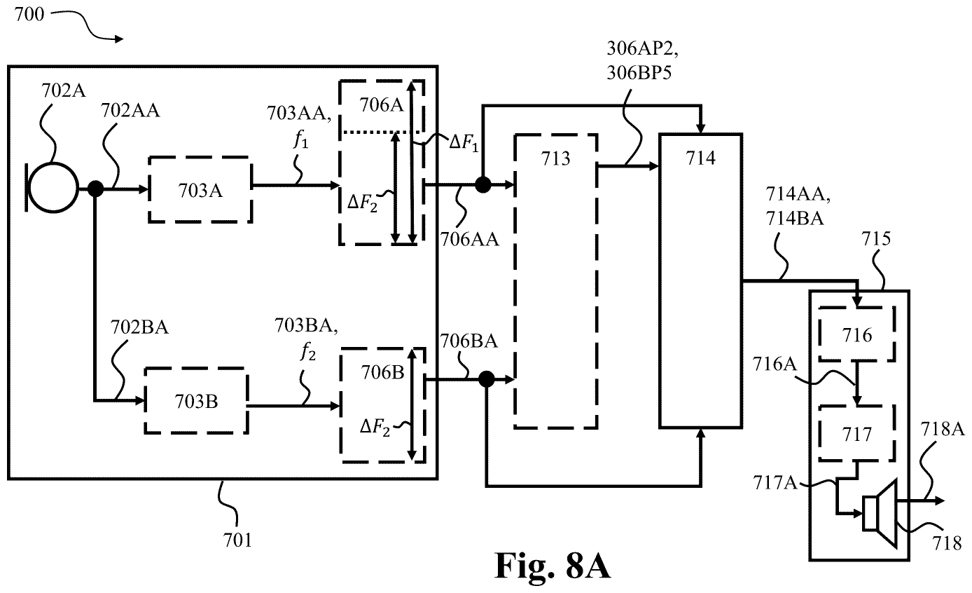

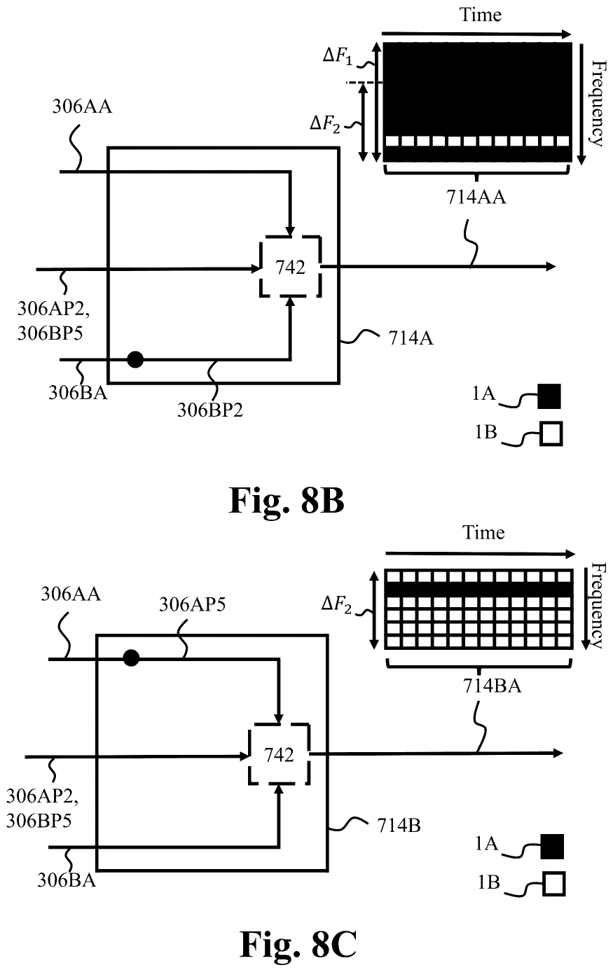

FIGS. 8A-8C schematically illustrate an example hearing aid 700, the example hearing aid 700 comprising a single microphone according to the present disclosure. FIG. 8A shows the structure of the hearing aid 700. The hearing aid 700 comprises an input unit 701, a signal processing unit 714, and an output unit 715. The input unit 701 comprises a microphone 702A.

In one or more example hearing aids, the output unit 718 comprises an output transducer 716. FIGS. 8B-8C schematically illustrate example signal processing units 714A, 714B of the hearing aid 700. In other words, the signal processing unit 714 may be configured to operate according to any of the signal processing units 714A, 714B of FIGS. 8B-8C.

The input unit 701 is configured to provide a first frequency-domain signal 706AA comprising a plurality of first frequency components associated with a first frequency range ΔF₁. A first primary frequency range ΔF₂ being a subset of the first frequency range ΔF₁. The first primary frequency range ΔF₂ of the first frequency-domain signal 706AA comprises one or more first aliasing artefact frequency components. Each of the one or more first aliasing artefact frequency components being indicative of a frequency component of the plurality of first frequency components including a first aliasing artefact. For example, the first frequency-domain signal 706AA is the first frequency-domain signal 306AA of FIG. 3. For example, the first frequency-domain signal 306AA comprises the first aliasing artefact frequency component 306AP2 of FIG. 3.

The input unit 701 is configured to provide a second frequency-domain signal 706BA comprising a plurality of second frequency components associated with the first primary frequency range ΔF₂. The second frequency-domain signal 706BA comprises one or more second aliasing artefact frequency components (e.g., second aliasing artefact frequency component 306BP5 of FIG. 3). Each of the one or more second aliasing artefact frequency components being indicative of a frequency component of the plurality of second frequency components including a second aliasing artefact. For example, the second frequency-domain signal 706BA is the second frequency-domain signal 306BA of FIG. 3. For example, the second frequency-domain signal 706BA comprises the second aliasing artefact frequency component 306BP5 of FIG. 3.

The one or more first aliasing artefact frequency components are different from the one or more second aliasing artefact frequency components. In other words, the first aliasing artefact frequency component 306AP2 of FIG. 3 may be different from the second aliasing artefact frequency component 306BP5 of FIG. 3. For example, the location of the first aliasing artefact frequency component 306AP2 in the first frequency-domain signal 706AA is different from the location of the second aliasing artefact frequency component 306BP5 in the second frequency-domain signal 706BA.

In one or more example hearing aids, the input unit 701 comprises a microphone 702A configured to provide a first input signal 702AA and a second input signal 702BA. For example, the first input signal 702AA is the first input signal 302AA of FIG. 3. For example, the second input signal 702BA is the second input signal 702BA of FIG. 3. For example, the first input signal 702AA and the second input signal 702BA are representative of a sound in an environment of the hearing aid 700. For example, the first input signal 702AA and the second input signal 702BA are the first input signal 302AA and the second input signal 302BA of FIG. 3, respectively.

In one or more example hearing aids, the input unit 701 comprises a first AD conversion unit 703A and a second AD conversion unit 703B.

In one or more example hearing aids, the first AD conversion unit 703A is configured to digitize the first input signal 702AA using the first sampling rate f₁ for provision of the first digitized signal 703AA. Put differently, the first AD conversion unit 703A may be configured to provide the first digitized signal 703AA by sampling the first input signal 702AB at the first sampling rate f₁.

In one or more example hearing aids, the second AD conversion unit 703B is configured to digitize the second input signal 702BA using the second sampling rate f₂ for provision of the second digitized signal 703BA. Put differently, the second AD conversion unit 303B may be configured to provide the second digitized signal 703BA by sampling the second input signal 702BA at the second sampling rate f₂. In one or more example hearing aids, the first sampling rate f₁ is greater than the second sampling rate f₂.

Optionally, the hearing aid 700 can comprise a single AD conversion unit (not shown in FIG. 8) configured to digitize the first input signal 702AA and the second input signal 702BA using a third sampling rate for provision of a first primary digitized signal and a second primary digitized signal. In other words, the single AD conversion unit may be configured to sample the first input signal 702AA and the second input signal 702BA at the third sampling rate. For example, the third sampling rate is different from the first sampling rate f₁ and the second sampling rate f₂. For example, the input unit 701 is configured to apply a downsampling technique to the first primary digitized signal and the second primary digitized signal when the third sampling rate is greater than the first sampling rate f₁ and the second sampling rate f₂ for provision of the first digitized signal 703AA and the second digitized signal 703BA. For example, the input unit 701 is configured to apply an upsampling technique to the first primary digitized signal and the second primary digitized signal when the third sampling rate is less than the first sampling rate f₁ and the second sampling rate f₂ for provision of the first digitized signal 703AA and the second digitized signal 703BA.

Optionally, the first AD conversion unit 703A and the second AD conversion unit 703B are included in an auxiliary device (e.g. a phone, a computer, etc.). The hearing aid 300 may be configured to receive, from the auxiliary device, the first digitized signal 703AA sampled at the first sampling rate f₁ and the second digitized signal 703BA sampled at the second sampling rate f₂. For example, the single AD conversion unit can be included in an auxiliary device. For example, the first digitized signal 703AA and the second digitized signal 703BA are the first digitized signal 303AA and the second digitized signal 303BA of FIG. 3, respectively.

In one or more example hearing aids, the input unit 701 comprises a plurality of analysis filter banks comprising a first analysis filter bank 706A and a second analysis filter bank 706B.

For example, the first analysis filter bank 706A is configured to provide the first frequency-domain signal 706AA based on the first digitized signal 703AA. In one or more example hearing aids, the second analysis filter bank 706B is configured to provide a second frequency-domain signal 706BA based on the second digitized signal 703BA. The frequency range of the second frequency-domain signal 706BA is a subset of the frequency range of the first frequency-domain signal 706AA. In other words, the first sampling rate f₁ may be greater than the second sampling rate f₂.

In one or more example hearing aids, the hearing aid 700 comprises an aliasing artefact detection unit 713. In one or more example hearing aids, the aliasing artefact detection unit 713 is configured to determine, based on the first primary frequency range ΔF₂ of the first frequency domain signal 706AA and the second frequency domain signal 706BA, the one or more first aliasing artefact frequency components (e.g., the first aliasing artefact frequency component 306AP2 of FIG. 3) and the one or more second aliasing artefact frequency components (e.g., the second aliasing artefact frequency component 306BP5 of FIG. 3).

In one or more example hearing aids, the aliasing artefact detection unit 713 operates in the same manner as the aliasing artefact detection unit 313 of FIG. 3. For example, the aliasing artefact detection unit 713 is the aliasing artefact detection unit 313 of FIG. 3.

The signal processing unit 714 is configured to determine an aliasing artefact reduced signal 714AA, 714BA based on the first frequency domain signal 706AA, the second frequency domain signal 706BA, the one or more first aliasing artefact frequency components (e.g., the first aliasing artefact frequency component 306AP2 of FIG. 3) and the one or more second aliasing artefact frequency components 313B (e.g., the second aliasing artefact frequency component 306BP5 of FIG. 3). For example, the aliasing artefact reduced signal 714AA is the aliasing artefact reduced signal 314A of FIG. 3. For example, the aliasing artefact reduced signal 714b is the aliasing artefact reduced signal 314B of FIG. 3.

In one or more example hearing aids, the output unit 715 comprises a synthesis filter bank 716. In one or more example hearing aids, the synthesis filter bank 716 is configured to convert one of the aliasing artefact reduced signal 714AA, 714BA in the frequency domain into a second aliasing artefact reduced signal 716A (e.g., in the time domain).

In one or more example hearing aids, the output unit 715 comprises a DA conversion unit 717 configured to convert the second aliasing artefact reduced signal 716A (e.g., a digital signal) to an analogue output signal 717A, such as for being presented to the user wearing the hearing aid 700 via the output unit 715 (e.g., output transducer 718, such as a loudspeaker).

The output unit 715 is configured to output, based on one of the aliasing artefact reduced signals 714AA, 714BA, an audible signal 718A to the user wearing the hearing aid 700. In the embodiment of FIG. 8, the output unit 715 is configured to output the audible signal 718A based on the analogue output signal 717A. The analogue output signal 717A may be converted into an acoustic signal via the output transducer 718.

FIG. 8B-8C schematically illustrate example signal processing units 714A, 714B of the hearing aid 700. The signal processing units 714A, 714B may differ from the signal processing unit 314 of FIG. 3 (e.g., signals processing units 314A-314B) in the sense that signal processing units 714 does not comprise a beamforming unit (e.g., as a first input signal 702AA and a second input signal 702BA are provided by the same microphone). The signal processing units 714AA, 714BA may not comprise a pair determination unit (e.g., the pair determination unit 338 of FIG. 3).

For example, the aliasing artefact reduced signal determined by the signal processing unit 714A is associated with the first frequency range ΔF₁. In other words, the aliasing artefact reduced signal 714AA may be associated with the first frequency range ΔF₁.

For example, the aliasing artefact reduced signal determined by the signal processing unit 714B is associated with the first primary frequency range ΔF₂. In other words, the aliasing artefact reduced signal 714BA may be associated with the first primary frequency range ΔF₂.

In one or more example hearing aids, the signal processing unit 714AA, 714BA comprises a replacement unit 742 (e.g., the replacement unit 342 of FIG. 3).

In the embodiment of FIG. 8B, the replacement unit 742 (e.g., the signal processing unit 714A) is configured to determine the aliasing artefact reduced signal 714AA by updating, for the first aliasing pair P2, the first frequency component 306AP2 of the first frequency domain signal 706AA with the corresponding second frequency component 306BP2 of the second frequency domain signal 706BA. For example, the first frequency domain signal 706AA is used as a reference for determining the aliasing artefact reduced signal 714AA.

In the embodiment of FIG. 8C, the replacement unit 742 (e.g., the signal processing unit 714A) is configured to determine the aliasing artefact reduced signal 714BA by updating, for the second aliasing pair P5, the corresponding second frequency component 306BP5 of the second frequency domain signal 706BA with the first frequency component 306AP5 of the first frequency domain signal 706AA. For example, the second frequency domain signal 706BA is used as a reference for determining the aliasing artefact reduced signal 714BA.

For example, the aliasing artefact reduced signal 714AA, 714BA is provided in a TF representation, such as comprising a plurality of frequency components, each of the plurality of frequency components comprising a plurality of time instances. For example, frequency components of such plurality of frequency components in black (e.g., color 1A) illustrate portions of the first frequency domain signal 706AA (e.g., portions free of aliasing artefacts). For example, frequency components of such plurality of frequency components in white (e.g., color 1B) illustrate portions of the second frequency domain signal 706BA (e.g., portions free of aliasing artefacts).

In one or more example hearing aids, the signal processing unit 314C of FIGS. 6A-6B (such as, without the beamforming unit 340 and the pair determination unit 338) can be configured to determine (e.g., easily adapted for determining) the aliasing artefact reduced signal 714AA, 714BA using appropriate binary masks, such as following the same structure of FIGS. 6A-6B (e.g., such as using similar operations described with reference to FIGS. 6A-6B).

In one or more example hearing aids, the hearing aid 700 can comprise a single microphone configured to provide at least two input signals. In other words, the hearing aid 700 can be easily adapted to follow the same structure of hearing aid 500 of FIG. 7A. For example, input signals 502A, 502BA, 502CA of FIG. 7A can be provided by the same microphone. For example, the signal processing unit 514 of FIG. 7A can be configured to operate in the same manner as signal processing unit 714AA, 714BA of FIGS. 8B-8C, e.g., operating without a beamforming unit.

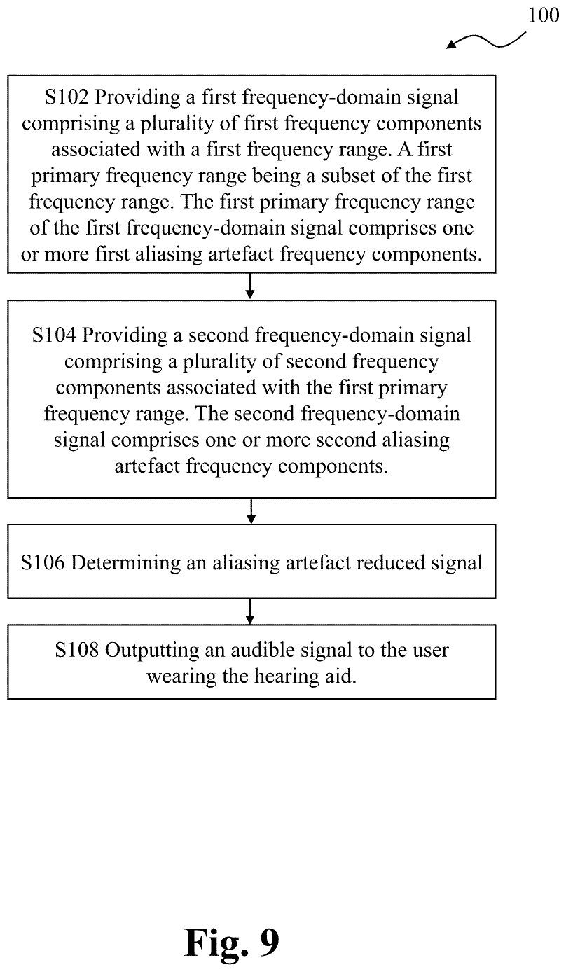

FIG. 9 illustrates a flow-chart of an example method 100 of operating a hearing aid according to the present disclosure.

The method 100 comprises providing S102 a first frequency-domain signal comprising a plurality of first frequency components associated with a first frequency range. For example, providing the first frequency-domain signal comprises determining the first frequency-domain signal based on a first input signal. A first primary frequency range being a subset of the first frequency range. The first primary frequency range of the first frequency-domain signal comprises one or more first aliasing artefact frequency components. Each of the one or more first aliasing artefact frequency components is indicative of a frequency component of the plurality of first frequency components including a first aliasing artefact.

The method 100 comprises providing S104 a second frequency-domain signal comprising a plurality of second frequency components associated with the first primary frequency range. For example, providing the second frequency-domain signal comprises determining the second frequency-domain signal based on a second input signal. The second frequency-domain signal comprises one or more second aliasing artefact frequency components. Each of the one or more second aliasing artefact frequency components is indicative of a frequency component of the plurality of second frequency components including a second aliasing artefact.

Each of the first input signal and second input signal is representative of a sound in an environment of the hearing aid, the environment of the hearing aid comprising an aliasing source.

The method 100 comprises determining S106, based on the first frequency domain signal, the second frequency domain signal, the one or more first aliasing artefact frequency components and the one or more second aliasing artefact frequency components, an aliasing artefact reduced signal.

The method 100 comprises outputting S108, based on the aliasing artefact reduced signal, an audible signal to the user wearing the hearing aid.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art.

The claims are not intended to be limited to the aspects shown herein but are to be accorded the full scope consistent with the language of the claims, wherein reference to an element in the singular is not intended to mean “one and only one” unless specifically so stated, but rather “one or more”. Unless specifically stated otherwise, the term “some” refers to one or more.

Examples of hearing aids according to the disclosure are set out in the following items:

Item A1. A hearing aid comprising:
an input unit configured to:
   provide a first frequency-domain signal comprising a plurality of first frequency components associated with a first frequency range, a first primary frequency range being a subset of the first frequency range, wherein the first primary frequency range of the first frequency-domain signal comprises one or more first aliasing artefact frequency components, each of the one or more first aliasing artefact frequency components being indicative of a frequency component of the plurality of first frequency components including a first aliasing artefact, and
   provide a second frequency-domain signal comprising a plurality of second frequency components associated with the first primary frequency range, wherein the second frequency-domain signal comprises one or more second aliasing artefact frequency components, each of the one or more second aliasing artefact frequency components being indicative of a frequency component of the plurality of second frequency components including a second aliasing artefact;
a signal processing unit configured to determine, based on the first frequency domain signal, the second frequency domain signal, the one or more first aliasing artefact frequency components and the one or more second aliasing artefact frequency components, an aliasing artefact reduced signal; and
an output unit configured to output, based on the aliasing artefact reduced signal, an audible signal to the user wearing the hearing aid.

Item A2. The hearing aid according to item A1, wherein each pair of a plurality of pairs of frequency components comprises a first frequency component of the plurality of first frequency components and a corresponding second frequency component of the plurality of second frequency components, the first frequency component and the corresponding second frequency component being associated with the first primary frequency range.

Item A3. The hearing aid according to item A2, wherein the signal processing unit is configured to:
determine a first magnitude of the first frequency component of each pair of the plurality of pairs of frequency components;
determine a second magnitude of the corresponding second frequency component of each pair of the plurality of pairs of frequency components;
compare the first magnitude with the second magnitude; and
determine whether the magnitude comparison meets a criterion.

Item A4. The hearing aid according to item A3, wherein to determine whether the magnitude comparison meets the criterion comprises to:
determine that the magnitude comparison meets the criterion when the first magnitude is different from the second magnitude.

Item A5. The hearing aid according to item A4, wherein the signal processing unit is configured to:
upon determining that the magnitude comparison meets the criterion, determining that the first magnitude is greater than or equal to the second magnitude by a magnitude threshold;
determine the first frequency component as a first aliasing artefact frequency component of the one or more first aliasing artefact frequency components; and
selecting the corresponding second frequency component to be part of the aliasing artefact reduced signal.

Item A6. The hearing aid according to item A5, wherein the signal processing unit is configured to:
upon determining that the magnitude comparison meets the criterion, determining that the second magnitude is greater than or equal to the first magnitude by the magnitude threshold;
determine the corresponding second frequency component as a second aliasing artefact frequency component of the one or more second aliasing artefact frequency components; and
selecting the first frequency component to be part of the aliasing artefact reduced signal.

Item A7. The hearing aid according to item A3, wherein to determine whether the magnitude comparison meets the criterion comprises to:
determine that the magnitude comparison meets the criterion when the first magnitude is approximately equal to the second magnitude.

Item A8. The hearing aid according to item A7, wherein the signal processing unit is configured to:
upon determining that the magnitude comparison does not meet the criterion, determine that the first magnitude is approximately equal to the second magnitude;
determine a combined version of the first frequency component and the corresponding second frequency component by applying a multi-channel processing technique to the first frequency component and the corresponding second frequency component; and
selecting the combined version to be part of the aliasing artefact reduced signal.

A9. The hearing aid according to item A2, wherein the first frequency component of the plurality of first frequency components and the corresponding second frequency component of the plurality of second frequency components are filtered frequency components.

A10. The hearing aid according to item A1, wherein the first aliasing artefact comprises a first ultrasound artefact, and wherein the second aliasing artefact comprises a second ultrasound artefact.

A11. The hearing aid according to item A1, wherein the input unit comprises a first analysis filter bank and a second analysis filter bank, the first analysis filter bank being configured to provide the first frequency-domain signal based on a first digitized signal, the second analysis filter bank being configured to provide the second frequency-domain signal based on a second digitized signal.

A12. A hearing aid according to item A1, wherein the input unit comprises a first analogue-to-digital (AD) conversion unit and a second AD conversion unit, the first AD conversion unit being configured to digitize a first input signal using the first sampling rate for provision of the first digitized signal, and the second AD conversion unit being configured to digitize a second input signal using the second sampling rate for provision of the second digitized signal, wherein the first sampling rate is greater than the second sampling rate.

A13. A hearing aid according to item A1, wherein the input unit comprises a first microphone configured to provide the first input signal, and a second microphone configured to provide the second input signal, the first input signal and the second input signal being representative of a sound in an environment of the hearing aid.

Item B1. A hearing aid comprising:
an input unit configured to provide L frequency domain signals, L denoting at least two frequency domain signals, wherein the L frequency domain signals comprise a plurality of frequency components, wherein a set of frequency components of a plurality of sets of frequency components comprises L frequency components, the L frequency components having the same location in the L frequency domain signals, and wherein the frequency range of the L frequency domain signals are different from one another in that at least two of the plurality of sets of frequency components comprise up to L−1 frequency components including an aliasing artefact;
a signal processing unit configured to determine, based on the at least two frequency domain signals and the plurality of plurality of frequency components including aliasing artefacts, an aliasing artefact reduced signal; and
an output unit configured to output, based on the aliasing artefact reduced signal, an audible signal to the user wearing the hearing aid.

Item B2. The hearing aid according to item B1, wherein the signal processing unit is configured to:
determine, for each set of frequency components, a magnitude associated with each of the L frequency components;
determine one or more lowest magnitudes among the magnitudes of the L frequency components; and
determine the one or more frequency components comprising the lowest magnitude as non-aliasing frequency components; and
determine the remaining frequency components, e.g., two or up to L−1 frequency components of the L frequency components, as frequency components aliasing frequency components.

Item B3. The hearing aid according to item B2, wherein the signal processing unit is configured to determine one lowest magnitude among the magnitudes of the L frequency components, and wherein the signal processing unit is configured to:
selecting the frequency component comprising the lowest magnitude to be part of the aliasing artefact reduced signal.

Item B4. The hearing aid according to item B2, wherein the signal processing unit is configured to determine two or more lowest magnitudes among the magnitudes of the L frequency components, and wherein the signal processing unit is configured to:
determine a combined version of the two or more frequency components comprising the lowest magnitudes by applying a multi-channel processing technique to said two or more frequency components; and
select the combined version to be part of the aliasing artefact reduced signal.

Item B5. The hearing aid according to item B1, wherein the L frequency components are filtered frequency components.

Item B6. The hearing aid according to item B1, wherein an aliasing artefact comprises an ultrasound artefact.

Item B7. The hearing aid according to item B1, wherein the input unit comprises L analysis filter banks, each of the L analysis filter banks being configured to provide a respective frequency domain signal of the L frequency-domain signals based on a respective digitized signal.

Item B8. A hearing aid according to item B1, wherein the input unit comprises L analogue-to-digital (AD) conversion units, each of the AD units being configured to digitize a respective input signal using a respective sampling rate for provision of a respective digitized signal, wherein the sampling rates are different from one another.

Item B9. A hearing aid according to item B1, wherein the input unit comprises L microphones configured to provide the corresponding L input signals, each of the L input signals being representative of a sound in an environment of the hearing aid.

1. A hearing aid comprising:
an input unit configured to:
determine a first frequency-domain signal based on a first input signal, the first frequency-domain signal comprising a plurality of first frequency components associated with a first frequency range, a first primary frequency range being a subset of the first frequency range, wherein the first primary frequency range of the first frequency-domain signal comprises one or more first aliasing artefact frequency components, each of the one or more first aliasing artefact frequency components being indicative of a frequency component of the plurality of first frequency components including a first aliasing artefact,
determine a second frequency-domain signal based on a second input signal, the second frequency-domain signal comprising a plurality of second frequency components associated with the first primary frequency range, wherein the second frequency-domain signal comprises one or more second aliasing artefact frequency components, each of the one or more second aliasing artefact frequency components being indicative of a frequency component of the plurality of second frequency components including a second aliasing artefact, and
wherein each of the first input signal and second input signal is representative of a sound in an environment of the hearing aid, the environment of the hearing aid comprising an aliasing source;
an aliasing artefact detection unit configured to determine the one or more first aliasing artefact frequency components and the one or more second aliasing artefact frequency components based on a magnitude comparison between the first primary frequency range of the first frequency domain signal and the second frequency domain signal;
a signal processing unit configured to determine, based on the first frequency domain signal, the second frequency domain signal, the one or more first aliasing artefact frequency components and the one or more second aliasing artefact frequency components, an aliasing artefact reduced signal; and
an output unit configured to output, based on the aliasing artefact reduced signal, an audible signal to the user wearing the hearing aid.

2. The hearing aid according to claim 1, wherein each pair of a plurality of pairs of frequency components comprises a first frequency component of the plurality of first frequency components and a corresponding second frequency component of the plurality of second frequency components, the first frequency component and the corresponding second frequency component being associated with the first primary frequency range, and wherein to determine the one or more first aliasing artefact frequency components and the one or more second aliasing artefact frequency components comprises to:
determine a first magnitude of the first frequency component of each pair of the plurality of pairs of frequency components;
determine a second magnitude of the corresponding second frequency component of each pair of the plurality of pairs of frequency components;
compare the first magnitude with the second magnitude; and
determine whether the magnitude comparison meets a criterion.

3. The hearing aid according to claim 2, wherein to determine whether the magnitude comparison meets the criterion comprises to:
determine that the magnitude comparison meets the criterion when the first magnitude is different from the second magnitude.

4. The hearing aid according to claim 2, wherein to determine the one or more first aliasing artefact frequency components comprises to:
upon determining that the magnitude comparison meets the criterion, determine that the first magnitude is greater than or equal to the second magnitude by a magnitude threshold; and
determine the first frequency component as a first aliasing artefact frequency component of the one or more first aliasing artefact frequency components.

5. The hearing aid according to claim 2, to determine the one or more second aliasing artefact frequency components comprises to:
upon determining that the magnitude comparison meets the criterion, determine that the second magnitude is greater than or equal to the first magnitude by the magnitude threshold; and
determine the corresponding second frequency component as a second aliasing artefact frequency component of the one or more second aliasing artefact frequency components.

6. The hearing aid according to claim 2, wherein the first frequency component of the plurality of first frequency components and the corresponding second frequency component of the plurality of second frequency components are filtered frequency components.

7. The hearing aid according to claim 2, wherein the plurality of pairs of frequency components comprises a set of aliasing pairs and a remaining set of non-aliasing pairs, wherein:
the set of aliasing pairs includes at least a first aliasing pair and a second aliasing pair, the first aliasing pair including a first aliasing artefact frequency component of the one or more first aliasing artefact frequency components, and the second aliasing pair including a second aliasing artefact frequency component of the one or more second aliasing artefact frequency components; and
each of the remaining set of non-aliasing pairs includes neither the one or more first aliasing artefact frequency components nor the one or more second aliasing artefact frequency components.

8. The hearing aid according to claim 7, wherein to determine the aliasing artefact reduced signal comprises to:
determine, for each of the remaining set of non-aliasing pairs, a combined version of the first frequency component and the corresponding second frequency component by applying a multi-channel processing technique to the first frequency component and the corresponding second frequency component.

9. The hearing aid according to claim 8, wherein to determine the aliasing artefact reduced signal comprises to:
update, for each of the remaining set of non-aliasing pairs, the first frequency component with the corresponding combined version of the first frequency component and the corresponding second frequency component; and
update, for the first aliasing pair, the first frequency component with the corresponding second frequency component.

10. The hearing aid according to claim 8, wherein to determine the aliasing artefact reduced signal comprises to:
update, for each of the remaining set of non-aliasing pairs, the corresponding second frequency component with the corresponding combined version of the first frequency component and the corresponding second frequency component; and
update, for the second aliasing pair, the corresponding second frequency component with the first frequency component.

11. The hearing aid according to claim 1, wherein the first aliasing artefact comprises a first ultrasound artefact, and wherein the second aliasing artefact comprises a second ultrasound artefact.

12. The hearing aid according to claim 1, wherein the input unit comprises a first analysis filter bank and a second analysis filter bank, the first analysis filter bank being configured to determine the first frequency-domain signal based on a first digitized signal, the second analysis filter bank being configured to determine the second frequency-domain signal based on a second digitized signal.

13. A hearing aid according to claim 12, wherein the input unit comprises a first analogue-to-digital (AD) conversion unit and a second AD conversion unit, the first AD conversion unit being configured to digitize a first input signal using the first sampling rate for provision of the first digitized signal, and the second AD conversion unit being configured to digitize a second input signal using the second sampling rate for provision of the second digitized signal, wherein the first sampling rate is greater than the second sampling rate.

14. A hearing aid according to claim 1, wherein the input unit comprises a first microphone configured to provide the first input signal, and a second microphone configured to provide the second input signal.
